(19) United States
(12) Patent Application Publication
(10) Pub. No.: US 2011/0164011 A1
(43) Pub. Date: Jul. 7, 2011

(54) Display apparatus, light detection method and electronic apparatus

(75) Inventors: Tetsuro Yamamoto, Kanagawa (JP); Katsuhide Uchino, Kanagawa (JP); Kazuo Nakamura, Kanagawa (JP)

(73) Assignee: Sony Corporation, Tokyo (JP)

(21) Appl. No.: 12/929,006

(22) Filed: Dec. 22, 2010

(30) Foreign Application Priority Data
Jan. 7, 2010 (JP) 2010-001877

(51) Int. Cl. G09G 3/30; G09G 5/00

(52) U.S. Cl. 345/207; 345/76

(57) ABSTRACT

Disclosed herein is a display apparatus, including pixel circuits disposed in a matrix at positions at which signal lines and scanning lines cross each other and individually including a light emitting element; a light emission driving section to apply a signal value to each of the pixel circuits to cause the circuit to emit light of a luminance; and a light detection section provided in each of the pixel circuits and including a sensor-switch serving element which functions by switching thereof between an on state and an off state and functions, in the off state thereof, as a light sensor for detecting light from the light emitting element of the pixel circuit, and a detection signal outputting transistor connected to a light detection line for outputting light detection information corresponding to a variation amount of current of the sensor-switch serving element in the off state to the light detection line.

### BACKGROUND OF THE INVENTION

1. Field of the Invention

The present invention relates to a display apparatus wherein a self-luminous device such as, for example, an organic electroluminescence device (organic EL device) is used in a pixel circuit and a light detection method for a light detection section provided in the pixel circuit and an electronic apparatus.

2. Description of the Related Art

In a display apparatus of the active matrix type wherein an organic electroluminescence (EL: Electroluminescence) light emitting element is used as a pixel, current flowing to a light emitting element in each pixel circuit is controlled by an active device, generally a thin film transistor (TFT) provided in each pixel circuit. Since an organic EL device is a current light emitting element, a gradation of color development is obtained by controlling the amount of current flowing to the EL device.

In particular, in a pixel circuit which includes an organic EL device, current corresponding to an applied signal value voltage is supplied to the organic EL device to carry out light emission of a gradation in accordance with the signal value.

In a display apparatus which uses a self-luminous device such as a display apparatus which uses such an organic EL device as described above, it is important to cancel the dispersion in light emission luminance among pixels to eliminate non-uniformity which appears on a screen.

While the dispersion in light emission luminance among pixels appears also in an initial state upon panel fabrication, the dispersion is caused by time-dependent variation.

A light emission efficiency of an organic EL device is degraded by passage of time. In particular, even if the same current flows, the emitted light luminance degrades together with passage of time.

As a result, a screen burn that, if a white WINDOW pattern is displayed on the black background and then the white is displayed on the full screen as shown, for example, in FIG. 59A, then the luminance at the portion at which the WINDOW pattern is displayed decreases.

A countermeasure against such a situation as described above is disclosed in JP-T-2007-501953 or JP-T-2008-518263 (referred to as Patent Document 1 and 2, respectively, hereinafter). In particular, Patent Document 1 discloses an apparatus wherein a light sensor is disposed in each pixel circuit and a detection value of the light sensor is fed back to the system to correct the emitted light luminance. Patent Document 2 discloses an apparatus wherein a detection value is fed back from a light sensor to a system to carry out correction of the emitted light luminance.

### SUMMARY OF THE INVENTION

The present invention is directed to a display apparatus wherein a light detection section for detecting light from a light emitting element of a pixel circuit is provided for the pixel circuit. The display apparatus is implemented wherein a signal value is corrected in accordance with light amount information detected by the light detection section to prevent such a screen burn as described above. The present invention further provides a light detection section which can carry out detection with a high degree of accuracy and can be configured from a small number of elements and a small number of control lines.

According to an embodiment of the present invention, there is a display apparatus, including:

a plurality of pixel circuits disposed in a matrix at positions at which a plurality of signal lines and a plurality of scanning lines cross each other and individually including a light emitting element;

a light emission driving section adapted to apply a signal value to each of the pixel circuits to cause the pixel circuit to emit light of a luminance corresponding to the signal value; and

a light detection section provided in each of the pixel circuits and including a sensor-switch serving element which functions as a switching element by switching thereof between an on state and an off state and functions, in the off state thereof, as a light sensor for detecting light from the light emitting element of the pixel circuit, and a detection signal outputting transistor connected to a light detection line for outputting light detection information corresponding to a variation amount of current of the sensor-switch serving element in the off state to the light detection line.

According to another embodiment of the present invention, there is a light detection method for a display apparatus including a pixel circuit having a light emitting element and a light detection section for detecting light from the light emitting element of the pixel circuit and outputting light detection information, the light detection section including a sensor-switch serving element which functions as a switching element by switching thereof between an on state and an off state and functions, in the off state thereof, as a light sensor for detecting light from the light emitting element of the pixel circuit, and a detection signal outputting transistor connected to a light detection line for outputting light detection information corresponding to a variation amount of current of the sensor-switch serving element in the offset state to the light detection line, the light detection method including the step of:

outputting the light detection information in accordance with a variation amount of current flowing to the sensor-switch serving element in the off state of the sensor-switch serving element from the detection signal outputting transistor to the light detection line.

According to further embodiment of the present invention, there is an electronic apparatus, including:

a plurality of pixel circuits disposed in a matrix at positions at which a plurality of signal lines and a plurality of scanning lines cross each other and individually including a light emitting element;

a light emission driving section adapted to apply a signal value to each of the pixel circuits to cause the pixel circuit to emit light of a luminance corresponding to the signal value; and

a light detection section including a sensor-switch serving element which functions as a switching element by switching thereof between an on state and an off state and functions, in the off state thereof, as a light sensor for detecting light from the light emitting element of the pixel circuit, and a detection signal outputting transistor connected to a light detection line for outputting light detection information corresponding to a variation amount of current of the sensor-switch serving element in the off state to the light detection line.

According to further embodiment of the present invention, there is a display apparatus, including:

a plurality of pixel circuits disposed in a matrix and each including a light emitting element; and

a light detection section including a sensor-switch serving element capable of functioning as a switch element and also as a light sensor for detecting the light from the light emitting element.

In the display apparatus, light detection method and electronic apparatus having such a configuration as described above, a sensor-switch serving element which functions as a switching element by switching thereof between an on state and an off state and functions, in the off state thereof, as a light sensor for detecting light from the light emitting element is used as the light detection element. Consequently, a preparation operation and a detection operation for detection by the light detection section can be implemented by the single element.

Further, outputting of the light detection information is carried out by the detection signal outputting transistor connected directly to the light detection line.

By the configurations, reduction of the number of components of the light detection section and reduction of the number of lines and drivers for operation control are achieved.

With the display apparatus, light detection method and electronic apparatus, simplification of the configuration of the light detection section can be achieved by using a sensor-switch serving element as the light detection element such that it is used, in the on state thereof, as a switching element but is used, in the off state thereof, as a light detection element and connecting the detection signal outputting transistor directly to the light detection line. In other words, the number of transistors for configuring the light detection element and the number of control lines for the transistors can be reduced.

As a result, enhancement in yield can be implemented, and it is possible to take a countermeasure against a failure in picture quality caused by deterioration of the efficiency of a light emitting element such as a screen burn.

The above and other objects, features and advantages of the present invention will become apparent from the following description and the appended claims, taken in conjunction with the accompanying drawings in which like parts or elements denoted by like reference symbols.

### BRIEF DESCRIPTION OF THE DRAWINGS

FIG. 1 is a block diagram showing a display apparatus according to an embodiment of the present invention;

FIG. 2 is a diagrammatic view showing an example of disposition of a light detection section in the display apparatus of FIG. 1;

FIG. 3 is a circuit diagram showing a configuration which has been taken into consideration in the course to the present invention;

FIG. 4 is a waveform diagram illustrating operation of the circuit of FIG. 3;

FIG. 5 is a circuit diagram showing another configuration which has been taken into consideration in the course to the present invention;

FIG. 6 is a waveform diagram illustrating operation of the circuit of FIG. 5;

FIGS. 7 to 9 are equivalent circuit diagrams illustrating operation of the circuit of FIG. 5;

FIG. 10 is a circuit diagram showing further configuration which has been taken into consideration in the course to the present invention;

FIG. 11 is a waveform diagram illustrating operation of the circuit of FIG. 10;

FIGS. 12 to 15 are equivalent circuit diagrams illustrating operation of the circuit of FIG. 10;

FIG. 16 is a circuit diagram according to the first embodiment of the present invention;

FIGS. 17A and 17B are diagrammatic views illustrating light detection operation period according to an embodiment of the present invention;

FIGS. 18A and 18B are diagrammatic views illustrating light detection operation period according to an embodiment of the present invention;

FIG. 19 is an operation waveform according to the first embodiment of the present invention;

FIG. 20 is an explanatory diagram of light detection operation according to the first embodiment of the present invention;

FIGS. 21 to 25 are equivalent circuit diagrams illustrating operation upon light detection according to the first embodiment of the present invention;

FIG. 26 is a circuit diagram according to the second embodiment of the present invention;

FIG. 27 is an operation waveform according to the second embodiment of the present invention;

FIG. 28 is a waveform diagram illustrating light detection operation according to the second embodiment of the present invention;

FIGS. 29 to 33 are equivalent circuit diagrams illustrating operation upon light detection according to the second embodiment of the present invention;

FIG. 34 is a circuit diagram according to the third embodiment of the present invention;

FIG. 35 is a waveform diagram illustrating light detection operation according to the third embodiment of the present invention;

FIGS. 36 to 40 are equivalent circuit diagrams illustrating operation upon light detection according to the third embodiment of the present invention;

FIG. 41 is a circuit diagram according to the fourth embodiment of the present invention;

FIG. 42 is a waveform diagram illustrating light detection operation according to the fourth embodiment of the present invention;

FIG. 43 is a circuit diagram according to the fifth embodiment of the present invention;

FIG. 44 is a waveform diagram illustrating light detection operation according to the fifth embodiment of the present invention;

FIG. 45 is a block diagram showing a display apparatus according to the sixth and seventh embodiments of the present invention;

FIG. 46 is a circuit diagram according to the sixth embodiment of the present invention;

FIG. 47 is an operation waveform according to the sixth embodiment of the present invention;

FIG. 48 is a waveform diagram illustrating light detection operation according to the sixth embodiment of the present invention;

FIG. 49 is a circuit diagram according to the seventh embodiment of the present invention;

FIG. 50 is an operation waveform according to the seventh embodiment of the present invention;

FIG. 51 is a waveform diagram illustrating light detection operation according to the seventh embodiment of the present invention;

FIGS. 52 to 56 are equivalent circuit diagrams illustrating operation upon light detection according to the seventh embodiment of the present invention;

FIGS. 57A and 57B are waveform diagrams illustrating modifications of the present invention;

FIGS. 58A and 58B are schematic views showing examples of an application of the present invention; and

FIGS. 59A and 59B are schematic views illustrating correction against a screen burn.

### DETAILED DESCRIPTION OF THE PREFERRED EMBODIMENTS

In the following, embodiments of the present invention are described in the following order.

### <1. Configuration of the Display Apparatus>

<2. Taken into Consideration in the Course to the Present Invention: Configuration Examples 1 to 3>

### <3. First Embodiment>

[3-1. Circuit Configuration]

[3-2. Light Detection Operation Period]

[3-3. Light Detection Operation]

### <4. Second Embodiment>

### <5. Third Embodiment>

### <6. Fourth Embodiment>

### <7. Fifth Embodiment>

### <8. Sixth Embodiment>

### <9. Seventh Embodiment>

### <10. Modifications, and Applications>

### 1. Configuration of the Display Apparatus

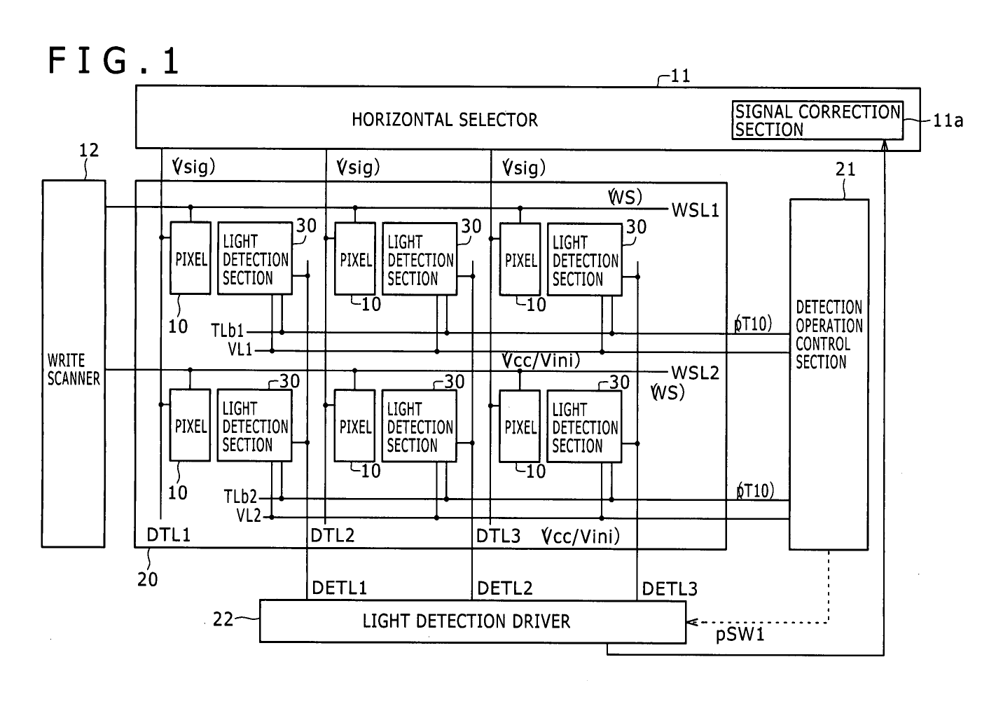

A configuration of an organic EL display apparatus according to an embodiment of the present invention is shown in FIG. 1. The organic EL display apparatus is incorporated as a display device in various electronic apparatus. In particular, the organic EL display apparatus is incorporated in various electronic apparatus such as, for example, a television receiver, a monitor apparatus, a recording and reproduction apparatus, a communication apparatus, a computer apparatus, an audio apparatus, a video apparatus, a game machine and a home electronics apparatus.

It is to be noted that the configuration shown in FIG. 1 corresponds to first to fourth embodiments hereinafter described.

The organic EL display apparatus includes a plurality of pixel circuits 10 each including an organic EL device as a light emitting element for carrying out light emission driving in accordance with an active matrix method.

Referring to FIG. 1, the organic EL display apparatus includes a pixel array 20 wherein a great number of pixel circuits 10 are arranged in a matrix in a row direction and a column direction, that is, in m rows×n columns. It is to be noted that each of the pixel circuits 10 functions as one of light emitting pixels of R (red), G (green) and B (blue), and a color display apparatus is configured by arranging the pixel circuits 10 of the individual colors in accordance with a predetermined rule.

As components for driving the pixel circuits 10 to emit light, a horizontal selector 11 and a write scanner 12 are provided.

Signal lines DTL, particularly DTL1, DTL2, . . . , which are selected by the horizontal selector 11 for supplying a voltage in accordance with a signal value, that is, a gradation value, of a luminance signal as display data to the pixel circuits 10 are arranged in the column direction on the pixel array 20. The number of signal lines DTL1, DTL2, . . . , is equal to the number of columns of the pixel circuits 10 disposed in a matrix in the pixel array 20.

Further, on the pixel array 20, writing control lines WSL, that is, WSL1, WSL2, . . . , are arranged in the row direction. The number of writing control lines WSL is equal to the number of the pixel circuits 10 disposed in a matrix in the row direction on the pixel array 20.

The writing control lines WSL, that is, WSL1, WSL2, . . . , are driven by the write scanner 12. The write scanner 12 successively supplies a scanning pulse WS to the writing control lines WSL1, WSL2, . . . , disposed in rows to line-sequentially scan the pixel circuits 10 in a unit of a row.

The horizontal selector 11 supplies a signal value potential Vsig as an input signal to the pixel circuits 10 to the signal lines DTL1, DTL2, . . . , disposed in the column direction in a timed relationship with the line-sequential scanning by the write scanner 12.

A light detection section 30 is provided corresponding to each of the pixel circuits 10. The light detection section 30 includes an element, which is a sensor serving transistor T10 hereinafter described, in the inside thereof which functions as a light sensor, and a detection signal outputting circuit configuration including a detection signal outputting transistor (hereinafter described as T5). The light detection section 30 outputs detection information of an emitted light amount of the light emitting element of the corresponding pixel circuit 10.

Further, a detection operation control section 21 for controlling operation of the light detection section 30 is provided. Control lines TLb, that is, TLb1, TLb2, . . . , extend from the detection operation control section 21 to the light detection sections 30.

While a configuration of the detection signal outputting circuit configuration of the light detection section 30 is hereinafter described, the control lines TLa function to supply a control pulse pT3 for on/off control of a switching transistor T3 in the light detection sections 30 to the switching transistor T3. Meanwhile, the control lines TLb function to supply a control pulse pT10 for on/off control of the sensor serving transistor T10 in the light detection sections 30 to the sensor serving transistor T10.

Further, power supply lines VL, that is, VL1, VL2, . . . , for supplying an operation power supply voltage for the light detection section 30 are arranged for the light detection sections 30. The detection operation control section 21 applies a pulse voltage formed from an operation power supply voltage Vcc and a reference potential Vini to the power supply lines VL, that is, VL1, VL2, . . . .

Further, light detection lines DETL, that is, DETL1, DETL2, . . . , are disposed, for example, in a column direction for the light detection section 30. The light detection lines DETL are used as lines for outputting a voltage as detection information by the light detection sections 30.

The light detection lines DETL, that is, DETL1, DETL2, . . . , are connected to a light detection driver 22. The light detection driver 22 carries out voltage detection regarding the light detection lines DETL to detect light amount detection information by the light detection sections 30.

The light detection driver 22 applies light amount detection information regarding the pixel circuits 10 by the light detection sections 30 to a signal value correction section 11a in the horizontal selector 11.

The signal value correction section 11a decides a degree of degradation of the light emission efficiency of the organic EL device in the pixel circuits 10 based on the light amount detection information and carries out a correction process of the signal value Vsig to be applied to the pixel circuits 10 in accordance with a result of the decision.

The light emission efficiency of an organic EL device degrades as time passes. In particular, even if the same current is supplied, the light emission luminance decreases as time passes. Therefore, in the display apparatus according to the present embodiment, the emitted light amount of each pixel circuit 10 is detected and degradation of the light emission luminance is decided based on a result of the detection. Then, the signal value Vsig itself is corrected in response to the degree of degradation. For example, where the signal value Vsig as a certain voltage value V1 is to be applied, correction is carried out such that a correction value α determined based on the degree of degradation of the light emission luminance is set and the signal value Vsig as the voltage value V1+α is applied.

The degradation of the light emission luminance of each pixel circuit 10 detected in such a manner as just described is compensated for by feeding back the same to the signal value Vsig to decrease a screen burn.

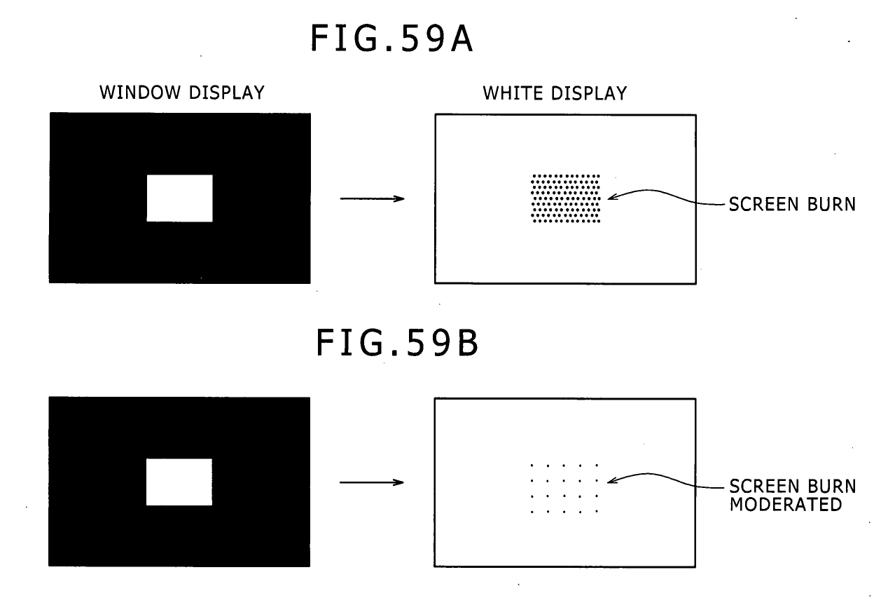

In particular, for example, in a situation wherein a screen burn occurs as seen in FIG. 59A, the screen burn is decreased as seen in FIG. 59B.

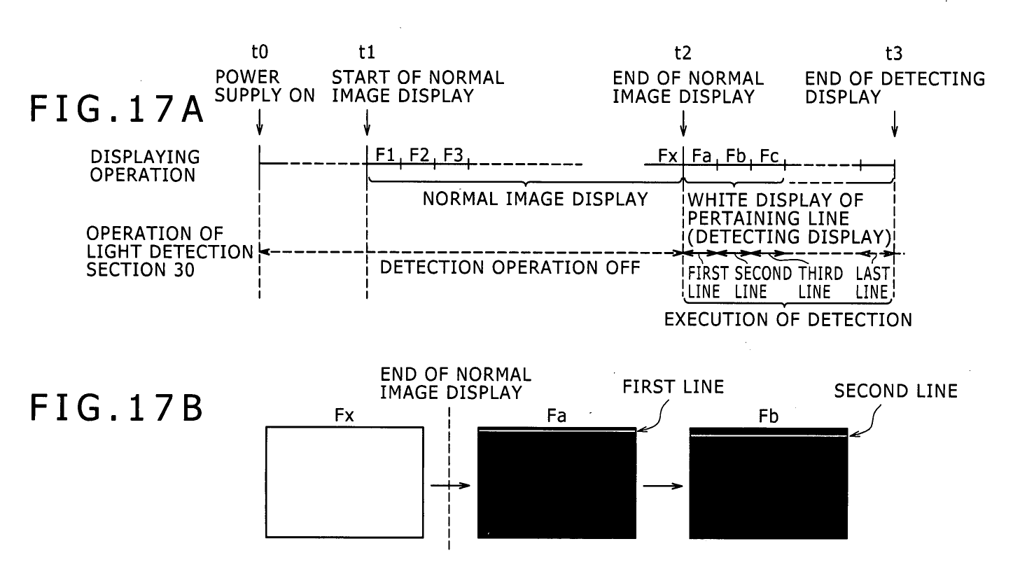

It is to be noted that, though not shown in FIG. 1, potential lines for supply a cathode potential Vcat as a required fixed potential are connected to the pixel circuits 10 and the light detection sections 30 (shown in FIG. 17).

Further, although FIG. 1 shows the configuration corresponding to the first to fourth embodiments, in the case of the second and third embodiment, the detection operation control section 21 additionally includes a configuration for supplying a control signal pSW1 to the light detection driver 22 as indicated by a broken line.

Incidentally, while a single light detection section 30 is provided for each of the pixel circuits 10, there is no necessity to provide one light detection section 30 for each pixel circuit 10.

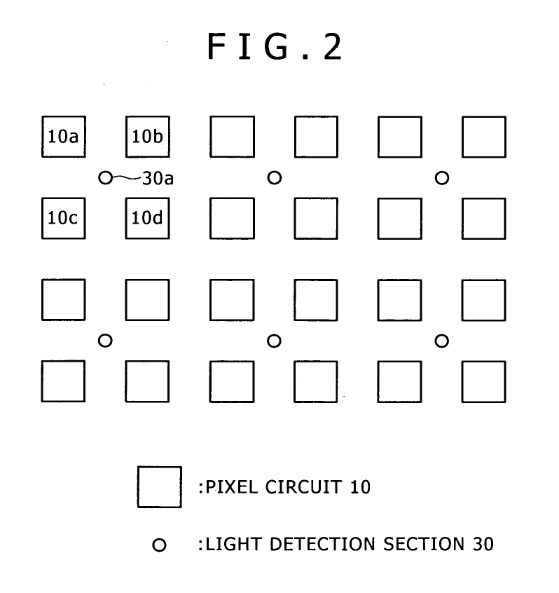

In other words, another configuration may be applied wherein one light detection section 30 carries out light detection for a plurality of pixel circuits 10, for example, like a configuration shown in FIG. 2 wherein one light detection section 30 is disposed for four pixel circuits 10. For example, such a technique may be taken that, where light detection regarding four pixel circuits 10a, 10b, 10c and 10d shown in FIG. 2 is carried out while the pixel circuits 10a, 10b, 10c and 10d are successively driven to emit light in order, light detection is carried out successively by a light detection section 30a disposed at a central position among the pixel circuits 10a, 10b, 10c and 10d. Or another technique may be taken that, while a plurality of pixel circuits 10 are driven to emit light at the same time, the light amount is detected in a unit of a pixel block including, for example, the pixel circuits 10a, 10b, 10c and 10d.

### 2. Configuration Taken into Consideration in the Course to the Present Invention: Configuration Examples 1 to 3

Here, before the circuit configuration and operation of the embodiment of the present invention are described, configuration examples 1 to 3 of the light detection section which has been taken into consideration in the course to the present invention are described to facilitate understandings of the present embodiment.

It is to be noted that the applicant recognizes that the configuration examples 1 to 3 are not publicly known inventions.

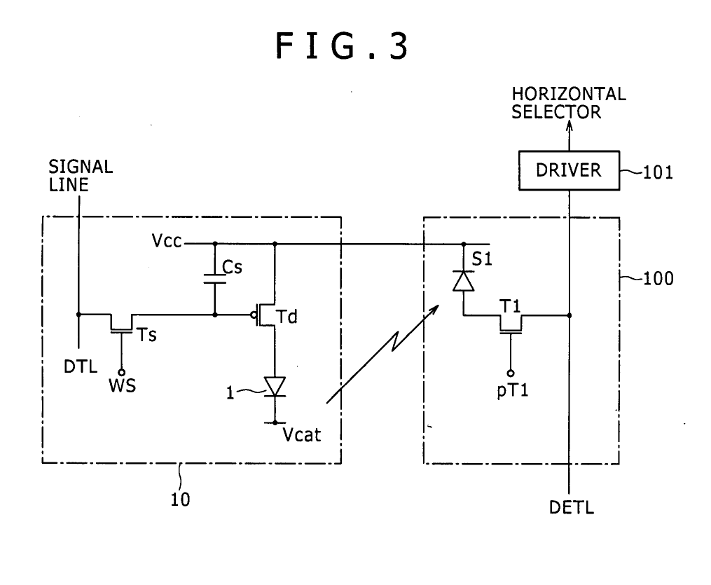

First, as the configuration example 1, FIG. 3 shows a pixel circuit 10 and a light detection section 100 contrived for reduction of a screen burn.

The pixel circuit 10 includes a driving transistor Td, a sampling transistor Ts, a holding capacitor Cs and an organic EL element 1. The pixel circuit 10 having the configuration is hereinafter described more particularly in the first embodiment.

In order to compensate for a drop of the light emission efficiency of the organic EL element 1 of the pixel circuit 10, the light detection section 100 is provided which includes a light detection element or light sensor S1 and a switching transistor T1 interposed between a power supply voltage Vcc and a fixed light detection line DETL.

In this instance, the light sensor S1, for example, in the form of a photodiode supplies leak current corresponding to the amount of emitted light from the organic EL element 1.

Generally, when a diode detects light, current thereof increases. Further, the increasing amount of current varies depending upon the amount of light incident to the diode. In particular, if the light amount is great, then the increasing amount of current is great, and if the light amount is small, then the increasing amount of current is small.

The current flowing through the light sensor S1 flows to the light detection line DETL if the switching transistor T1 is rendered conducting.

An external driver 101 connected to the light detection line DETL detects the amount of current supplied from the light sensor S1 to the light detection line DETL.

The current value detected by the external driver 101 is converted into a detection information signal and supplied to a horizontal selector 11. The horizontal selector 11 decides from the detection information signal whether or not the detection current value corresponds to the signal value Vsig provided to the pixel circuit 10. If the luminance of the emitted light of the organic EL element 1 indicates a degraded level, then the detection current amount indicates a reduced level. In this instance, the signal value Vsig is corrected.

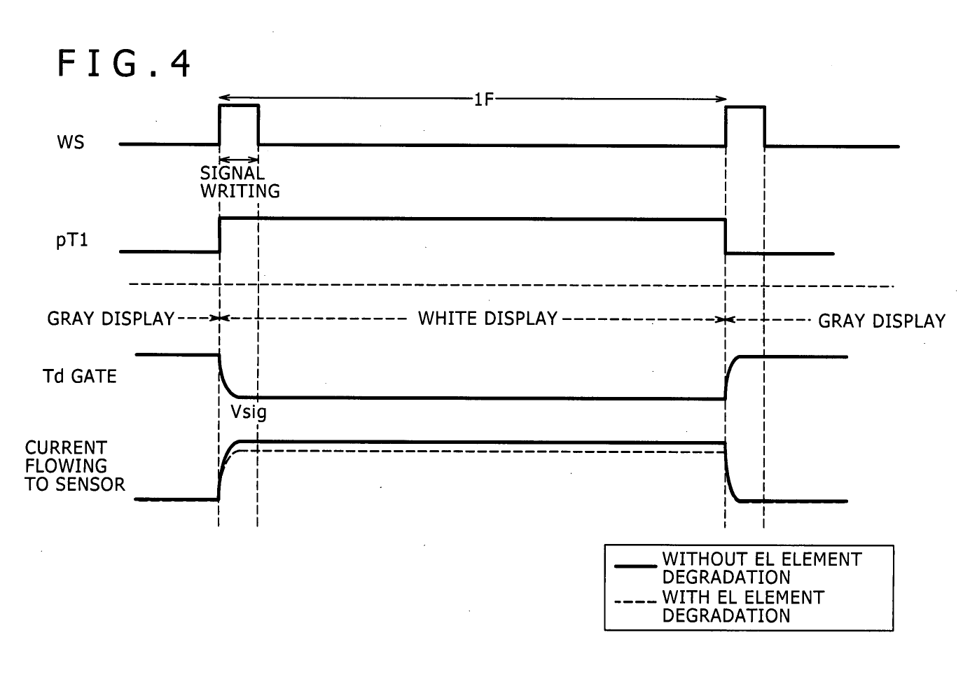

A light detection operation waveform is illustrated in FIG. 4. Here, the period within which the light detection section 100 outputs detection current to the external driver 101 is determined as one frame.

Within a signal writing period illustrated in FIG. 4, the sampling transistor Ts in the pixel circuit 10 exhibits an on state with a scanning pulse WS, and the signal value Vsig applied to a signal line DTL from the horizontal selector 11 is inputted to the pixel circuit 10. The signal value Vsig is inputted to the gate of the driving transistor Td and is retained into the holding capacitor Cs. Therefore, the driving transistor Td supplies current corresponding to the gate-source voltage thereof to the organic EL element 1 so that the organic EL element 1 emits light. For example, if the signal value Vsig is supplied for a white display within a current frame, then the organic EL element 1 emits light of the white level within the current frame.

Within the frame within which light of the white level is emitted, the switching transistor T1 in the light detection section 100 is rendered conducting with a control pulse pT1. Therefore, the variation of current of the light sensor S1 which receives the light of the organic EL element 1 is reflected on the light detection line DETL.

For example, if the amount of current flowing through the light sensor S1 thereupon is equal to the amount of light which should originally be emitted and is such as indicated by a solid line in FIG. 4, then if the emitted light amount is reduced by deterioration of the organic EL element 1, then it is such as indicated by a broken line in FIG. 4.

Since a variation of current corresponding to degradation of the luminance of emitted light appears on the light detection line DETL, the external driver 101 can detect the current amount and obtain information of the degree of degradation. Then, the information is fed back to the horizontal selector 11 to correct the signal value Vsig to carry out compensation for the luminance degradation. Accordingly, a screen burn can be decreased.

However, such a light detection system as described above gives rise to the following disadvantage.

In particular, the light sensor S1 receives emitted light of the organic EL element 1 and increases the current thereof. For a diode as the light sensor S1, preferably an off region thereof in which a great current variation is exhibited, that is, an applied voltage of a negative value proximate to zero, is used. This is because the current variation can be detected comparatively precisely.

However, even if the current value at this time indicates an increase, since it is very low with respect to the on current, if it is intended to detect the luminance variation with a high degree of accuracy, then a long period of time may be required for charging the parasitic capacitance of the light detection line DETL. For example, it is difficult to detect a current variation with a high degree of accuracy in one frame.

As a countermeasure, it is a possible idea to increase the size of the light sensor S1 to increase the amount of current. However, as the size increases, the ratio of the area which the light detection section 100 occupies in a pixel array 20 increases.

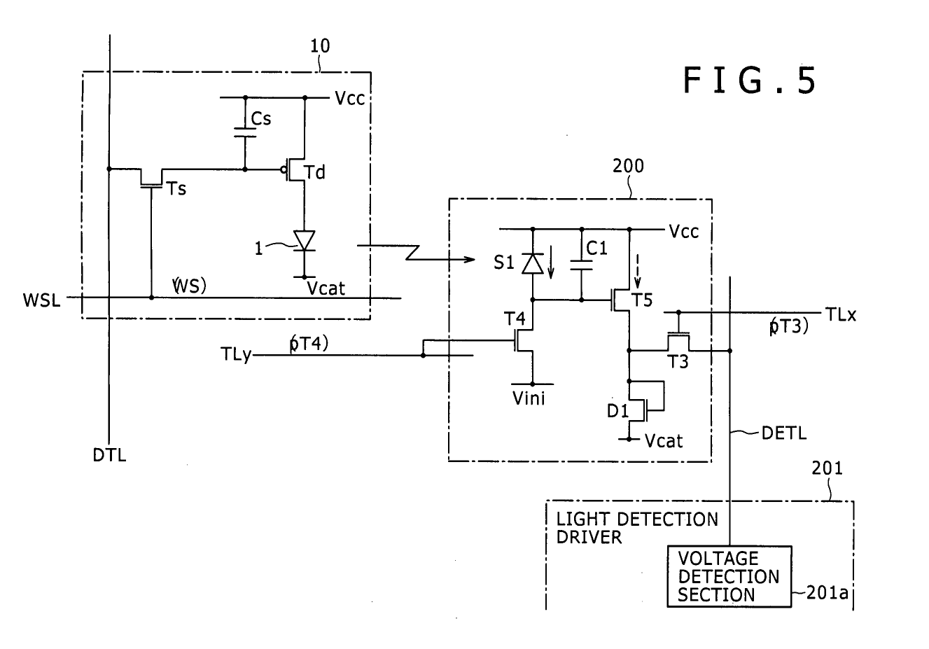

Therefore, such a light detection section 200 as shown in FIG. 5 has been contrived.

Referring to FIG. 5, a detection signal outputting circuit as the light detection section 200 includes a light sensor S1, a capacitor C1, a detection signal outputting transistor T5 in the form of an n-channel TFT, switching transistors T3 and T4, and a diode D1 in the form of a diode connection of a transistor.

The light sensor S1 is connected between the power supply voltage Vcc and the gate of the detection signal outputting transistor T5.

The light sensor S1 is produced using a PIN diode or amorphous silicon.

The light sensor S1 is disposed so as to detect light emitted from the organic EL element 1. The current of the light sensor S1 increases or decreases in response to the detection light amount. In particular, if the emission light amount of the organic EL element 1 is great, then the current increasing amount is great, but if the emission light amount of the organic EL element 1 is small, then the current increasing amount is small.

The capacitor C1 is connected between the power supply voltage Vcc and the gate of the detection signal outputting transistor T5.

The detection signal outputting transistor T5 is connected at the drain thereof to the power supply voltage Vcc and at the source thereof to the switching transistor T3.

The switching transistor T3 is connected between the source of the detection signal outputting transistor T5 and the light detection line DETL. The switching transistor T3 is turned on/off with a control pulse pT3 provided to the gate thereof from a control line TLx. When the switching transistor T3 is turned on, the source potential of the detection signal outputting transistor T5 is outputted to the light detection line DETL.

The diode D1 is connected between the source of the detection signal outputting transistor T5 and a cathode potential Vcat.

The switching transistor T4 is connected at the drain and the source thereof between the gate of the detection signal outputting transistor T5 and a reference potential Vini. The switching transistor T4 is turned on/off with a control pulse pT4 supplied from a control line TLy to the gate thereof.

When the switching transistor T4 is on, the reference potential Vini is inputted to the gate of the switching transistor T5.

A light detection driver 201 includes a voltage detection section 201a for detecting the potential of each light detection line DETL. The voltage detection section 201a detects a detection signal voltage outputted from the light detection section 200 and supplies the detected detection signal voltage as emission light amount information, which is information of luminance degradation, of the organic EL element 1 to the horizontal selector 11.

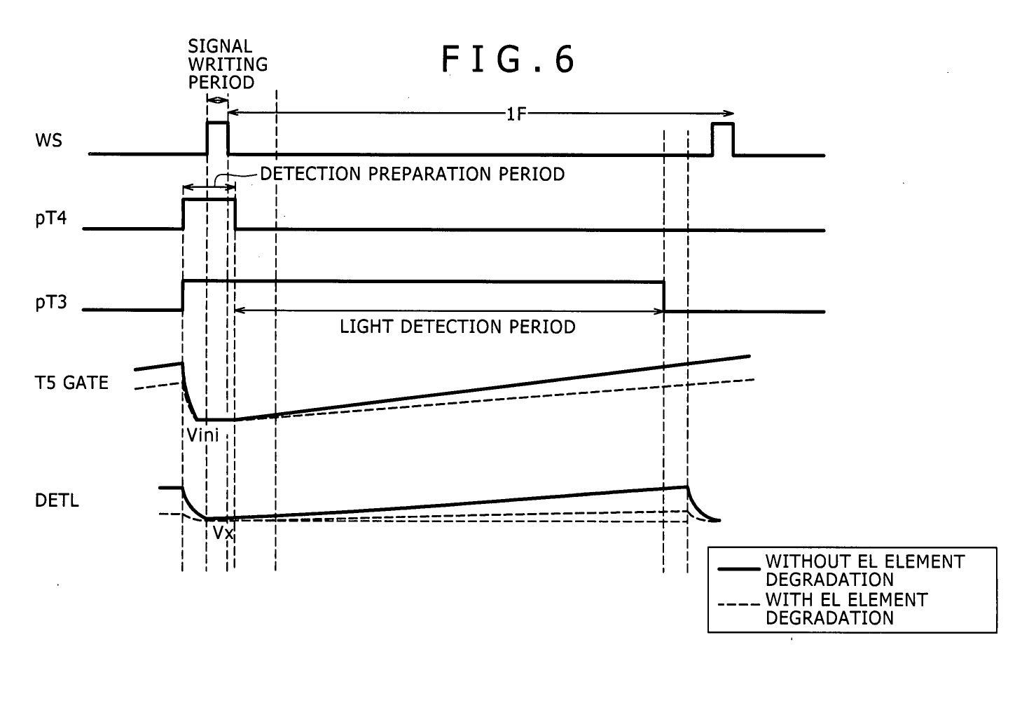

FIG. 6 illustrates operation waveforms upon light detection operation.

In particular, FIG. 6 illustrates the scanning pulse WS for writing the signal value Vsig into the pixel circuit 10, control pulses pT4 and pT3 for the light detection section 200, a gate voltage of the detection signal outputting transistor T5 and a voltage appearing on the light detection line DETL.

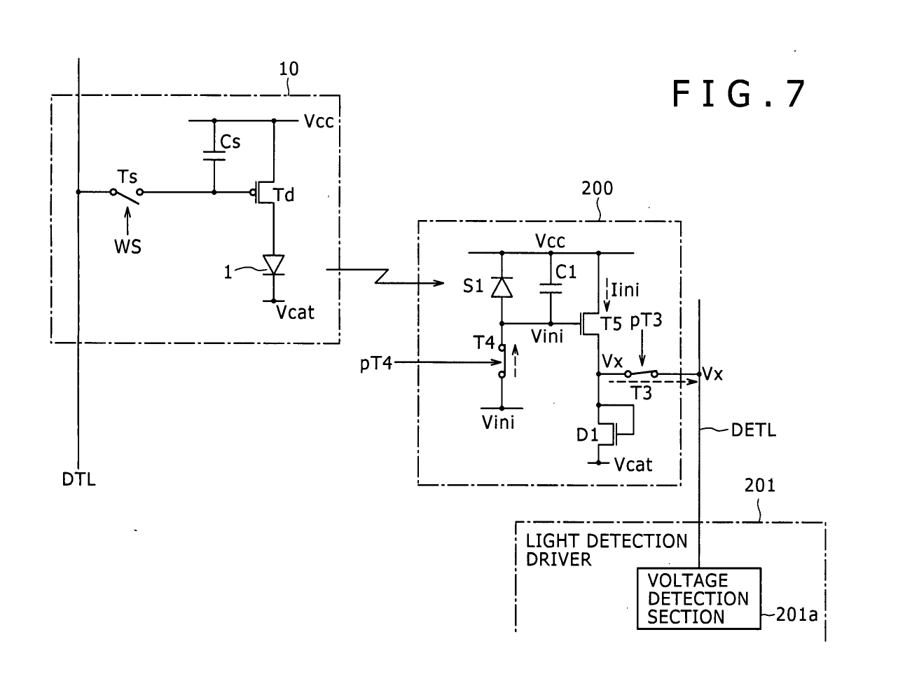

In the light detection section 200, first as a detection preparation period, the switching transistors T3 and T4 are turned on with the control pulses pT4 and pT3, respectively. A state at this time is illustrated in FIG. 7.

When the switching transistor T4 is turned on, the reference potential Vini is inputted to the gate of the detection signal outputting transistor T5.

The reference potential Vini is set to a level with which the detection signal outputting transistor T5 and the diode D1 are turned on. In particular, the reference potential Vini is higher than the sum of a threshold voltage VthT5 of the detection signal outputting transistor T5, a threshold voltage VthD1 of the diode D1 and the cathode potential Vcat, that is, VthT5+VthD1+Vcat. Therefore, since current Iini flows as seen in FIG. 7 and also the switching transistor T3 is on, a potential Vx is outputted to the light detection line DETL.

Within the detection preparation period, the gate potential of the detection signal outputting transistor T5=Vini and the potential of the light detection line DETL=Vx are obtained as seen in FIG. 6.

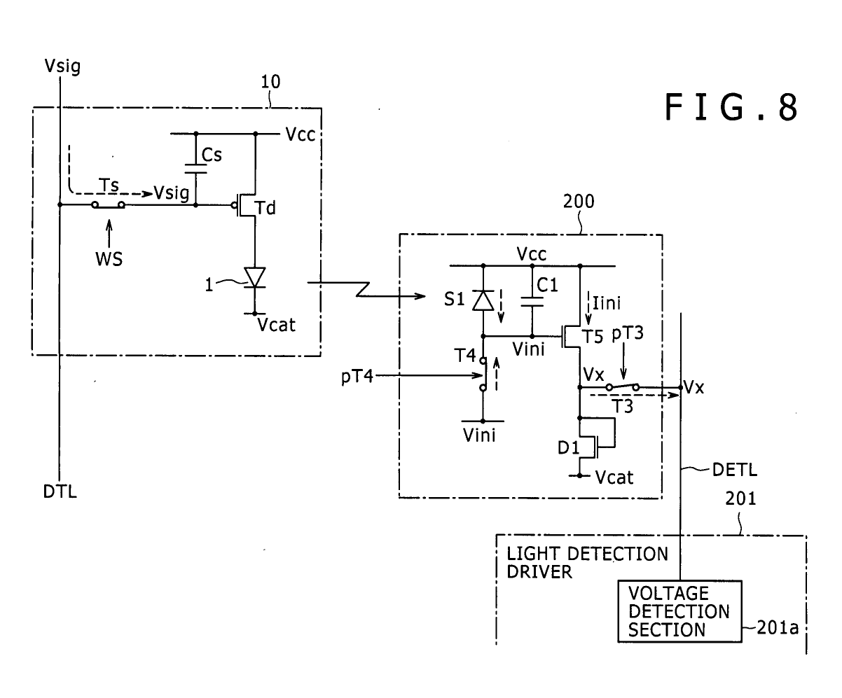

For a display within a period of one frame, signal writing is carried out in the pixel circuit 10. In particular, within the signal writing period of FIG. 6, the scanning pulse WS is placed into the H (High) level to render the sampling transistor Ts conducting. At this time, the horizontal selector 11 provides the signal value Vsig for a gradation of a white display to the signal line DTL. Consequently, in the pixel circuit 10, the organic EL element 1 emits light in accordance with the signal value Vsig. A state at this time is illustrated in FIG. 8.

At this time, the light sensor S1 receives the light emitted from the organic EL element 1 and leak current thereof varies. However, since the switching transistor T4 is in an on state, the gate voltage of the detection signal outputting transistor T5 remains the reference potential Vini.

After the signal writing ends, the sampling transistor Ts in the pixel circuit 10 is turned off.

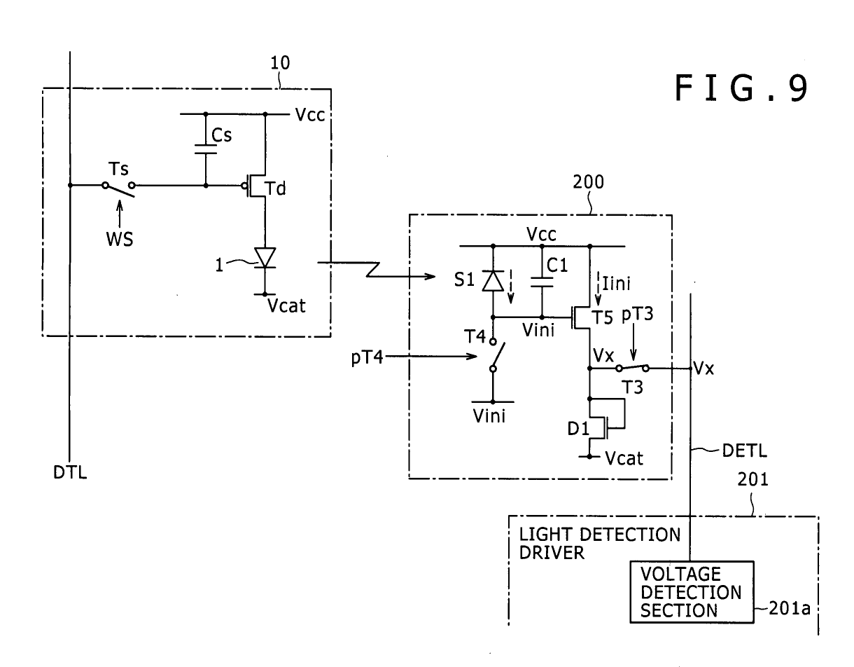

Meanwhile, in the light detection section 200, the control pulse pT4 is placed into the L (Low) level to turn off the switching transistor T4. This state is illustrated in FIG. 9.

When the switching transistor T4 is turned off, the light sensor S1 receives the light emitted from the organic EL element 1 and supplies leak current from the power supply voltage Vcc to the gate of the detection signal outputting transistor T5.

By this operation, the gate voltage of the detection signal outputting transistor T5 gradually rises from the reference potential Vini as seen in FIG. 6, and together with this, also the potential of the light detection line DETL rises from the potential Vx. This potential variation of the light detection line DETL is detected by the voltage detection section 201a. The detected potential corresponds to the amount of emitted light of the organic EL element 1. In other words, if a particular gradation display such as, for example, a white display is executed by the pixel circuit 10, then the detected potential represents a degree of degradation of the organic EL element 1. For example, the potential difference of the light detection line DETL represented by a solid line in FIG. 6 represents the potential difference when the organic EL element 1 is not degraded at all while the potential difference represented by a broken line in FIG. 6 represents the potential difference when the organic EL element 1 suffers from degradation.

After lapse of a fixed period of time, the control pulse pT3 is placed into the L level to turn off the switching transistor T3 thereby to end the detection operation.

Detection, for example, regarding the pixel circuits 10 in a pertaining line within one frame is carried out in such a manner as described above.

The detection signal outputting circuit of the light detection section 200 has a configuration of a source follower circuit, and if the gate voltage of the detection signal outputting transistor T5 varies, then the variation is outputted from the source of the detection signal outputting transistor T5. In other words, the variation of the gate voltage of the detection signal outputting transistor T5 by variation of leak current of the light sensor S1 is outputted from the source of the detection signal outputting transistor T5 to the light detection line DETL.

Meanwhile, the gate-source voltage Vgs of the detection signal outputting transistor T5 is set so as to be higher than the threshold voltage Vth of the detection signal outputting transistor T5. Therefore, the value of current outputted from the detection signal outputting transistor T5 is much higher than that of the circuit configuration described hereinabove with reference to FIG. 3, and even if the value of current of the light sensor S1 is low, since it passes the detection signal outputting transistor T5, detection information of the emitted light amount can be outputted to the light detection driver 201.

Therefore, although a light detection operation of high accuracy is possible, the light detection section 200 is formed from an increased number of elements. In particular, the light detection section 200 may require the light sensor S1, the four transistors T3, T4, T5 and D1, and the capacitor C1, and this gives rise to increase of the number of elements per one pixel and increase of the ratio of transistors including the pixel circuit 10. This makes a cause of a low yield.

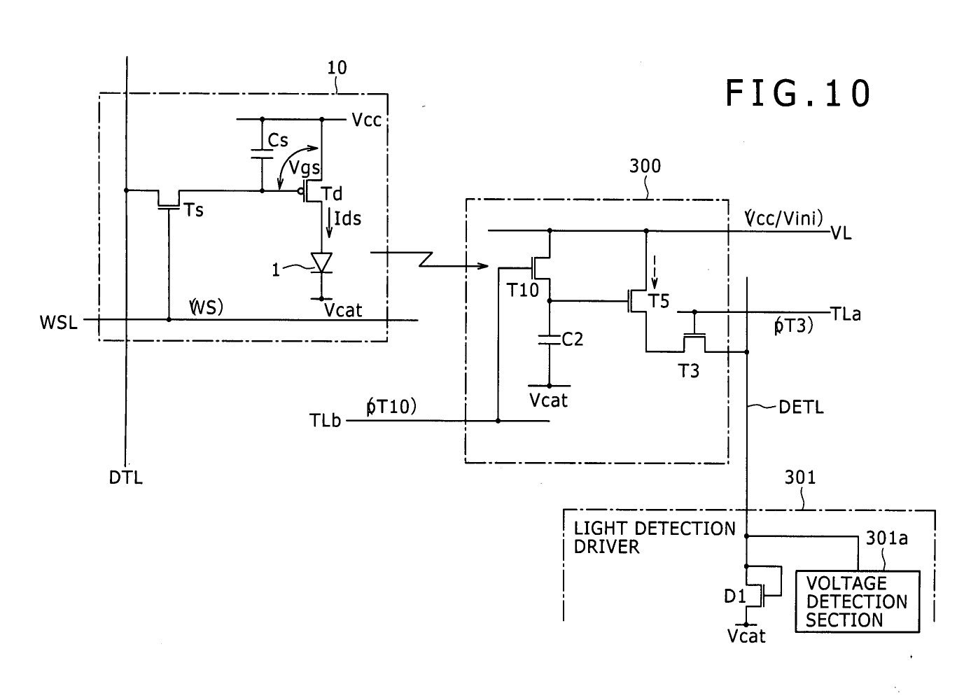

Further, the configuration example 3 is shown in FIG. 10.

The light detection section 300 shown in FIG. 10 includes a sensor serving transistor T10, capacitor C2, detection signal outputting transistor T5 in the form of an n-channel TFT, and a switching transistor T3.

The sensor serving transistor T10 is connected between a power supply line VL and the gate of the detection signal outputting transistor T5.

The sensor serving transistor T10 is provided in place of the light sensor S1 in the form of a diode in the configuration described hereinabove with reference to FIG. 5, and is changed over between an on state and an off state so as to function as a switching element and besides functions as a light sensor in the off state thereof.

A TFT has a structure wherein it is formed by disposing a gate metal, a source metal and so forth on a channel layer. The sensor serving transistor T10 is formed so as to have a structure wherein, for example, a metal layer which forms the source and the drain does not comparatively intercept light to the channel layer above the channel layer. In other words, the TFT should be formed so that external light may be admitted into the channel layer.

The sensor serving transistor T10 is disposed so as to detect light emitted from the organic EL element 1. Then, in the off state of the sensor serving transistor T10, leak current thereof increases or decreases in response to the emitted light amount. In particular, if the emitted light amount of the organic EL element 1 is great, then the increasing amount of the leak current is great, but if the emitted light amount is small, then the increasing amount of the leak current is small.

The sensor serving transistor T10 is connected at the gate thereof to a control line TLb. Accordingly, the sensor serving transistor T10 is turned on/off with a control pulse pT10. When the sensor serving transistor T10 is turned on, the potential of the power supply line VL is inputted to the gate of the detection signal outputting transistor T5.

To the power supply line VL, a pulse voltage having two values including a power supply voltage Vcc and a reference voltage Vini is provided from the detection operation control section 21.

The capacitor C2 is connected between the cathode potential Vcat and the gate of the detection signal outputting transistor T5. The capacitor C2 is provided to retain the gate voltage of the detection signal outputting transistor T5.

The detection signal outputting transistor T5 is connected at the drain thereof to the power supply line VL. The detection signal outputting transistor T5 is connected at the source thereof to the switching transistor T3.

The switching transistor T3 is connected between the source of the detection signal outputting transistor T5 and the light detection line DETL. The switching transistor T3 is connected at the gate thereof to a control line TLa and accordingly is turned on/off with the control pulse pT3. When the switching transistor T3 is turned on, current flowing to the detection signal outputting transistor T5 is outputted to the light detection line DETL.

A light detection driver 301 includes a voltage detection section 301a for detecting the potential of each of the light detection lines DETL. The voltage detection section 301a detects a detection signal voltage outputted from the light detection section 300.

It is to be noted that the diode D1, for example, in the form of a transistor of a diode connection is connected to the light detection line DETL so as to provide a current path to a fixed value, for example, to the cathode potential Vcat.

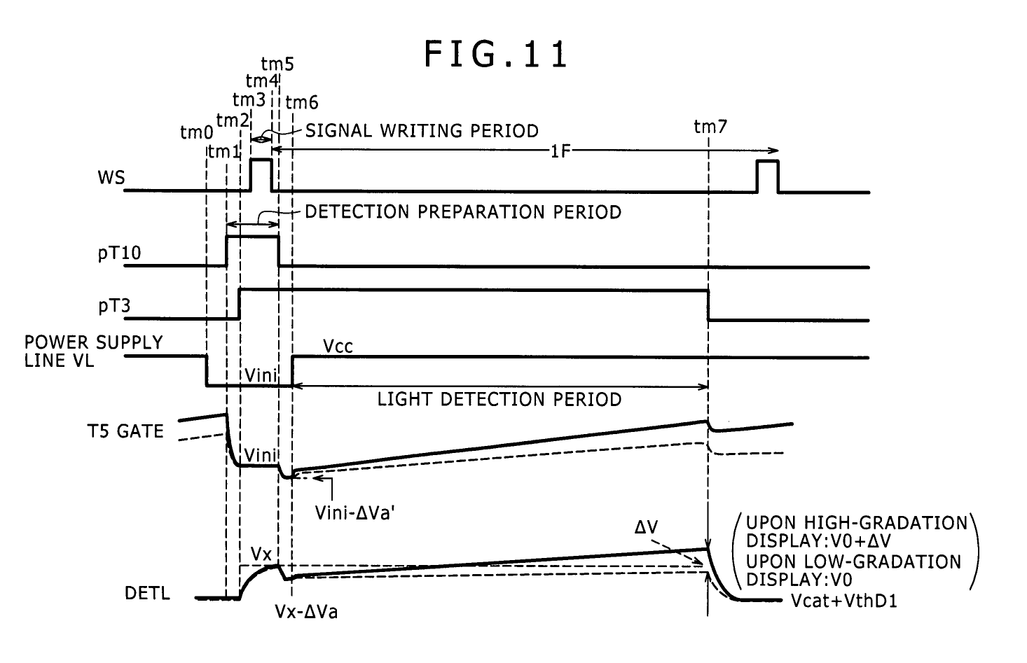

The light detection operation by the light detection section 300 is described with reference to FIGS. 11 to 16.

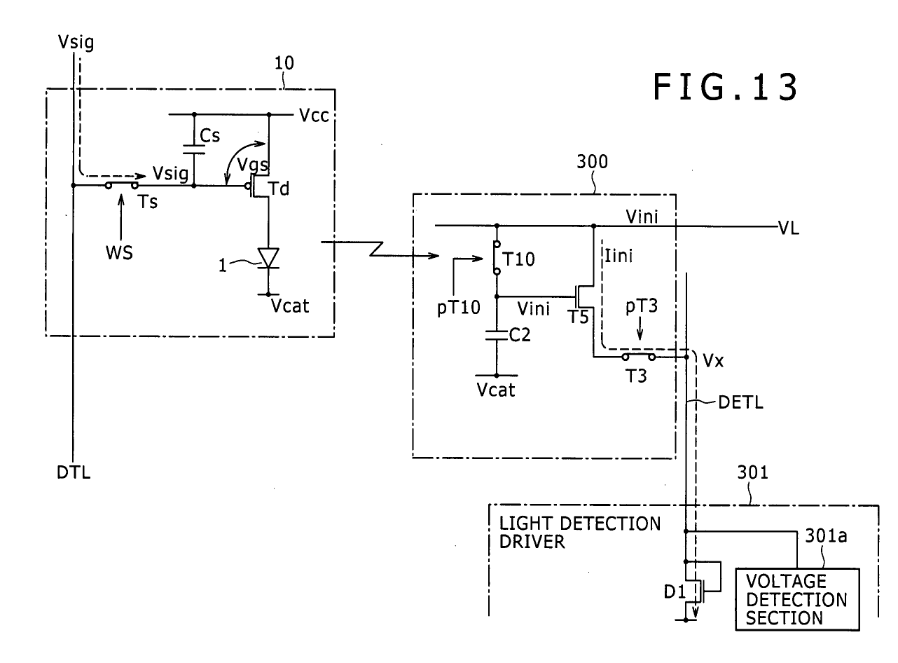

FIG. 11 shows waveforms regarding the operation of the light detection section 30. In particular, FIG. 13 shows a scanning pulse WS to be applied from the write scanner 12 to a pixel circuit 10, particularly to the sampling transistor Ts. Also, FIG. 13 further illustrates control pulses pT10, pT3, and a power supply pulse of the power supply line VL to be applied to the control lines TLb and TLa. FIG. 13 further illustrates a gate voltage of the detection signal outputting transistor T5 and a voltage appearing on the light detection line DETL.

It is assumed that one light detection section 300 carries out light amount detection regarding a corresponding one of the pixel circuits 10 within a period of one frame as seen in FIG. 11.

First, within a period from time tm0 to time tm6 including a detection preparation period, the power supply line VL is set to the reference voltage Vini. Further, within the period from time tm1 to time tm5, the control pulse pT10 is set to the H level to place the sensor serving transistor T10 into an on state to carry out detection preparations.

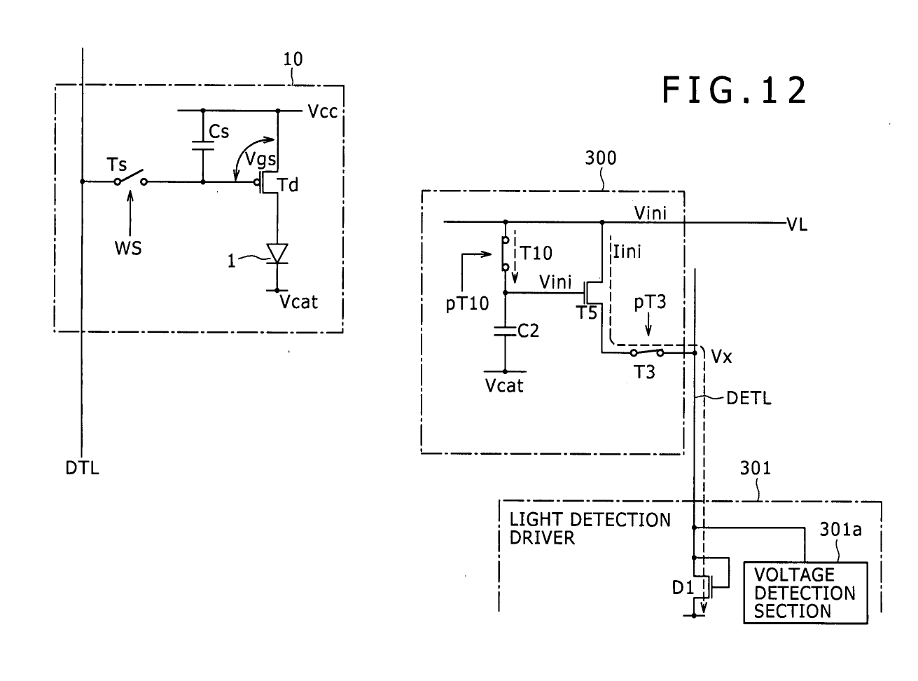

A state at this time is illustrated in FIG. 12. When the sensor serving transistor T10 is placed into an on state at time tm1 at which the power supply line VL has the reference voltage Vini, the reference voltage Vini is inputted to the gate of the detection signal outputting transistor T5. Further, when the switching transistor T3 is placed into an on state by the control pulse pT3 at time tm2, the source of the detection signal outputting transistor T5 is connected to the light detection line DETL.

Here, the reference voltage Vini is a voltage with which the detection signal outputting transistor T5 is placed into an on state. Therefore, current Iini flows as seen in FIG. 12, and the light detection line DETL exhibits a certain potential Vx. Since such operations as described above carried out within the detection preparation period, the gate potential of the detection signal outputting transistor T5 is equal to the reference voltage Vini and the potential of the light detection line DETL is equal to the potential Vx.

Within the period from time tm3 to time tm4 of FIG. 11, writing of the signal value Vsig into the pixel circuits 10 is carried out for a display for a one-frame period. In particular, within the signal wiring period of FIG. 13, the scanning pulse WS is set to the H level to render the sampling transistor Ts conducting. At this time, the horizontal selector 11 applies the signal value Vsig, for example, of the white display gradation to the signal line DTL. Consequently, in the pixel circuits 10, the organic EL element 1 emits light in accordance with the signal value Vsig. A state in this instance is illustrated in FIG. 13.

At this time, since the sensor serving transistor T10 is on, the gate voltage of the detection signal outputting transistor T5 remains equal to the reference potential Vini.

After the signal writing ends, the sampling transistor Ts in the pixel circuits 10 is turned off at time tm4.

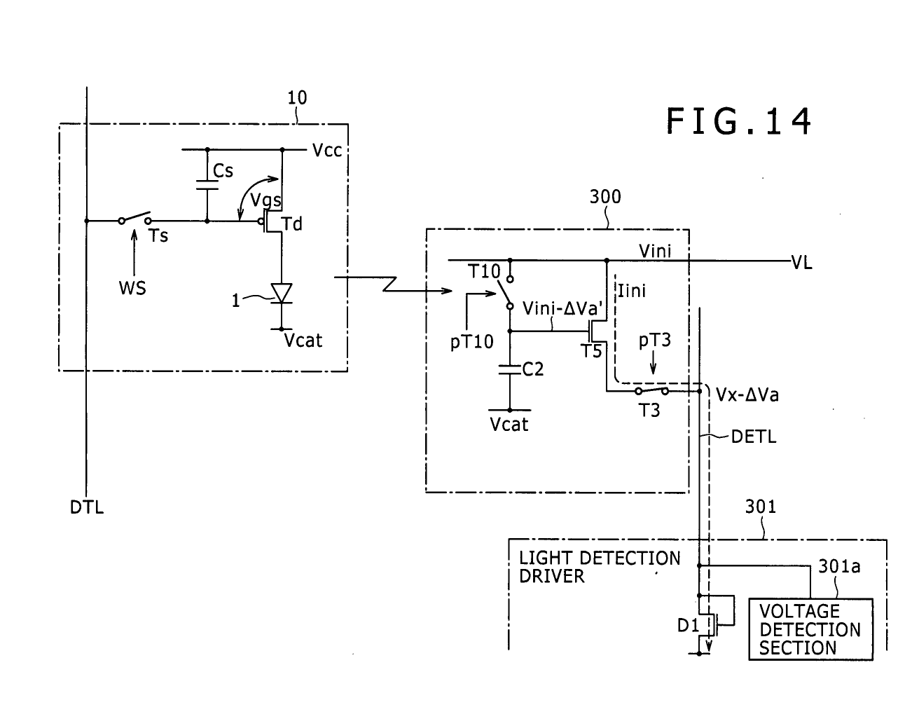

Meanwhile, in the light detection section 30, the control pulse pT10 is placed into the L level at time tm5 to turn off the sensor serving transistor T10. This state is illustrated in FIG. 14.

Where the sensor serving transistor T10 is turned off, a coupling amount ΔVa′ corresponding to a capacitance ratio between the capacitor C2 and the parasitic capacitance of the sensor serving transistor T10 is inputted to the gate of the detection signal outputting transistor T5. Therefore, also the voltage of the light detection line DETL varies to a potential given by Vx−ΔVa.

By the coupling, a potential difference appears between the source and the drain of the sensor serving transistor T10 and varies the leak amount of the sensor serving transistor T10 depending upon the received light amount. However, the leak current at this time little varies the gate voltage of the detection signal outputting transistor T5. This arises from the facts that the potential difference between the source and the drain of the sensor serving transistor T10 is small and that the time before a next operation of varying the power supply line VL from the reference potential Vini to the power supply voltage Vcc is short.

At time tm6 after a fixed period of time elapses, the potential of the power supply line VL are changed from the reference potential Vini to the power supply voltage Vcc.

By this operation, the coupling from the power supply line VL is inputted to the gate of the detection signal outputting transistor T5, and consequently, the gate potential of the detection signal outputting transistor T5 rises. Since the potential of the power supply line VL varies to the high potential, a great potential difference appears between the source and the drain of the sensor serving transistor T10, and leak current flows from the power supply line VL to the gate of the detection signal outputting transistor T5 in response to the received light amount.

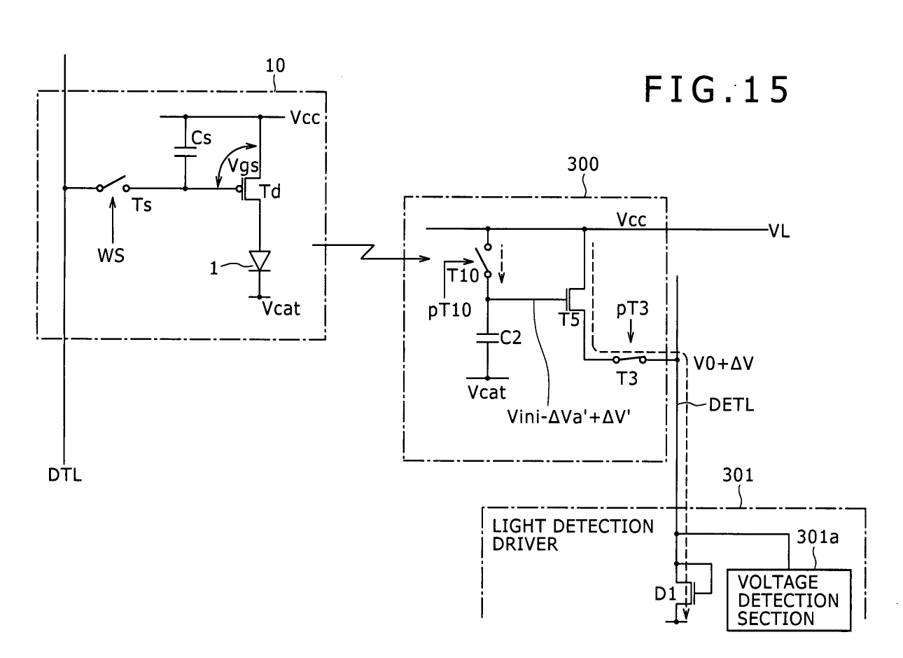

This state is illustrated in FIG. 15. By the operation described, the gate voltage of the detection signal outputting transistor T5 varies from Vini−ΔVa′ to Vini−ΔVa′+ΔV′. FIG. 11 illustrates a manner wherein the gate potential of the detection signal outputting transistor T5 gradually rises from Vini−ΔVa′ to Vini−ΔVa′+ΔV′ after time tm6.

Together with this, also the potential of the light detection line DETL rises from the potential Vx−ΔVa to V0+ΔV. It is to be noted that the potential V0 is a potential of the light detection line DETL in a low gradation displaying state, that is, in a black displaying state. Since the amount of current flowing to the sensor serving transistor T10 increases as the amount of light received by the sensor serving transistor T10 increases, the voltage of the light detection line DETL upon a high gradation display is higher than that upon a low gradation display.

This potential variation of the light detection line DETL is detected by the voltage detection section 301a. This detection voltage corresponds to the emitted light amount of the organic EL element 1. In other words, if a particular gradation display such as, for example, a white display is being executed by the pixel circuit 10, then the detection potential represents a degree of degradation of the organic EL element 1.

After lapse of a fixed interval of time, the control pulse pT3 is set to the L level at time tm7 to turn off the switching transistor T3 thereby to end the detection operation. Consequently, no more current is supplied to the light detection line DETL, and the potential becomes equal to Vcat+VthD1. It is to be noted that VthD1 represents a threshold voltage of the diode D1.

For example, detection with regard to the pixel circuits 10 of the pertaining line within one frame is carried out in the following manner.

With the light detection section 300 which carries out such a light detection operation as described above, an accurate light detection operation can be achieved similarly to the light detection section 200 described hereinabove with reference to FIG. 5.

Further, since the sensor serving transistor T10 is used, the number of elements can be reduced. However, since the control lines TLb and TLa for the transistors T10 and T3 are required and the power supply line VL is used as a pulse voltage power supply, three control systems are required for one light detection section 300.

For example, while the configuration examples 2 and 3 allow highly accurate detection, the configuration example 2 has a drawback that the light detection section 200 includes an increased number of elements while the configuration example 3 has another drawback that, although the number of elements decreases, three systems of control lines are required, that is, the number of drivers for driving the control lines increases.

Taking the foregoing into consideration, the embodiments of the present invention make it possible to simplify the configuration of a light detection section and a control system therefor and achieve a high yield while maintaining the feature that light detection can be carried out with a high degree of accuracy similarly as with the configuration example 2 and the configuration example 3.

### 3. First Embodiment

### 3-1. Circuit Configuration

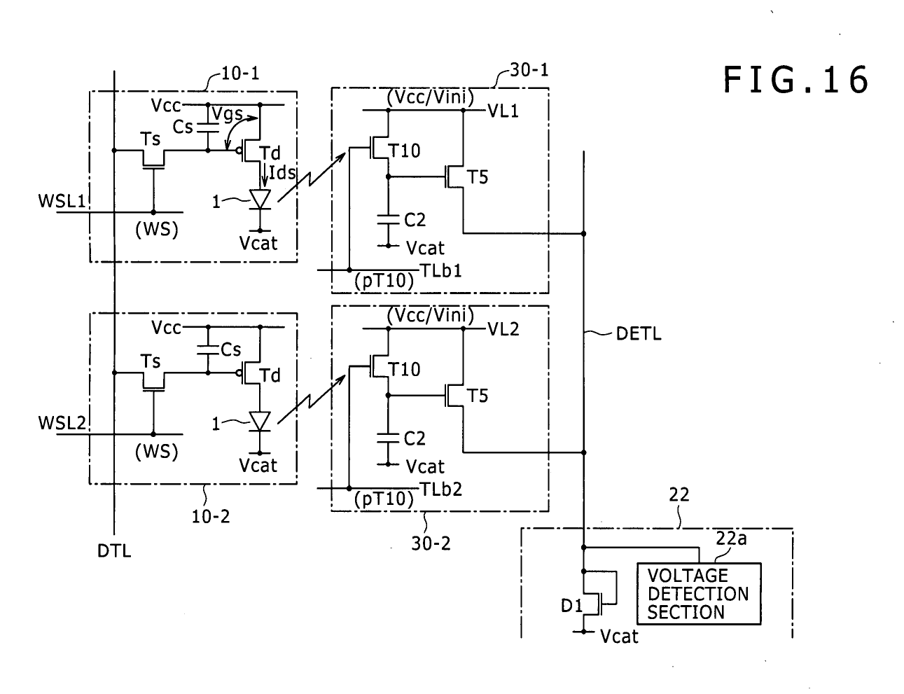

A configuration of the pixel circuit 10 and a light detection section 30 of the embodiment shown in FIG. 1 is shown in FIG. 16.

It is to be noted that FIG. 16 shows two pixel circuits 10, that is, 10-1 and 10-2, connected to the same signal line DTL, and two light detection sections 30, that is, 30-1 and 30-2, corresponding to the pixel circuits 10-1 and 10-2, respectively, and connected to the same light detection line DETL. In the following description, except where distinction is required particularly, they are referred to collectively as “pixel circuits 10” and “light detection sections 30.”

Referring to FIG. 16, the pixel circuit 10 shown includes a sampling transistor Ts in the form of an re-channel TFT, a holding capacitor Cs, a driving transistor Td in the form of a p-channel TFT, and an organic EL element 1.

As seen in FIG. 1, each pixel circuit 10 is disposed at a crossing point between a signal line DTL and a writing control line WSL. The signal line DTL is connected to the drain of the sampling transistor Ts, and the writing control line WSL is connected to the gate of the sampling transistor Ts.

The driving transistor Td and the organic EL element 1 are connected in series between a power supply voltage Vcc and a cathode potential Vcat.

The sampling transistor Ts and the holding capacitor Cs are connected to the gate of the driving transistor Td. The gate-source voltage of the driving transistor Td is represented by Vgs.

In the present pixel circuit 10, when the horizontal selector 11 applies a signal value corresponding to a luminance signal to the signal line DTL, if a write scanner 12 places the scanning pulse WS of the writing control line WSL to the H level, then the sampling transistor Ts is rendered conducting and the signal value is written into the holding capacitor Cs. The signal value potential written in the holding capacitor Cs becomes the gate potential of the driving transistor Td.

If the write scanner 12 places the scanning pulse WS of the writing control line WSL into the L level, then although the signal line DTL and the driving transistor Td are electrically disconnected from each other, the gate potential of the driving transistor Td is held stably by the holding capacitor Cs.

Then, driving current Ids flows to the driving transistor Td and the organic EL element 1 so as to be directed from the power supply voltage Vcc toward the cathode potential Vcat.

At this time, the driving current Ids exhibits a value corresponding to the gate-source voltage Vgs of the driving transistor Td, and the organic EL element 1 emits light with a luminance corresponding to the current value.

In short, in the pixel circuit 10, the signal value potential is written from the signal line DTL into the holding capacitor Cs to vary the gate application voltage of the driving transistor Td thereby to control the value of current to flow to the organic EL element 1 to obtain a gradation of color development.

Since the driving transistor Td in the form of a p-channel TFT is designed such that it is connected at the source thereof to the power supply voltage Vcc so that the driving transistor Td normally operates within a saturation region thereof, the driving transistor Td serves as a source of constant current which has a value given by the following expression (1):

Ids=(½)·μ·(W/L)·Cox·(Vgs−Vth)² (1)

where Ids is current flowing between the drain and the source of the transistor which operates in its saturation region, μ the mobility, W the channel width, L the channel length, Cox the gate capacitance, and Vth the threshold voltage of the driving transistor Td.

As apparently recognized from the expression (1) above, within the saturation region, the drain current Ids of the driving transistor Td is controlled by the gate-source voltage Vgs. Since the gate-source voltage Vgs of the driving transistor Td is kept fixed, the driving transistor Td operates as a constant current source and can cause the organic EL element 1 to emit light with a fixed luminance.

Generally, the current-voltage characteristic of the organic EL element 1 degrades as time passes. Thus, in the pixel circuit 10, together with a time-dependent variation of the organic EL element 1, the drain voltage of the driving transistor Td varies. However, since the gate-source voltage Vgs of the driving transistor Td is fixed in the pixel circuit 10, a fixed amount of current flows to the organic EL element 1 and the emitted light luminance does not vary. In short, stabilized gradation control can be anticipated.

However, as time passes, not only the driving voltage but also the light emission efficiency of the organic EL element 1 degrades. In other words, even if the same current is supplied to the organic EL element 1, the emitted light luminance of the organic EL element 1 drops together with time. As a result, such a screen burn as described hereinabove with reference to FIG. 59A appears.

Therefore, the light detection section 30 is provided so that correction or compensation corresponding to degradation of the emitted light luminance is carried out.

The light detection section 30 in the present embodiment includes a sensor serving transistor T10, a capacitor C2, and a detection signal outputting transistor T5 in the form of an n-channel TFT as seen in FIG. 16.

The sensor serving transistor T10 is connected between a power supply line VL and the gate of the detection signal outputting transistor T5.

The sensor serving transistor T10 is provided in place of the light sensor S1 in the form of a diode in the configuration described hereinabove with reference to FIG. 5, and is changed over between an on state and an off state so as to function as a switching element and besides functions as a light sensor in the off state thereof.

The sensor serving transistor T10 is disposed so as to detect light emitted from the organic EL element 1. Then, in the off state of the sensor serving transistor T10, leak current thereof increases or decreases in response to the emitted light amount. In particular, if the emitted light amount of the organic EL element 1 is great, then the increasing amount of the leak current is great, but if the emitted light amount is small, then the increasing amount of the leak current is small.

The sensor serving transistor T10 is connected at the gate thereof to a control line TLb. Accordingly, the sensor serving transistor T10 is turned on/off with a control pulse pT10 of a detection operation control section 21 described hereinabove with reference to FIG. 1. When the sensor serving transistor T10 is turned on, the potential of the power supply line VL is inputted to the gate of the detection signal outputting transistor T5.

It is to be noted that, as described in FIG. 1, a pulse voltage which can assume the two values of the power supply voltage Vcc and the reference potential Vini is supplied from the detection operation control section 21 to the power supply line VL.

The capacitor C2 is connected between the cathode potential Vcat and the gate of the detection signal outputting transistor T5. The capacitor C2 is provided to retain the gate voltage of the detection signal outputting transistor T5.

A light detection driver 22 includes a voltage detection section 22a for detecting the potential of each of the light detection lines DETL. The voltage detection section 22a detects a detection signal voltage outputted from the light detection section 30 and supplies the detection signal voltage as emitted light amount information of the organic EL element 1, that is, as information of luminance degradation of the organic EL element 1, to the horizontal selector 11 described hereinabove with reference to FIG. 1, particularly to the signal value correction section 11a.

It is to be noted that the diode D1, for example, in the form of a transistor of a diode connection is connected to the light detection line DETL so as to provide a current path to a fixed value, for example, to the cathode potential Vcat.

According to this, the diode D1 in the light detection section 200 shown in FIG. 5 is disposed outside of the pixel array 20, that is, on the light detection driver 22 side, and this makes a factor for reduction of the number of elements of the light detection section 30 of the present example.

In this manner, the light detection section 30 of the present example is configured from the two transistors T5 and T10 and the capacitor C2 through provision of the sensor serving transistor T10, external disposition of the diode D1 and direct connection of the detection signal outputting transistor T5 to the light detection line DETL. Further, to one light detection section 30, only two systems of control lines are connected including the control line TLb for providing a control pulse pT10 for controlling the sensor serving transistor T10 between on and off and the power supply line VL for providing a pulse voltage.

### 3-2. Light Detection Operation Period

While the light detection operation of detecting the emitted light amount of the organic EL element 1 of the pixel circuit 10 is carried out by the light detection section 30 described hereinabove with reference to FIG. 16, an execution period of the light detection operation and so forth of the light detection section 30 is described here.

It is to be noted that the light detection operation period described here is similar also to those of the second to seventh embodiments hereinafter described.

FIG. 17A illustrates a light detection operation carried out after a normal image display.

It is to be noted that the term “normal image display” used hereinbelow signifies a state wherein a signal value Vsig based on an image signal supplied to the display apparatus is provided to each pixel circuit 10 to carry out an image display of an ordinary dynamic image or still image.

It is assumed that, in FIG. 17A, the power supply to the display apparatus is turned on at time to.

Here, various initialization operations upon turning on of the power supply are carried out before time t1, and a normal image display is started at time t1. Then, after time t1, a display of frames F1, F2, . . . of video images is executed as the normal image display.

In this period, the light detection section 30 does not execute a light detection operation.

At time t2, the normal image display ends. This corresponds to such a case that, for example, a turning off operation for the power supply is carried out.

In the example of FIG. 17A, the light detection section 30 executes a light detection operation after time t2.

In this instance, the light detection operation is carried out for pixels for one line, for example, within a period of one frame.

For example, when the light detection operation is started, the horizontal selector 11 causes the pixel circuits 10 within a first frame Fa to execute such a display that the first line is displayed by a white display as seen in FIG. 17B. In short, the signal value Vsig is applied to the pixel circuits 10 such that the pixel circuits 10 in the first line carry out a white display, that is, a high luminance gradation display while all of the other pixel circuits 10 execute a black display.

Within the period of the frame Fa, the light detection sections 30 corresponding to the pixels in the first line detect the emitted light amount of the corresponding pixels. The light detection driver 22 carries out voltage detection of the light detection lines DETL of the columns to obtain emitted light luminance information of the pixels in the first line. Then, the emitted light luminance information is fed back to the horizontal selector 11.

In the next frame Fb, the horizontal selector 11 causes the pixel circuits 10 to execute such a display that a white display is executed in the second line as seen in FIG. 17B. In other words, the horizontal selector 11 causes the pixel circuits 10 in the second line to execute a white display, that is, a high luminance gradation display but causes all of the other pixel circuits 10 to execute a black display.

Within the period of the frame Fb, the light detection sections 30 corresponding to the pixels in the second line detect the emitted light amount of the corresponding pixels. The light detection driver 22 carries out voltage detection of the light detection lines DETL of the columns to obtain emitted light luminance information of the pixels in the second line. Then, the emitted light luminance information is fed back to the horizontal selector 11.

Such a sequence of operations as described above is repeated up to the last line. At a stage wherein emitted light luminance information of the pixels of the last line is detected and fed back to the horizontal selector 11, the light detection operation ends.

The horizontal selector 11 carries out a signal value correction process based on the emitted light luminance information of the pixels.

When the light detection operation described above is completed at time t3, required processes such as, for example, to switch off the power supply to the display apparatus are carried out.

It is to be noted that, while, in the light detection operation for each line, the light detection sections 30 corresponding to the pixels in the line are selected, the selection is carried out with a power supply pulse provided to the power supply line VL and a control pulse pT10 for the sensor serving transistor T10 provided from the detection operation control section 21.

In particular, operation of the light detection sections 30 is controlled such that a voltage variation responsive to light detection by only the light detection sections 30 corresponding to the pixels of the pertaining line may appear on the light detection line DETL in each frame.

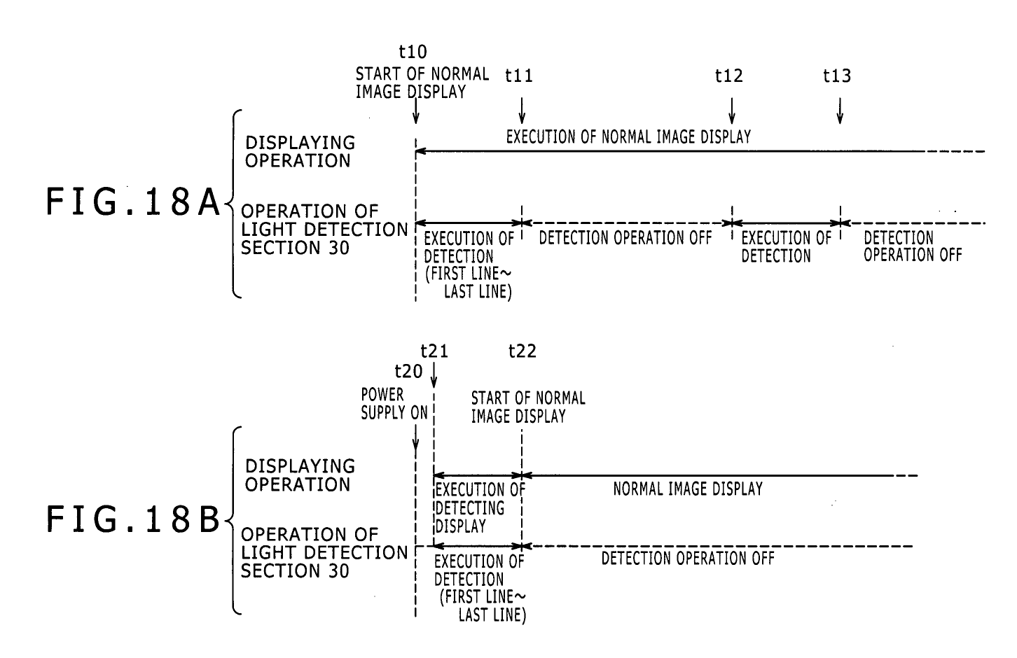

FIG. 18A illustrates a light detection operation carried out in a certain period during execution of the normal image display.

It is assumed that the normal image display is started, for example, at time t10. After the normal image display is started, the light detection operation by the light detection sections 30 is carried out for one line within a period of one frame. In other words, a detection operation similar to that carried out within the period from time t2 to time t3 of FIG. 17A is carried out. However, the display of each pixel circuit 10 is an image display in an ordinary case but is not a display for a light detection operation as in FIG. 17B.

When the light detection operation ends for the first to last lines, the light detection section 30 ends the light detection operation once.

The light detection operation is carried out after every predetermined period, and if it is assumed that the timing of a detection operation period comes at certain time t12, then a light detection operation from the first to the last line is carried out similarly. Then, after the light detection operation is completed, no light detection operation is carried out within a predetermined period of time.

For example, during execution of the normal image display, the light detection operation may be carried out in parallel in a predetermined period.

FIG. 18B illustrates a light detection operation carried out when the power supply is turned on.

It is assumed that the power supply to the display apparatus is turned on at time t20. Here, immediately after various initialization operations such as starting up when the power supply is made available are carried out, a light detection operation is carried out from time t21. In particular, a detection operation similar to the operation carried out within the period from time t2 to time t3 of FIG. 17 is carried out. Also each pixel circuit 10 executes a display for a light detection operation for displaying one line by a white display for every one frame as shown in FIG. 17B.

After the light detection operation for the first to the last lines is completed, the horizontal selector 11 causes the pixel circuits 10 to start the normal image display at time t22. The light detection sections 30 do not carry out the light detection operation.

For example, if the light detection operation is carried out after the normal image display comes to an end, during execution of the normal image display, before ordinary image display is started or at some other timing as described above and then the signal value correction process based on the detection is carried out, degradation of the emitted light luminance can be coped with.

It is to be noted that the light detection operation may be carried out, for example, at both timings after the normal image display ends and before the ordinary image display is started.

Where the light detection operation is carried out at both or one of the timings after the normal image display ends and before the ordinary image display is started, since such a display for the light detection operation as illustrated in FIG. 17B can be carried out, there is an advantage that the detection can be carried out with emitted light of a high gradation as in the case of the white display. Also it is possible for a display of an arbitrary gradation to be executed to detect a degree of degradation for each gradation.

On the other hand, where the light detection operation is carried out during execution of the normal image display, since the substance of an image being displayed actually is indefinite, it is not possible to specify a gradation to carry out the light detection operation. Therefore, it is necessary to decide a detection value as a value determined taking an emitted light gradation, that is, the signal value Vsig applied then to a pixel of the object of detection into consideration and carry out a signal value correction process. It is to be noted that, since a light detection operation and a correction process can be carried out repetitively during execution of the normal image display, there is an advantage that luminance degradation of the organic EL elements 1 can be coped with substantially normally.

### 3-3. Light Detection Operation

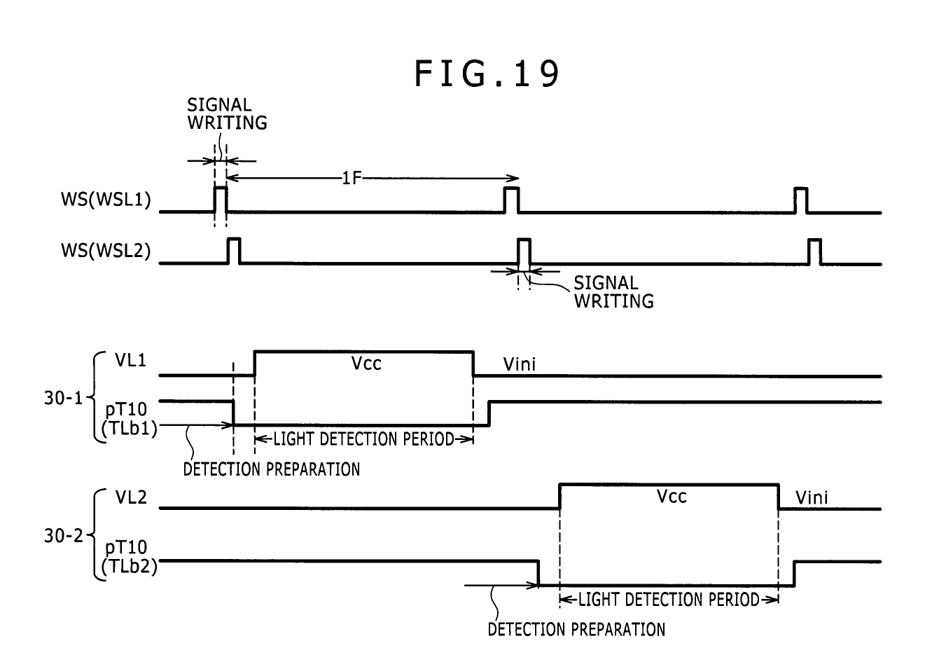

The light detection operation by the light detection section 30 of the present example is described with reference to FIGS. 19 to 25. The light detection operation is executed after the normal image display of FIGS. 17A and 17B comes to an end.

FIG. 19 illustrates a scanning pulse WS to the pixel circuits 10-1 and 10-2, control pulse pT10 to the light detection section 30-1, and control pulses pT3 and pT10 to the light detection section 30-2. For example, as seen in FIGS. 17A and 17B, light detection is carried out for every one line after the normal image display ends or at some other timing, and a single detection operation is carried out within one frame.

In particular, while, in the pixel circuit 10-1, writing of the signal value Vsig is carried out to carry out emission of light for one frame at a certain timing, at this time, in the light detection section 30-1, light detection operation is carried out in accordance with the control pulse pT10 and power supply pulse of the power supply line VL.

Within a next frame period, writing of the signal value Vsig is carried out to carry out emission of light for one frame at a certain timing by the pixel circuit 10-2, and at this time, the light detection section 30-2 carries out light detection operation in accordance with the control pulse pT10 and power supply pulse of the power supply line VL.

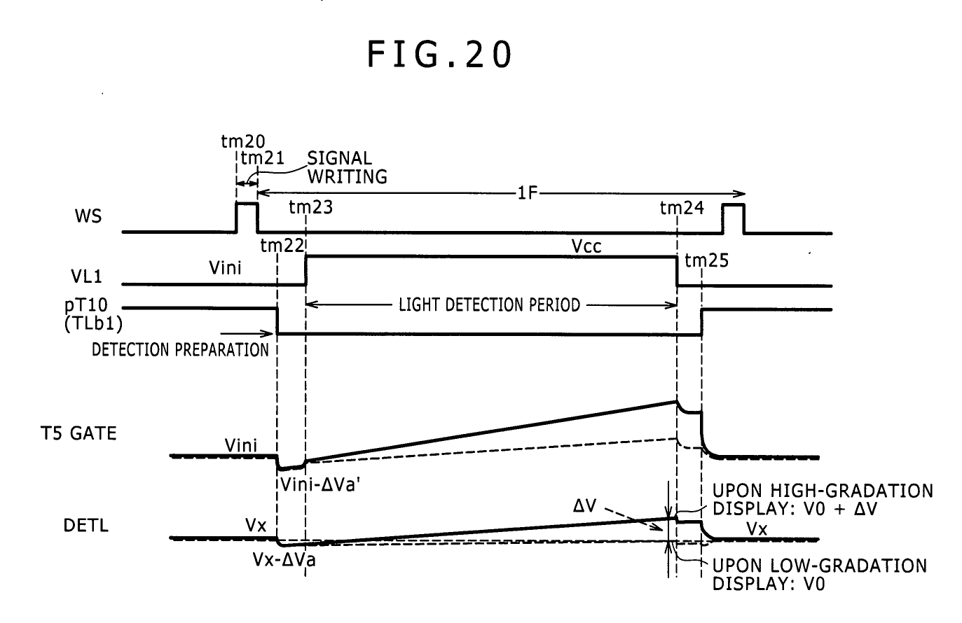

A light detection operation is described with reference to FIGS. 20 to 25 with attention paid to the pixel circuit 10-1 and the light detection section 30-1.

FIG. 20 illustrates the scanning pulse WS to be supplied from the write scanner 12 to the pixel circuit 10-1, particularly to the sampling transistor Ts, as a waveform regarding operation of the light detection section 30-1.

FIG. 20 illustrates also a power supply pulse of the power supply line VL. As seen in FIG. 20, the detection operation control section 21 applies the reference potential Vini to the power supply line VL within a detection preparation period preceding to a light detection period but applies the power supply voltage Vcc to the power supply line VL within a period within which the light detection is executed.

FIG. 20 further illustrates the control pulse pT10 to be applied to the control line TLb1. The sensor serving transistor T10 of the light detection section 30 is turned on/off with the control pulse pT10.

Further, FIG. 20 illustrates also the gate voltage of the detection signal outputting transistor T5 and the voltage appearing on the light detection line DETL.

As described hereinabove with reference to FIG. 19, except the period within which each light detection section 30 carries out light detection, the detection operation control section 21 sets the control pulse pT10 to the H level and sets the power supply line VL to the reference voltage Vini.

In FIG. 20, for the light detection section 30-1, the detection operation control section 21 sets the control pulse pT10 for the control line TLb1 to the H level and sets the sensor serving transistor T10 to an on state till time tm22. Further, till time tm23, the detection operation control section 21 sets the power supply line VL1 to the reference voltage Vini.

The period within which the sensor serving transistor T10 is controlled to an on state is the detection preparation period.

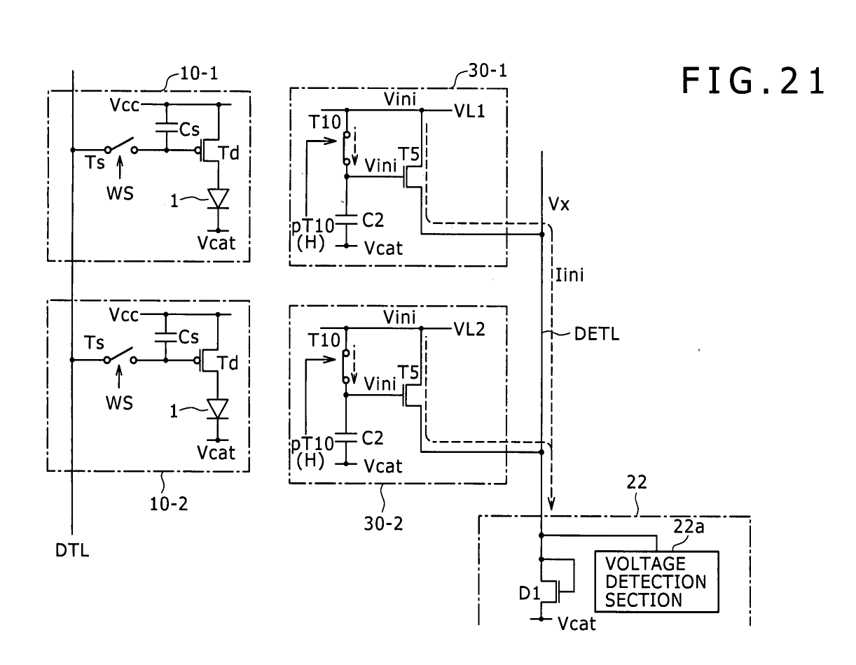

FIG. 21 shows an equivalent circuit in a state till time tm20.

In regard to both of the light detection sections 30-1 and 30-2, the sensor serving transistor T10 is in an on state, and the power supply lines VL1 and VL2 exhibit the reference voltage Vini. Therefore, the reference voltage Vini is inputted to the gate of the detection signal outputting transistors T5 of the light detection sections 30-1 and 30-2.

Since the detection signal outputting transistors T5 are connected at the source thereof to the light detection line DETL, current Iini flows to the light detection line DETL through the detection signal outputting transistors T5. Consequently, the light detection line DETL exhibits a certain potential Vx.

However, it is necessary for the reference voltage Vini to be so high as to place the detection signal outputting transistor T5 into an on state. In particular, it is necessary for the reference voltage Vini to be higher than the sum of the threshold voltage VthT5 of the detection signal outputting transistor T5, the threshold voltage VthD1 of the diode D1 connected to the light detection line DETL and the power supply connected to the source of the diode D1. In the example shown in FIG. 21, the power supply connected to the source of the diode D1 is, for example, a cathode voltage Vcat of the organic EL element 1. Consequently, it is necessary for the reference voltage Vini to satisfy the following expression:

Vini>VthT5+VthD1+Vcat

It is to be noted that the power supply to be connected to the source of the diode D1 is not limited to the cathode voltage Vcat.

Within the period from time tm20 to time tm21 of FIG. 20, writing of the signal value Vsig into the pixel circuits 10 is carried out for a display for a one-frame period.

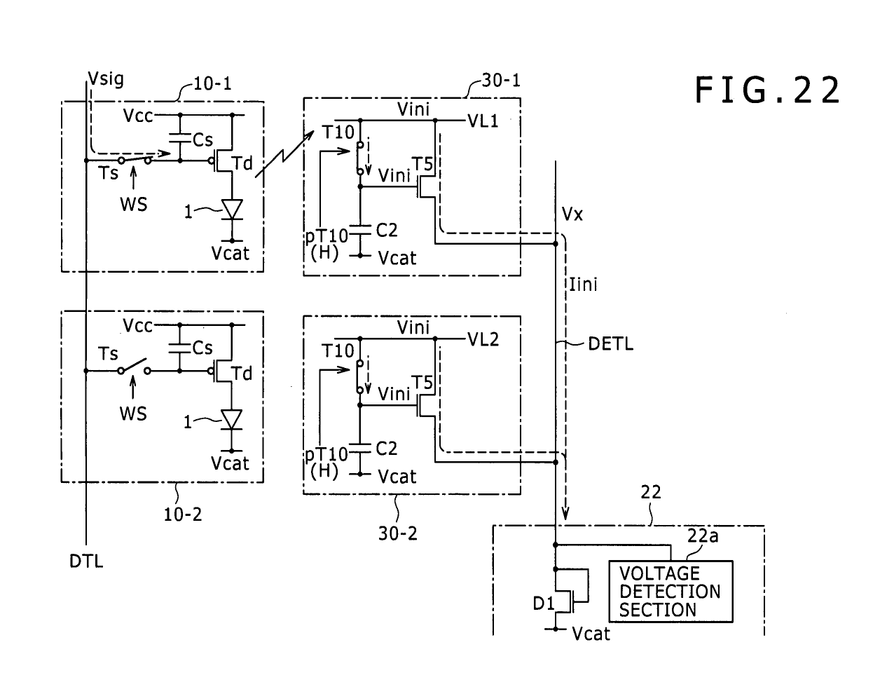

In particular, within the signal wiring period, the scanning pulse WS is set to the H level to render the sampling transistor Ts conducting. At this time, the horizontal selector 11 applies the signal value Vsig, for example, of the white display gradation to the signal line DTL. Consequently, in the pixel circuits 10, the organic EL element 1 emits light in accordance with the signal value Vsig. A state in this instance is illustrated in FIG. 22.

At this time, since the sensor serving transistor T10 is on, the gate voltage of the detection signal outputting transistor T5 remains equal to the reference potential Vini, and the potential of the light detection line DETL remains equal to the potential of Vx.

After the signal writing ends, the sampling transistor Ts in the pixel circuits 10-1 is turned off at time tm21.

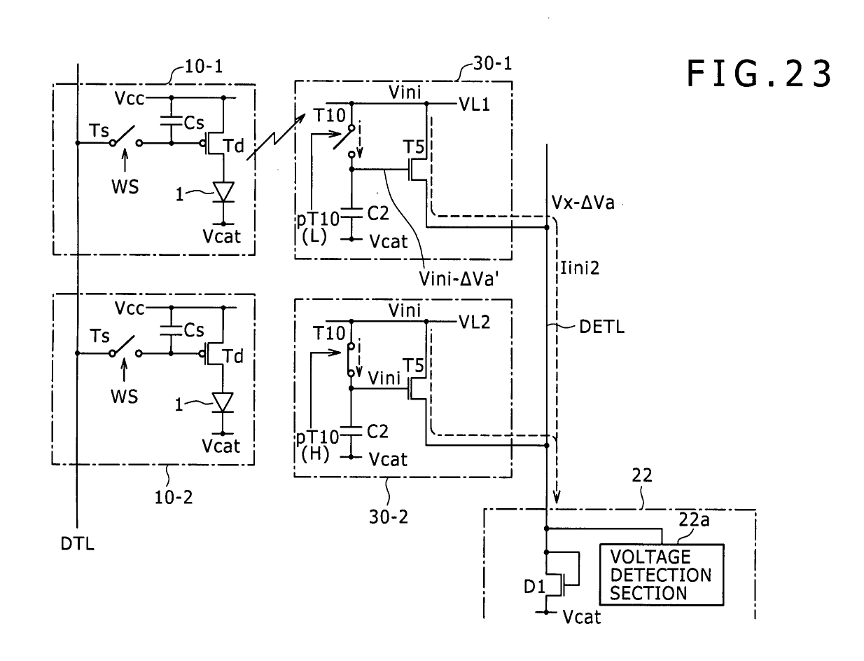

Meanwhile, in the light detection section 30-1, the control pulse pT10 is placed into the L level at time tm22 to turn off the sensor serving transistor T10. This state is illustrated in FIG. 23.

Where the sensor serving transistor T10 is turned off, a coupling amount ΔVa′ corresponding to a capacitance ratio between the capacitor C2 and the parasitic capacitance of the sensor serving transistor T10 is inputted to the gate of the detection signal outputting transistor T5. Consequently, the gate voltage of the detection signal outputting transistor T5 drops to Vini−ΔVa′. Then, also the voltage of the light detection line DETL varies to Vx−ΔVa. “−ΔVa′” indicates a potential variation of the light detection line DETL corresponding to the decreasing amount “−ΔVa′” of the gate potential of the detection signal outputting transistor T5.

By the coupling, a potential difference appears between the source and the drain of the sensor serving transistor T10 and varies the leak amount of the sensor serving transistor T10 depending upon the received light amount. However, the leak current at this time little varies the gate voltage of the detection signal outputting transistor T5. This arises from the facts that the potential difference between the source and the drain of the sensor serving transistor T10 is small and that the time (tm22 to tm23) before a next operation of varying the power supply line VL from the reference potential Vini to the power supply voltage Vcc is short.

At time tm23 after a fixed period of time elapses, the detection operation control section 21 varies the potential of the power supply line VL from the reference potential Vini to the power supply voltage Vcc.

By this operation, the coupling from the power supply line VL is inputted to the gate of the detection signal outputting transistor T5, and consequently, the gate potential of the detection signal outputting transistor T5 rises. Since the potential of the power supply line VL varies to the high potential, a great potential difference appears between the source and the drain of the sensor serving transistor T10, and leak current flows from the power supply line VL to the gate of the detection signal outputting transistor T5 in response to the received light amount.

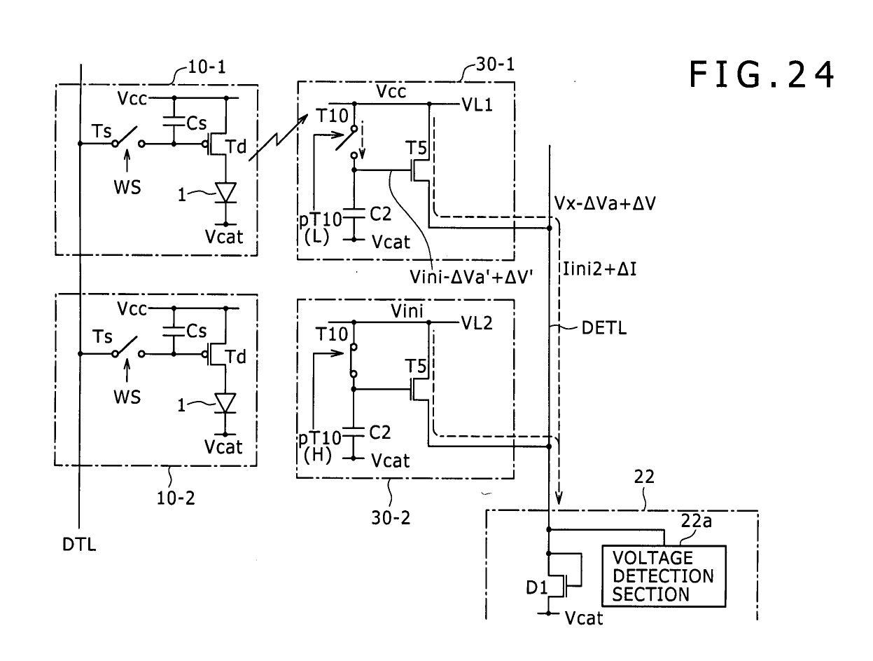

This state is illustrated in FIG. 24. By the operation described, the gate voltage of the detection signal outputting transistor T5 varies from Vini−ΔVa′ to Vini−ΔVa′+ΔV′. ΔV′ is the rise amount of the gate voltage of the detection signal outputting transistor T5 by leak current of the sensor serving transistor T10.

FIG. 20 illustrates a manner wherein the gate potential of the detection signal outputting transistor T5 gradually rises from Vini−ΔVa′ to Vini−ΔVa′+ΔV′ after time tm23.

Together with this, also the potential of the light detection line DETL rises from the potential Vx−ΔVa to V0+ΔV. It is to be noted that the potential V0 is a potential of the light detection line DETL in a low gradation displaying state, that is, in a black displaying state. Meanwhile, ΔV is a rise amount of the potential caused by the rise (ΔV′) of the gate voltage of the detection signal outputting transistor T5.

Since the amount of current flowing to the sensor serving transistor T10 increases as the amount of light received by the sensor serving transistor T10 increases, the voltage of the light detection line DETL upon a high gradation display is higher than that upon a low gradation display.

This potential variation of the light detection line DETL is detected by the voltage detection section 22a. This detection voltage corresponds to the emitted light amount of the organic EL element 1. In other words, if a particular gradation display such as, for example, a white display is being executed by the pixel circuit 10, then the detection potential represents a degree of degradation of the organic EL element 1.

At time tm24 after lapse of a fixed period of time, the detection operation control section 21 sets the power supply line VL1 to the reference voltage Vini. At this time, if the gate potential of the detection signal outputting transistor T5 is higher than the reference voltage Vini, then current flows from the gate of the detection signal outputting transistor T5 to the power supply line VL1 and the gate potential of the detection signal outputting transistor T5 drops.

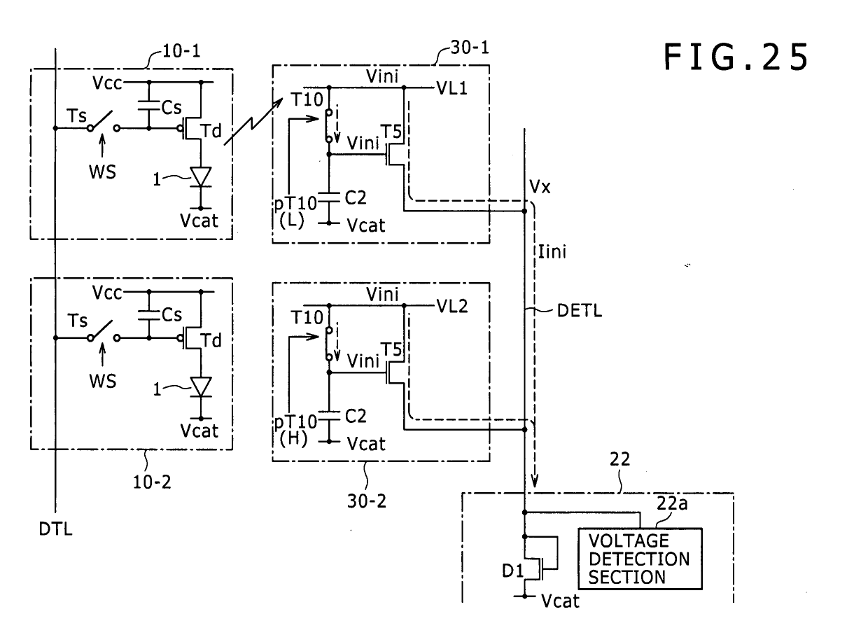

Thereafter at time tm25, the detection operation control section 21 sets the control pulse pT10 to the H level to place the sensor serving transistor T10 into an on state. Consequently, the reference voltage Vini is inputted to the gate of the detection signal outputting transistor T5. FIG. 25 illustrates a state at this time.

The potential of the light detection line DETL drops when the power supply line VL1 is set to the reference voltage Vini, that is, at time tm24, and thereafter, when the sensor serving transistor T10 is placed into an on state at time tm25, the potential of the light detection line DETL becomes the potential Vx.

For example, detection with regard to the pixel circuits 10 of the pertaining line within one frame is carried out in the following manner.

The light detection section 30 in the present embodiment which carries out such a light detection operation as described above can carry out a light detection operation with a high degree of accuracy similarly to the light detection section 200 described hereinabove with reference to FIG. 5 and the light detection section 300 described hereinabove with reference to FIG. 10.

In particular, the detection signal outputting circuit of the light detection section 30 is configured as a source follower circuit, and if the gate voltage of the detection signal outputting transistor T5 varies, then the variation is outputted from the source of the detection signal outputting transistor T5. Therefore, the variation of the gate voltage of the detection signal outputting transistor T5 by the variation of leak current of the sensor serving transistor T10 is outputted from the source of the sensor serving transistor T10 to the light detection line DETL.

Further, the gate-source voltage Vgs of the detection signal outputting transistor T5 is set so as to be higher than the threshold voltage Vth of the detection signal outputting transistor T5. Therefore, the value of current outputted from the detection signal outputting transistor T5 is much higher than that of the circuit configuration described hereinabove with reference to FIG. 3. Thus, even if the current value of the sensor serving transistor T10 is low, where the current flows through the detection signal outputting transistor T5, detection information of the emitted light amount can be outputted appropriately to the light detection driver 22.

Further, the light detection section 30 can be configured from two transistors (T10 and T5) and one capacitor C2 as well as two control lines (VL and TLb). In other words, simplification of the configuration of the light detection section 30 can be implemented, and also the control which uses the control lines does not become complicated.

In particular, in comparison with the light detection section 200 of FIG. 5, the number of components of the light detection section 30 can reduced significantly. Consequently, simplification of the configuration of the light detection section 30 itself can be implemented.

Further, in comparison with the light detection section 300 described hereinabove with reference to FIG. 10, the number of control lines can be reduced from three (VL, TLa and TLb) to two (VL and TLb), and the wiring lines of control lines and the number of drivers of the detection operation control section 21 for driving the control lines can be reduced significantly.

Accordingly, simplification, reduction in cost and enhancement in yield of the panel configuration can be implemented.

Further, also the arrangement of elements on the pixel array 20 is provided with room, and this is suitable for design.

Further, where the light detection driver 22 feeds back the detected light amount information as information for correction of the signal value Vsig to the horizontal selector 11, a countermeasure against a drawback in picture quality such as a screen burn can be taken.

It is to be noted that, in FIG. 16, while the present invention is applied to the pixel circuit 10 wherein the organic EL element 1 emits light simultaneously with image signal writing, it can be applied also to a pixel circuit wherein emission and non-emission of light are controlled by a switch or a power supply line.

In this instance, even if, when no light is emitted, a light detection preparation operation is carried out and, after the potential of the power supply line VL is changed from the low potential to the high potential, a light emitting operation is started with the pixel circuit 10 to carry out a light detection operation, light detection can be carried out without any problem. Such points are the same as the following embodiments described later.

### 4. Second Embodiment

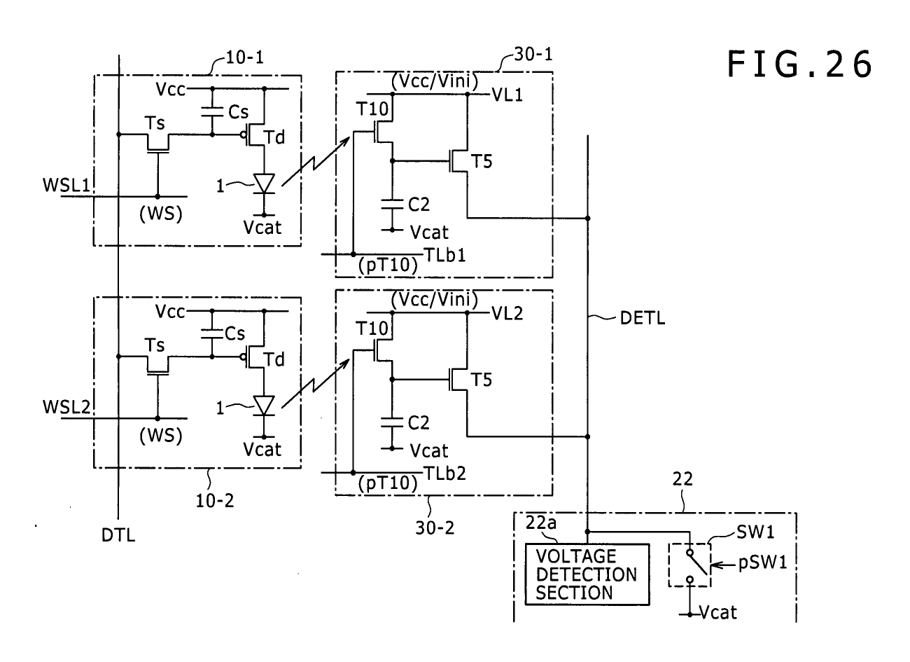

A second embodiment is described below with reference to FIGS. 26 to 33.

Referring first to FIG. 26, there are shown two pixel circuits 10, that is, 10-1 and 10-2, and two light detection sections 30, that is, 30-1 and 30-2, similarly as in FIG. 21. The light detection sections 30 have a configuration similar to that in the first embodiment described hereinabove, and overlapping description of them is omitted herein to avoid redundancy.

Further, the pixel circuits 10 have a configuration similar to that in the first embodiment described hereinabove not only in the present embodiment also in the third to seventh embodiments hereinafter described, and overlapping description of them is omitted herein to avoid redundancy.

FIG. 26 further shows a light detection driver 22. The light detection driver 22 in FIG. 26 is similar to but different from that shown in FIG. 21 in that it includes a switch SW1 and a fixed power supply such as, for example, a cathode voltage Vcat in place of the diode D1 connected to the light detection line DETL.

The switch SW1 is controlled between on and off, for example, with a control signal pSW1 from the detection operation control section 21.

Also with the present configuration, light amount detection can be carried out similarly.

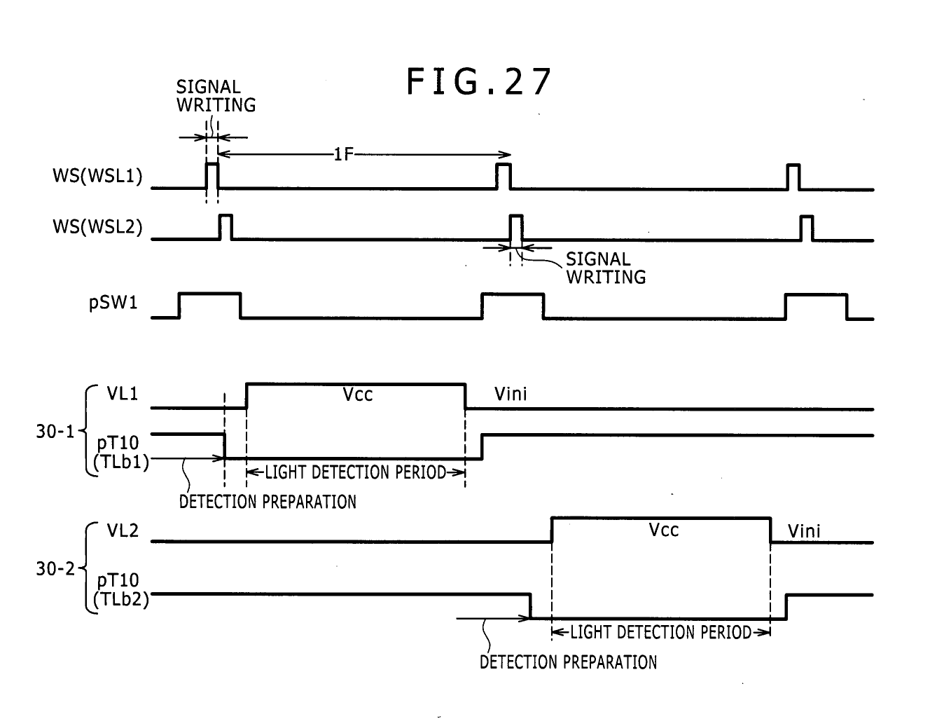

FIG. 27 illustrates waveforms of the scanning pulses WS to the pixel circuits 10-1 and 10-2, control pulses pT3 and pT10 to the light detection section 30-1, and control pulses pT3 and pT10 to the light detection section 30-2 similarly to FIG. 19. While the waveforms mentioned are similar to those of FIG. 19, FIG. 27 additionally illustrates a waveform of the control signal pSW1 to the switch SW1.

In particular, the pixel circuit 10-1 carries out writing of a signal value Vsig and emission of light for one frame at a particular timing, and thereupon, the light detection section 30-1 carries out a light detection operation in response to the control pulse pT10 and a pulse voltage of the power supply line VL.

Within a next frame period, the pixel circuit 10-2 carries out writing of the signal value Vsig and light emission for one frame at another certain timing, and thereupon, the light detection section 30-2 carries out a light detection operation in response to the control pulse pT10 and the pulse voltage of the power supply line VL.

The control signal pSW1 is set to the H level so that the switch SW1 exhibits an on state only within a predetermined period prior to a light detection period by each light detection section 30. Within the light detection period, the switch SW1 exhibits an off state.

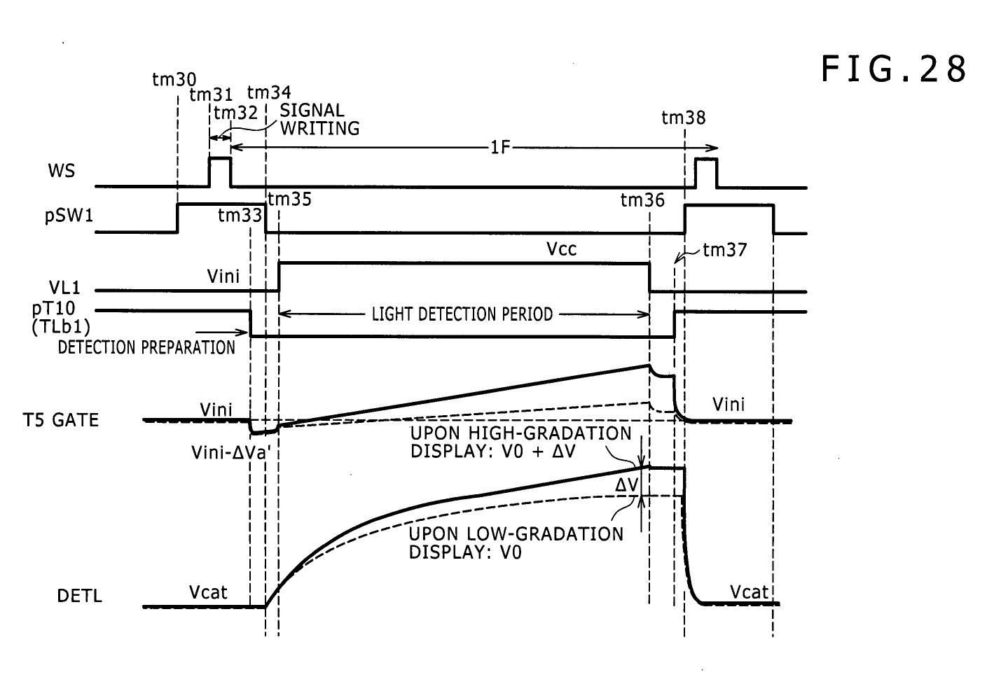

A light detection operation is described in detail with reference to FIGS. 28 to 33 with attention paid to the pixel circuit 10-1 and light detection section 30-1 side.

FIG. 28 illustrates waveforms relating to operation of the light detection section 30-1. In particular, FIG. 28 illustrates waveforms of the scanning pulse WS, the power supply pulse of the power supply line VL1, the control pulse pT10 to be applied to the control line TLb1, the gate voltage of the detection signal outputting transistor T5 and the voltage of the light detection line DETL similarly to FIG. 20. FIG. 28 additionally illustrates a waveform of the control signal pSW1.

As described hereinabove with reference to FIG. 27, except the period within which each light detection section 30 carries out light detection, the detection operation control section 21 sets the control pulse pT10 to the H level and sets the power supply line VL to the reference voltage Vini.

In FIG. 28, for the light detection section 30-1, the detection operation control section 21 sets the control pulse pT10 for the control line TLb1 to the H level and sets the sensor serving transistor T10 to an on state till time tm33. Further, till time tm35, the detection operation control section 21 sets the power supply line VL1 to the reference voltage Vini. The period within which the sensor serving transistor T10 is controlled to an on state is the detection preparation period.

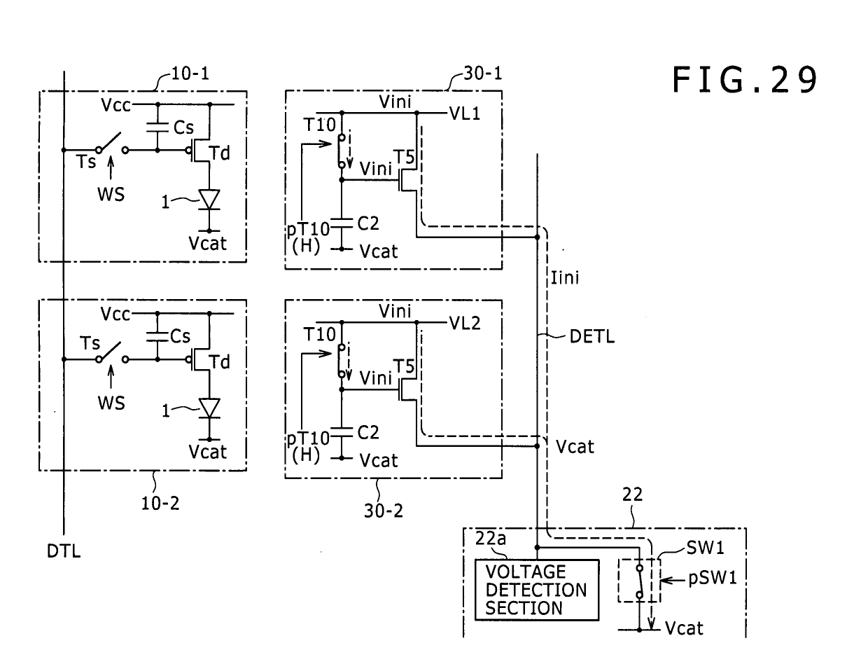

FIG. 29 shows an equivalent circuit in a state within a period from time tm30 to time tm31.

Referring to FIG. 29, in both of the light detection sections 30-1 and 30-2, the sensor serving transistor T10 is in an on state and the power supply lines VL1 and VL2 have the reference voltage Vini. Accordingly, the gate voltage of the detection signal outputting transistor T5 is the reference voltage Vini.

At time tm30, the control signal pSW1 is controlled to the H level to turn on the switch SW1 connected to the light detection line DETL.

At this time, if the on resistance of the switch SW1 is so low that it can be ignored, then the gate-source voltage Vgs of the detection signal outputting transistor T5 becomes Vini−Vcat. If this value is higher than the threshold voltage VthT5 of the detection signal outputting transistor T5, then current Iini flows as seen in FIG. 29.

It is to be noted that, while the initialization potential of the light detection line DETL is used as the cathode voltage Vcat of the organic EL element 1 as an example, the initialization potential is not limited to this, but, for example, a separate power supply may be used.

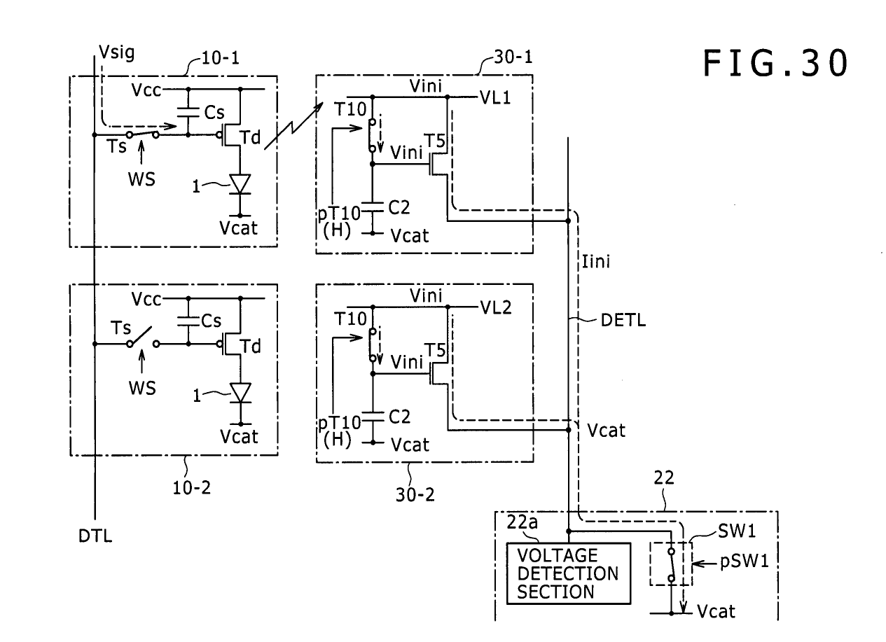

Within a period from time tm31 to time tm32, the write scanner 12 controls the scanning pulse WS to the pixel circuit 10-1 to the H level to turn on the sampling transistor Ts. As seen in FIG. 30, a signal value Vsig is inputted from the signal line DTL to the gate of the driving transistor Td.

At this time, the horizontal selector 11 applies the signal value Vsig, for example, of a white display gradation to the signal line DTL. Consequently, the organic EL element 1 in the pixel circuit 10 emits light in response to the signal value Vsig.

At this time, since the sensor serving transistor T10 is in an on state, the gate voltage of the detection signal outputting transistor T5 remains the reference voltage Vini and also the potential of the light detection line DETL remains the cathode voltage Vcat.

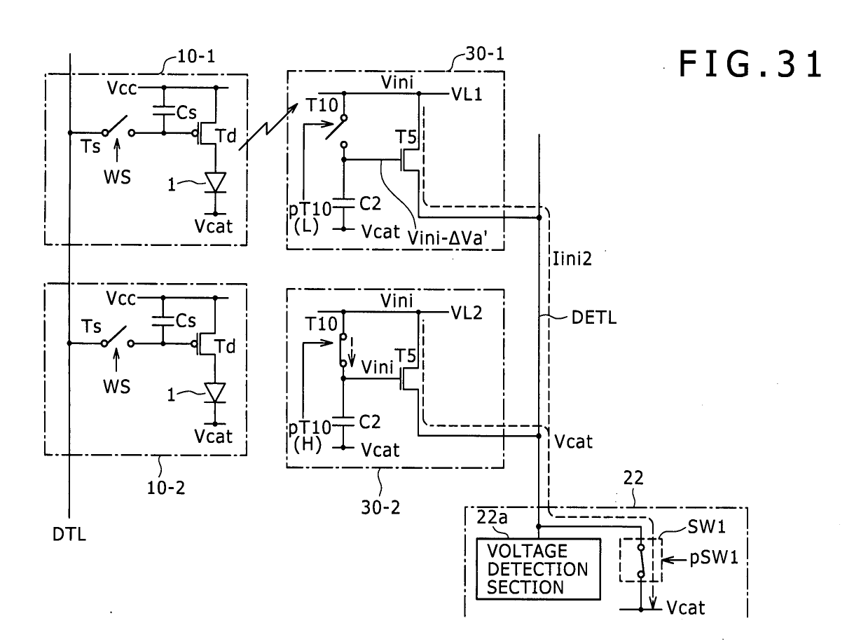

At time tm33 after lapse of a fixed period of time, the control pulse pT10 is set to the L level to turn off the sensor serving transistor T10 in the light detection section 30-1. This state is illustrated in FIG. 31. by turning off the sensor serving transistor T10, a coupling amount ΔVa′ corresponding to the capacitance ratio between the capacitor C2 and the parasitic capacitance of the sensor serving transistor T10 is inputted to the gate of the detection signal outputting transistor T5. Consequently, the gate potential of the detection signal outputting transistor T5 drops to Vini−ΔVa′.

At this time, the value of current flowing to the light detection line DETL varies from “Iini” to “Iini2” in response to the variation of the gate voltage of the detection signal outputting transistor T5. If the on resistance of the switch SW1 is so low that it can be ignored as described hereinabove, then the potential of the light detection line DETL almost remains the cathode voltage Vcat.

By the coupling, a potential difference appears between the source and the drain of the sensor serving transistor T10 and varies the leak amount of the sensor serving transistor T10 depending upon the received light amount. However, the leak current at this time little varies the gate voltage of the detection signal outputting transistor T5. This arises from the facts that the potential difference between the source and the drain of the sensor serving transistor T10 is small and that the time (tm33 to tm35) before a next operation of varying the power supply line VL1 from the reference potential Vini to the power supply voltage Vcc is short.

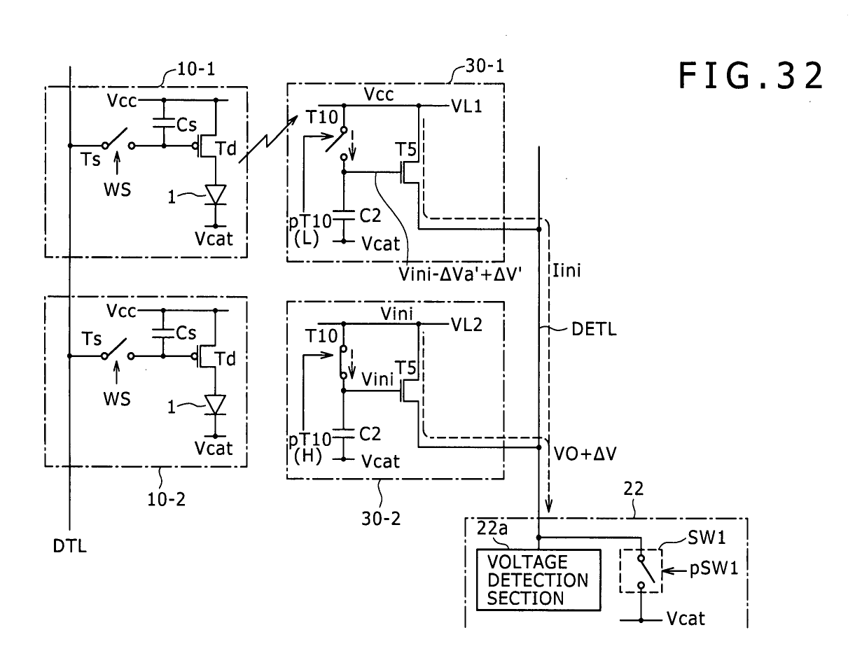

Further, at time tm34 after lapse of a fixed period of time, the switch SW1 is turned off with the control signal pSW1, and then at time tm35, the potential of the power supply line VL1 is varied from the reference voltage Vini to the power supply voltage Vcc. A state at this time is illustrated in FIG. 32.

By turning off the switch SW1, the potential of the light detection line DETL begins to gradually rise in a direction in which correction of the threshold value of the detection signal outputting transistor T5 is carried out. By varying the potential of the power supply line VL to a high potential (Vcc), a coupling is inputted from the power supply line VL to the gate of the detection signal outputting transistor T5, and consequently, the source-drain voltage of the sensor serving transistor T10 further increases.

Here, the potential of the light detection line DETL is studied.

The potential of the light detection line DETL begins to rise immediately after the switch SW1 is turned off as described hereinabove (refer to FIG. 28).

In any light detection section other than the light detection sections 30 such as the light detection sections 30-1 on a certain line on which a light detection operation is carried out, for example, in the light detection section 30-2, the gate of the detection signal outputting transistor T5 has the reference voltage Vini since the sensor serving transistor T10 is on.

Therefore, if the potential of the light detection line DETL is lower than Vini−VthT5, then the value of the current is high. On the contrary if the potential of the light detection line DETL is higher than Vini−VthT5, then the current to flow is determined by the value of the gate voltage of the detection signal outputting transistor T5 of the light detection sections 30 (light detection sections 30-1) on a certain line on which a light detection operation is carried out.

In short, if the gate voltage of the detection signal outputting transistor T5 of the light detection section 30-1 is higher than the reference voltage Vini, then a potential is outputted to the light detection line DETL.

By the series of operations described above, the gate voltage of the detection signal outputting transistor T5 of the light detection section 30-1 changes from Vini−ΔVa′ to Vini−ΔVa′+ΔV′. ΔV′ is a rise amount of the gate voltage of the detection signal outputting transistor T5 by leak current of the sensor serving transistor T10.

Together with the rise of the gate voltage of the detection signal outputting transistor T5, also the potential of the light detection line DETL becomes V0+ΔV. It is to be noted that V0 is the potential of the light detection line DETL in a low gradation display state. Meanwhile, ΔV is a variation amount corresponding to the rise amount ΔV′ described above.

As the amount of light received by the sensor serving transistor T10 increases, the amount of current flowing thereto increases. Therefore, the detection voltage in a high gradation display state becomes higher than that in a low gradation display state and is outputted to the outside.

The potential variation of the light detection line DETL is detected by the voltage detection section 22a. The detection voltage corresponds to the received light amount of the organic EL element 1. Where the pixel circuit 10 executes display of a particular gradation such as, for example, white display, the detection potential represents a degree of degradation of the organic EL element 1.

At time tm36 after lapse of a fixed period of time, the detection operation control section 21 controls the power supply line VL1 to the reference voltage Vini. At this time, if the gate potential of the detection signal outputting transistor T5 is higher than the reference voltage Vini, then current flows from the gate of the detection signal outputting transistor T5 to the power supply line VL1 and the gate potential of the detection signal outputting transistor T5 drops.

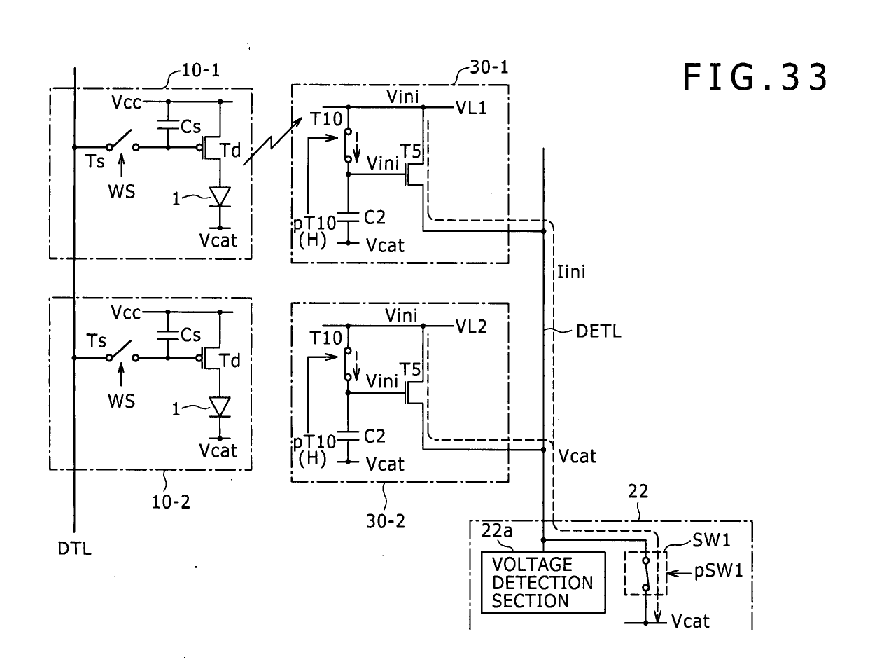

Thereafter, at time tm37, the control pulse pT10 is set to the H level by the detection operation control section 21 to turn on the sensor serving transistor T10. Consequently, the reference voltage Vini is inputted to the gate of the detection signal outputting transistor T5. Further at time tm38, the switch SW1 is turned on with the control signal pSW1. FIG. 33 illustrates a state at this time.

The potential of the light detection line DETL becomes the cathode voltage Vcat as a result of turning on the switch SW1.

Detection by the pixel circuits 10 on the pertaining line, for example, for one frame is carried out in such a manner as described above.

Also with the present second embodiment, similar effects to those of the first embodiment can be anticipated.

Further, with the second embodiment, when the switch SW1 is off since through-current to the fixed power supply such as, for example, the cathode voltage Vcat line does not flow from the power supply line VL, there is an advantage that the power consumption can be suppressed low in comparison with the first embodiment.

### 5. Third Embodiment

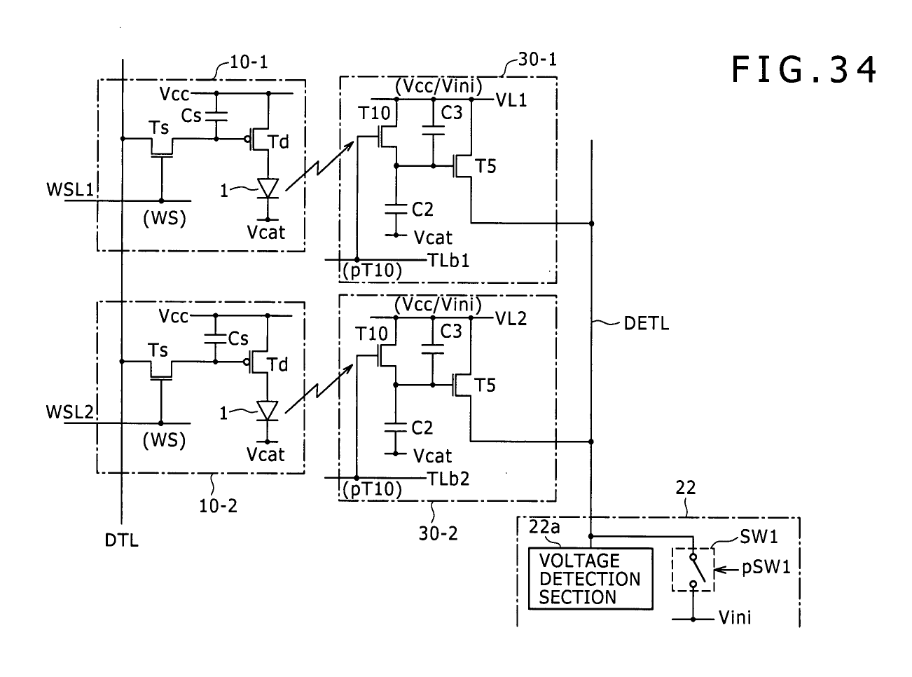

The third embodiment is described with reference to FIGS. 34 to 40.

Referring to FIG. 34, each light detection section 30, that is, 30-1 or 30-2, includes a sensor serving transistor T10 and a detection signal outputting transistor T5 similarly as in the embodiments described hereinabove.

The light detection section 30 further includes a first capacitor C2 connected between the gate of the detection signal outputting transistor T5 and a cathode voltage Vcat, and a second capacitor C3 connected between the gate of the detection signal outputting transistor T5 and a power supply line VL.

To the power supply line VL, that is, to each of the power supply lines VL1 and VL2, a pulse voltage which exhibits a power supply voltage Vcc or a reference voltage Vini is applied from a detection operation control section 21.

A light detection driver 22 includes a switch SW1 which is switched on and off with a control signal pSW1 from the detection operation control section 21, and a voltage detection section 22a similarly as in the second embodiment. However, in the present embodiment, the fixed potential to which the switch SW1 is connected is a line of the reference voltage Vini.

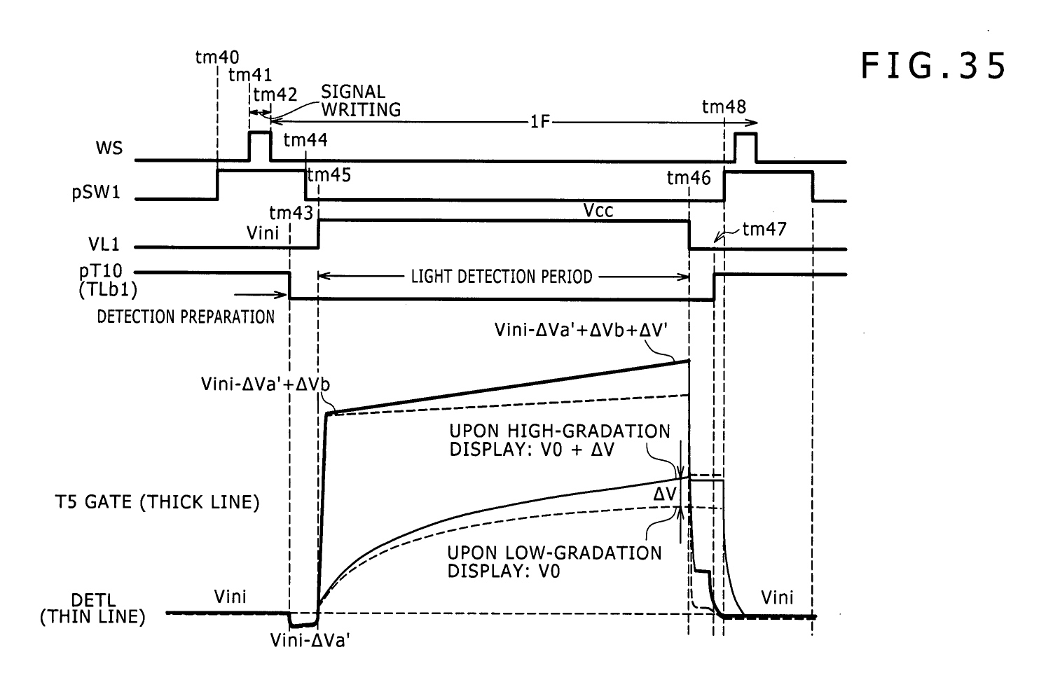

A light detection operation is described in detail with reference to FIGS. 35 to 40 with attention paid to the pixel circuit 10-1 and light detection section 30-1 side.

FIG. 35 illustrates waveforms relating to operation of the light detection section 30-1. In particular, FIG. 35 illustrates waveforms of the scanning pulse WS, control signal pSW1, power supply pulse of the power supply line VL1, control pulse pT10 to be applied to the control line TLb1, gate voltage of the detection signal outputting transistor T5 and voltage of the light detection line DETL similarly to FIG. 28.

In FIG. 35, the gate voltage of the detection signal outputting transistor T5 and the voltage of the light detection line DETL are indicated by a thick line and a thin line, respectively, so that they can be identified from each other.

It is to be noted that, while FIG. 35 shows waveforms within a period of one frame, if the control pulse pT10 for the light detection sections 30-1 and 30-2, voltage pulse of the power supply line VL, control signal pSW1 and scanning pulse WS are illustrated within a period of two frames, then the waveforms become similar to those in the second embodiment illustrated in FIG. 27.

Except the period within which each light detection section 30 carries out light detection, the detection operation control section 21 sets the control pulse pT10 to the H level and sets the power supply line VL to the reference voltage Vini (refer to FIG. 27).

In FIG. 35, for the light detection section 30-1, the detection operation control section 21 sets the control pulse pT10 for the control line TLb1 to the H level and sets the sensor serving transistor T10 to an on state till time tm43. Further, till time tm45, the detection operation control section 21 sets the power supply line VL1 to the reference voltage Vini. The period within which the sensor serving transistor T10 is controlled to an on state is the detection preparation period.

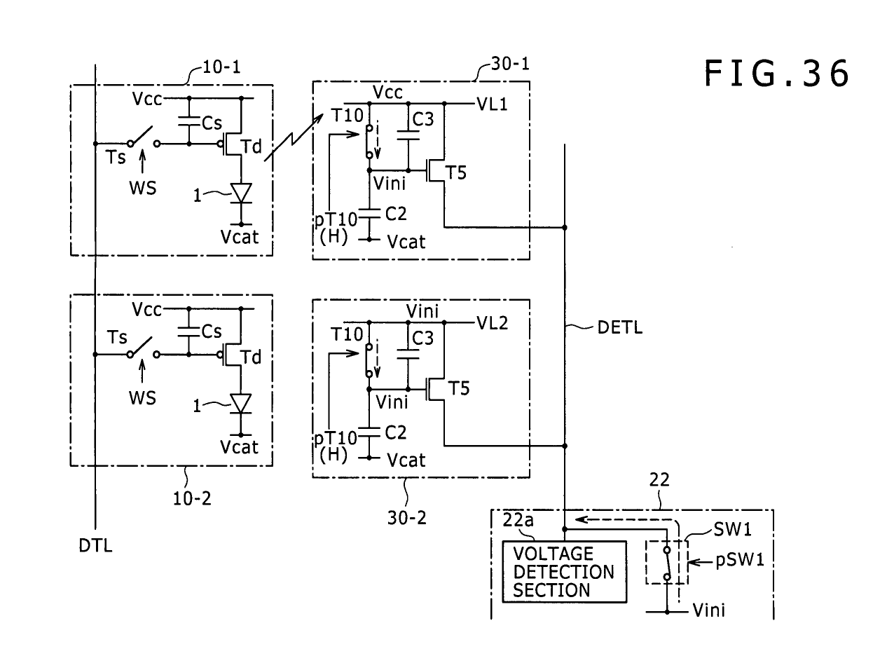

FIG. 36 illustrates a state within a period from time tm40 to time tm41.

First, in both of the light detection sections 30-1 and 30-2, the sensor serving transistor T10 is in an on state and the power supply lines VL1 and VL2 have the reference voltage Vini. Consequently, the reference voltage Vini is inputted to the gate of the detection signal outputting transistor T5.

Further, at time tm40, the control signal pSW1 is set to the H level to turn on the switch SW1 connected to the light detection line DETL. Consequently, also the potential of the light detection line DETL is charged to the reference voltage Vini.

At this time, the gate-source voltage of the detection signal outputting transistor T5 becomes 0 V to place the detection signal outputting transistor T5 into an off state.

It is to be noted here that, while the initialization potential of the light detection line DETL is the reference voltage Vini as an example, the initialization potential is not limited to this, but there is no problem even if a separate power supply from the reference voltage Vini is used only if the detection signal outputting transistor T5 is placed into an off state.

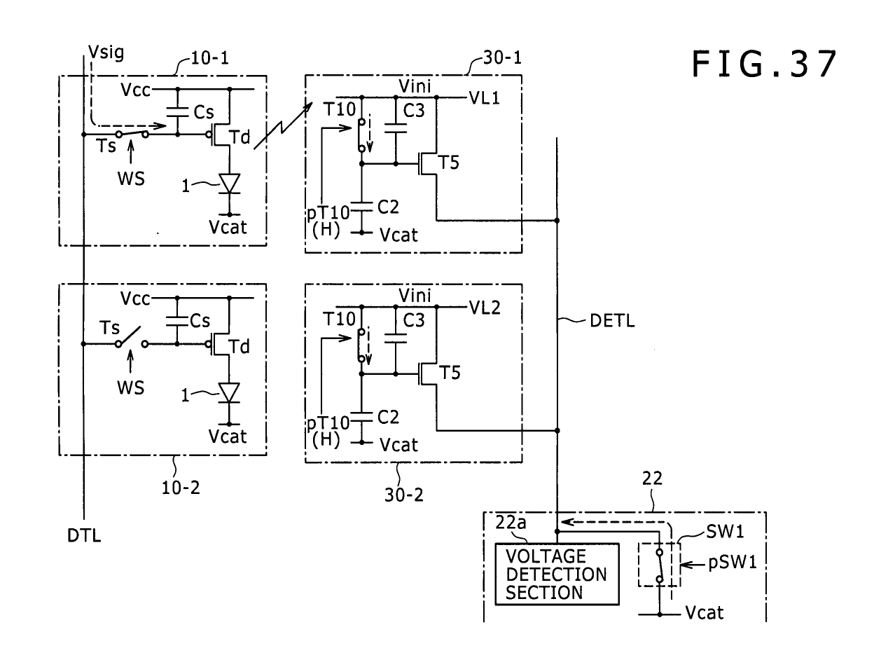

Within a period from time tm41 to time tm42, the sampling transistor Ts of the pixel circuit 10-1 is controlled to an on state with the scanning pulse WS to input the signal value voltage Vsig to the gate of the driving transistor Td. By this operation, the EL element begins to emit light. A state at this time is illustrated in FIG. 37.

At this time, in the light detection section 30-1, since the sensor serving transistor T10 is in an on state, the gate voltage of the detection signal outputting transistor T5 remains the reference voltage Vini, and also the potential of the light detection line DETL remains the reference voltage Vini similarly.

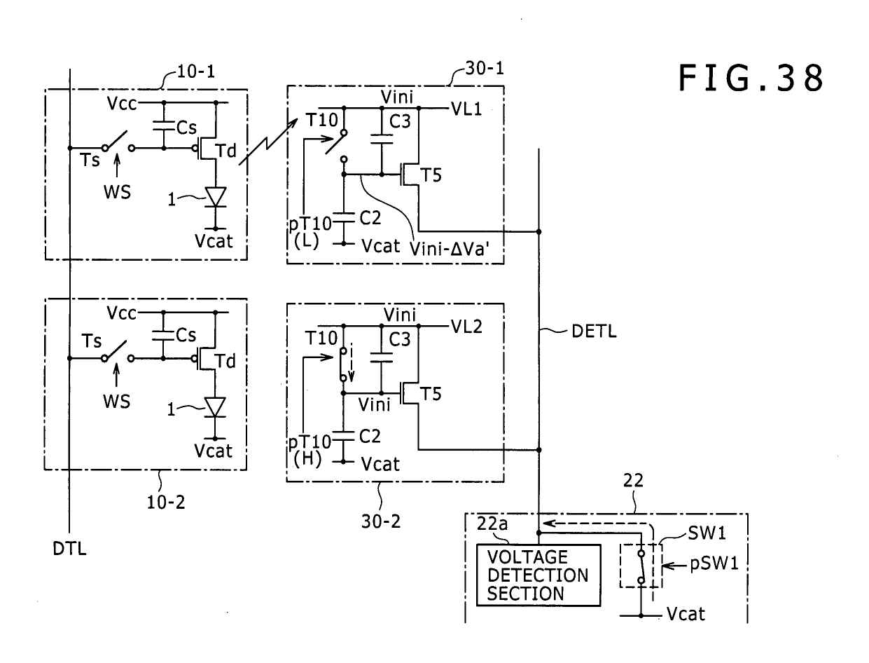

At time tm43 after lapse of a fixed period of time, the detection operation control section 21 sets the control pulse pT10 to the L level to turn off the sensor serving transistor T10. A state at this time is illustrated in FIG. 38.

By turning off the sensor serving transistor T10, a coupling amount ΔVa′ is inputted to the gate of the detection signal outputting transistor T5.

Also at this time, since the switch SW1 is in an on state, the potential of the light detection line DETL does not exhibit any variation.

Further, a potential difference is produced between the source and the drain of the sensor serving transistor T10 by the coupling and the leak amount is varied by the amount of received light. However, at this time, the leak current of the sensor serving transistor T10 little varies the gate voltage of the detection signal outputting transistor T5. This is because, at this point of time, the potential difference between the source and the drain of the sensor serving transistor T10 is small and the time before a next operation, that is, before an operation of turning off the switch SW1 and varying the potential of the power supply line VL1 from the reference voltage Vini to the power supply voltage Vcc is short.

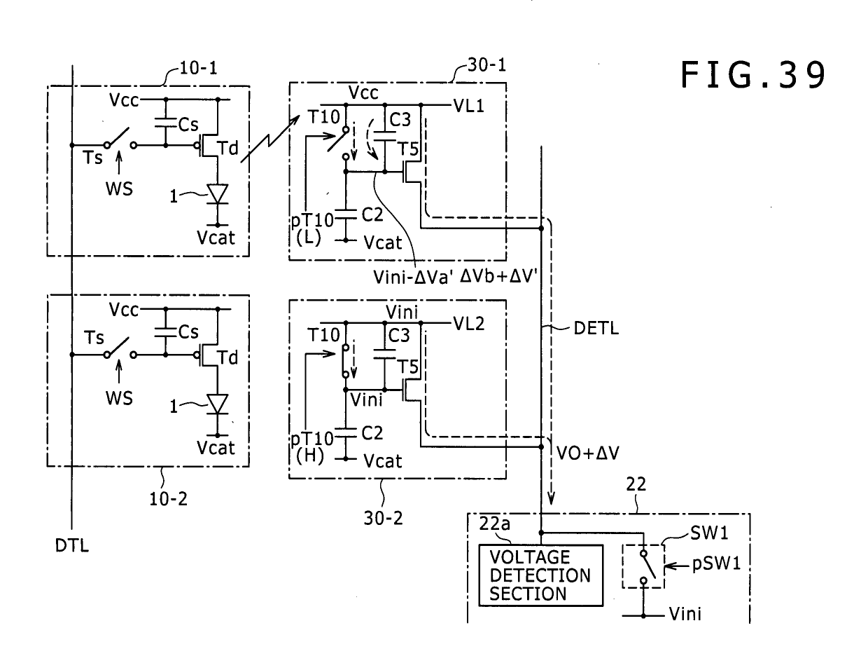

Further, at time tm44 after lapse of a fixed period of time, the detection operation control section 21 switches off the switch SW1 with the control signal pSW1, and then at time tm45, the detection operation control section 21 varies the potential of the power supply line VL1 from the reference voltage Vini to the power supply voltage Vcc. A state at this time is illustrated in FIG. 39.

By varying the potential of the power supply line VL1 from the reference voltage Vini to the power supply voltage Vcc, a coupling amount ΔVb from the power supply line VL1 is inputted to the gate of the detection signal outputting transistor T5 through the second capacitor C3.

Since this coupling amount ΔVb has a value relying upon the second capacitor C3, it is possible to make the gate potential of the detection signal outputting transistor T5 higher than Vini+VthT5 with the value of the second capacitor C3. VthT5 is the threshold voltage of the detection signal outputting transistor T5.

If the gate potential of the detection signal outputting transistor T5 can be made higher than Vini+VthT5, then the detection signal outputting transistor T5 is turned on and current begins to flow from the power supply line VL, which has the power supply voltage Vcc, to the light detection line DETL.

Further, also the source-drain voltage of the sensor serving transistor T10 becomes higher as a result of the coupling through the second capacitor C3, and light leak current depending upon the amount of received light flows from the power supply line VL, that is, from the power supply voltage Vcc, to the gate of the detection signal outputting transistor T5.

By this operation, the gate voltage of the detection signal outputting transistor T5 changes from the potential of Vini−ΔVa′+ΔVb to another potential of Vini−ΔVa′+ΔVb+ΔV′ after lapse of a fixed period of time. Together with this, also the potential of the light detection line DETL changes to V0+ΔV. ΔV′ is a rise amount of the gate voltage by the leak current, and ΔV is a potential rise amount of the light detection line DETL corresponding to the rise amount ΔV′ of the gate voltage.

Generally, the light leak amount of a light detection element increases as the amount of light received by the light detection amount increases. Therefore, the detection voltage in a high gradation display state becomes higher than the voltage in a low gradation display state and is outputted to the outside. The potential variation of the light detection line DETL is detected by the voltage detection section 22a. This detection voltage corresponds to the amount of light emitted from the organic EL element 1.

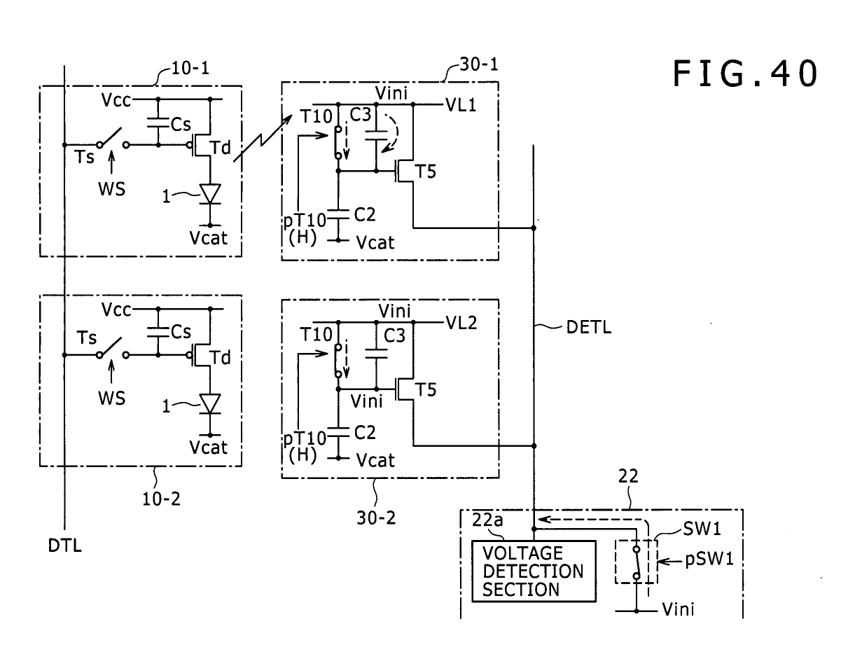

At time tm46 after lapse of a fixed period of time, the detection operation control section 21 sets the power supply line VL to the reference voltage Vini. At this time, a coupling amount ΔVb from the power supply line VL1 which has the reference voltage Vini is inputted to the gate of the detection signal outputting transistor T5 through the second capacitor C3 again. A state at this time is illustrated in FIG. 40.

Since the gate-source voltage Vgs of the detection signal outputting transistor T5 becomes lower than the threshold voltage of the detection signal outputting transistor T5 as a result of this operation, the detection signal outputting transistor T5 is turned off.

Thereafter, at time tm47, the detection operation control section 21 sets the control pulse pT10 to the H level to turn on the sensor serving transistor T10. To the gate of the detection signal outputting transistor T5, the reference voltage Vini is inputted.

At time tm48, the detection operation control section 21 switches on the switch SW1 with the control signal pSW1. By this operation, the gate potential of the detection signal outputting transistor T5 and the potential of the light detection line DETL become the reference voltage Vini.

Detection by the pixel circuits 10 on the line, for example, for one frame is carried out in such a manner as described above.

In particular, in the present third embodiment, an operation of charging the light detection line DETL to the reference voltage Vini is carried out in a detection preparation operation before the detection signal outputting transistor T5 starts outputting of light detection information.

Then, the sensor serving transistor T10 is placed into an off state, and further, the power supply line VL is set to the power supply voltage Vcc. Consequently, a potential difference is generated between the gate and the drain of the sensor serving transistor T10 through the second capacitor C3 and the gate potential of the sensor serving transistor T10 is raised to start outputting of the light detection information.

Also in the present third embodiment, similarly to the first and second embodiments, a light detection operation of high accuracy can be achieved, and besides it is possible to take a countermeasure against deterioration of the picture quality such as a screen burn. Further, the number of control systems for the light detection section 30 is two (VL and TLb), and this is advantageous also for a panel configuration.

Further, through-current from the power supply line VL upon light detection operation can be eliminated. Therefore, significant reduction in power consumption can be implemented. Particularly in the second embodiment, when the switch SW1 is on, through-current for all lines flows because the gate of the detection signal outputting transistor T5 is charged up to the reference voltage Vini. In the present embodiment, when the switch SW1 is on, no through-current flows.

### 6. Fourth Embodiment

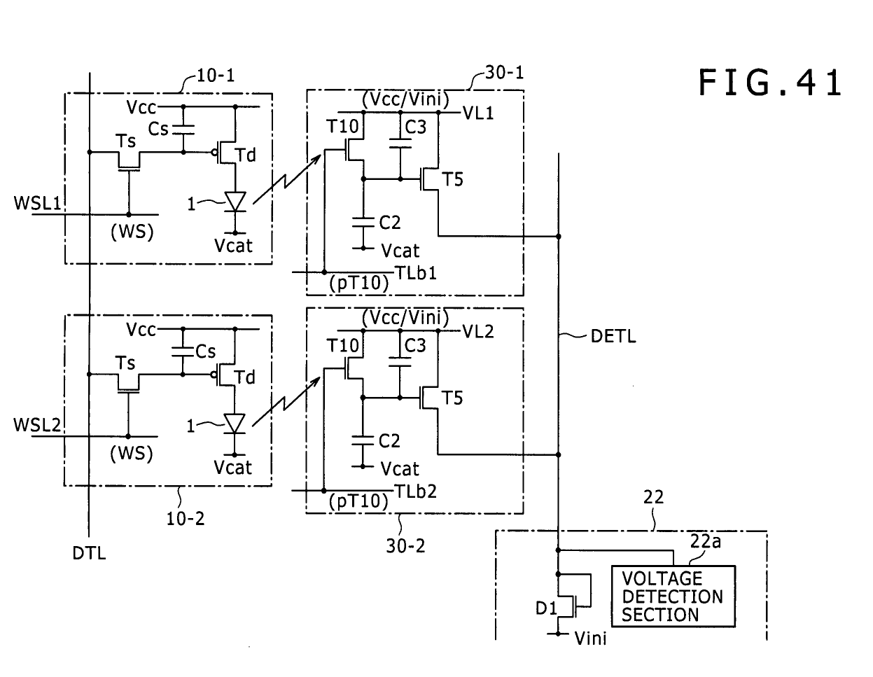

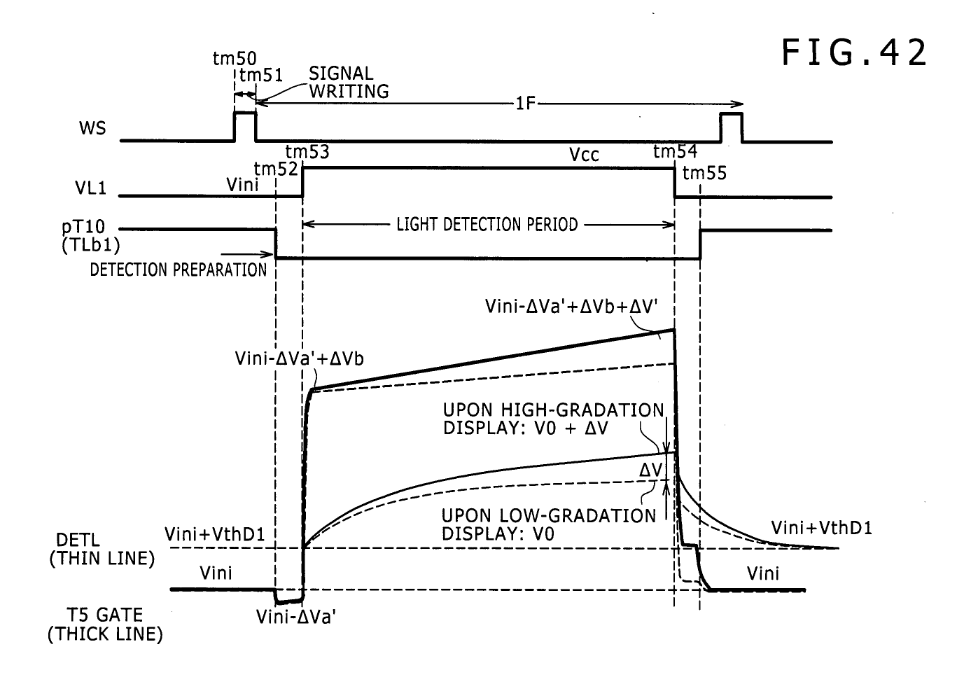

The fourth embodiment is described with reference to FIGS. 41 and 42.

Referring first to FIG. 41, each light detection section 30, that is, each of light detection sections 30-1 and 30-2, is similar to that of the embodiment described hereinabove. Meanwhile, a light detection driver 22 is configured from a voltage detection section 22a and a diode D1. The diode D1 is connected to a line of a reference voltage Vini.

A light detection operation is described in detail with reference to FIG. 42 with attention paid to the pixel circuit 10-1 and light detection section 30-1 side. FIG. 42 illustrates waveforms relating to operation of the light detection section 30-1. In particular, FIG. 42 illustrates waveforms of the scanning pulse WS, power supply pulse of the power supply line VL1, control pulse pT10 to be applied to the control line TLb1, gate voltage of the detection signal outputting transistor T5 and voltage of the light detection line DETL. The gate voltage of the detection signal outputting transistor T5 and the voltage of the light detection line DETL are indicated by a thick line and a thin line, respectively, so that they can be identified from each other.

It is to be noted that, while FIG. 42 shows waveforms within a period of one frame, if the control pulse pT10 for the light detection sections 30-1 and 30-2, voltage pulse of the power supply line VL and scanning pulse WS are illustrated within a period of two frames, then the waveforms become similar to those in the first embodiment illustrated in FIG. 19.

Except the period within which each light detection section 30 carries out light detection, the detection operation control section 21 sets the control pulse pT10 to the H level and sets the power supply line VL to the reference voltage Vini (refer to FIG. 19). In FIG. 42, for the light detection section 30-1, the detection operation control section 21 sets the control pulse pT10 for the control line TLb1 to the H level and sets the sensor serving transistor T10 to an on state till time tm52. Further, till time tm53, the detection operation control section 21 sets the power supply line VL1 to the reference voltage Vini. The period within which the sensor serving transistor T10 is controlled to an on state is the detection preparation period.

Within this detection preparation period, in both of the light detection sections 30-1 and 30-2, the sensor serving transistor T10 is in an on state and the power supply lines VL1 and VL2 exhibit the reference voltage Vini. Therefore, the reference voltage Vini is inputted to the gate of the detection signal outputting transistor T5 in the light detection sections 30-1 and 30-2.

The potential of the light detection line DETL is Vini+VthD1. VthD1 is the threshold voltage of the diode D1.

Within a period from time tm50 to time tm51, the sampling transistor Ts of the pixel circuit 10-1 is controlled to an on state with the scanning pulse WS to input the signal value voltage Vsig to the gate of the driving transistor Td. By this operation, the EL element begins to emit light.

At this time, in the light detection section 30-1, since the sensor serving transistor T10 is in an on state, the gate voltage of the detection signal outputting transistor T5 remains the reference voltage Vini, and also the potential of the light detection line DETL remains Vini+VthD1 similarly.

At time tm52, the detection operation control section 21 sets the control pulse pT10 to the L level to turn off the sensor serving transistor T10.

By turning off the sensor serving transistor T10, a coupling amount ΔVa′ is inputted to the gate of the detection signal outputting transistor T5, and the gate voltage becomes Vini−ΔVa′.

At time tm53, the detection operation control section 21 varies the potential of the power supply line VL1 from the reference voltage Vini to the power supply voltage Vcc.

Similarly as in the case of the third embodiment described hereinabove, by varying the potential of the power supply line VL1 from the reference voltage Vini to the power supply voltage Vcc, a coupling amount ΔVb from the power supply line VL1 is inputted to the gate of the detection signal outputting transistor T5 through the second capacitor C3.

By setting of the value of the second capacitor C3, it is possible to make the gate potential of the detection signal outputting transistor T5 higher than Vini+VthT5+VthD1 by the input of the coupling value ΔVb. VthT5 is the threshold voltage of the detection signal outputting transistor T5.

Consequently, the detection signal outputting transistor T5 is turned on and current begins to flow from the power supply line VL, which has the power supply voltage Vcc, to the light detection line DETL.

Further, by the coupling through the second capacitor C3, also the source-drain voltage of the sensor serving transistor T10 increases, and light leak current depending upon the amount of received light flows from the power supply line VL, which has the power supply voltage Vcc, to the gate of the detection signal outputting transistor T5.

By this operation, the gate voltage of the detection signal outputting transistor T5 changes from the potential of Vini−ΔVa′+ΔVb to another potential of Vini−ΔVa′+ΔVb+ΔV′ after lapse of a fixed period of time. Together with this, also the potential of the light detection line DETL changes to V0+ΔV. ΔV′ is a rise amount of the gate voltage by the leak current, and ΔV is a potential rise amount of the light detection line DETL corresponding to the rise amount ΔV′ of the gate voltage.

The light leak amount of a light detection element increases as the amount of light received by the light detection amount increases. Therefore, the detection voltage in a high gradation display state becomes higher than the voltage in a low gradation display state and is outputted to the outside. The potential variation of the light detection line DETL is detected by the voltage detection section 22a. This detection voltage corresponds to the amount of light emitted from the organic EL element 1.

At time tm54 after lapse of a fixed period of time, the detection operation control section 21 sets the power supply line VL to the reference voltage Vini. At this time, a coupling amount ΔVb from the power supply line VL1 which has the reference voltage Vini is inputted to the gate of the detection signal outputting transistor T5 through the second capacitor C3 again.

Since the gate-source voltage Vgs of the detection signal outputting transistor T5 becomes lower than the threshold voltage of the detection signal outputting transistor T5 as a result of this operation, the detection signal outputting transistor T5 is turned off.

Thereafter, at time tm55, the detection operation control section 21 sets the control pulse pT10 to the H level to turn on the sensor serving transistor T10. To the gate of the detection signal outputting transistor T5, the reference voltage Vini is inputted.

Thereafter, the potential of the light detection line DETL returns to Vini+VthD1.

Detection by the pixel circuits 10 on the pertaining line, for example, for one frame is carried out in such a manner as described above.

Also with the present fourth embodiment, similar effects to those of the third embodiment can be anticipated.

### 7. Fifth Embodiment

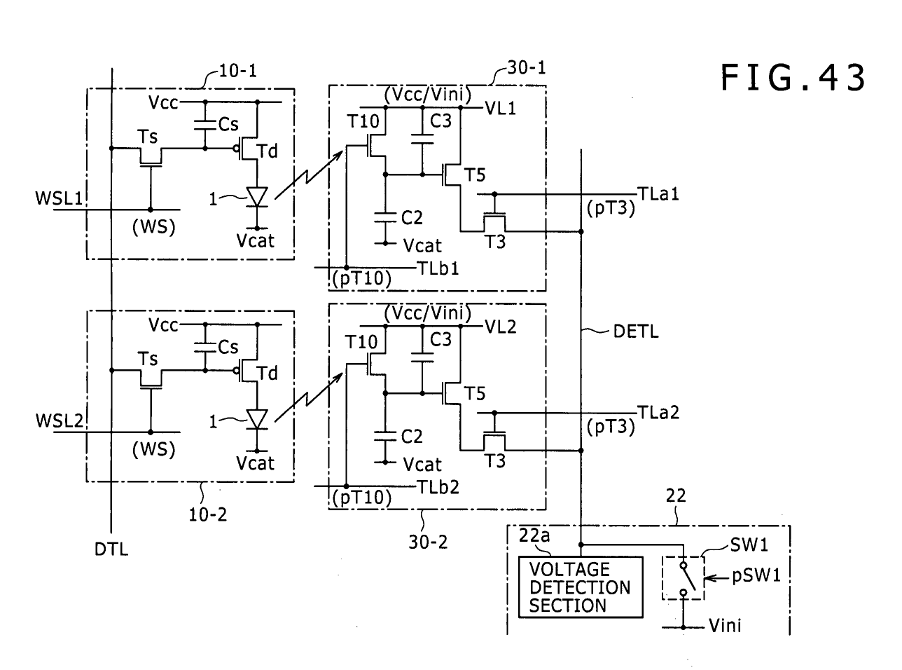

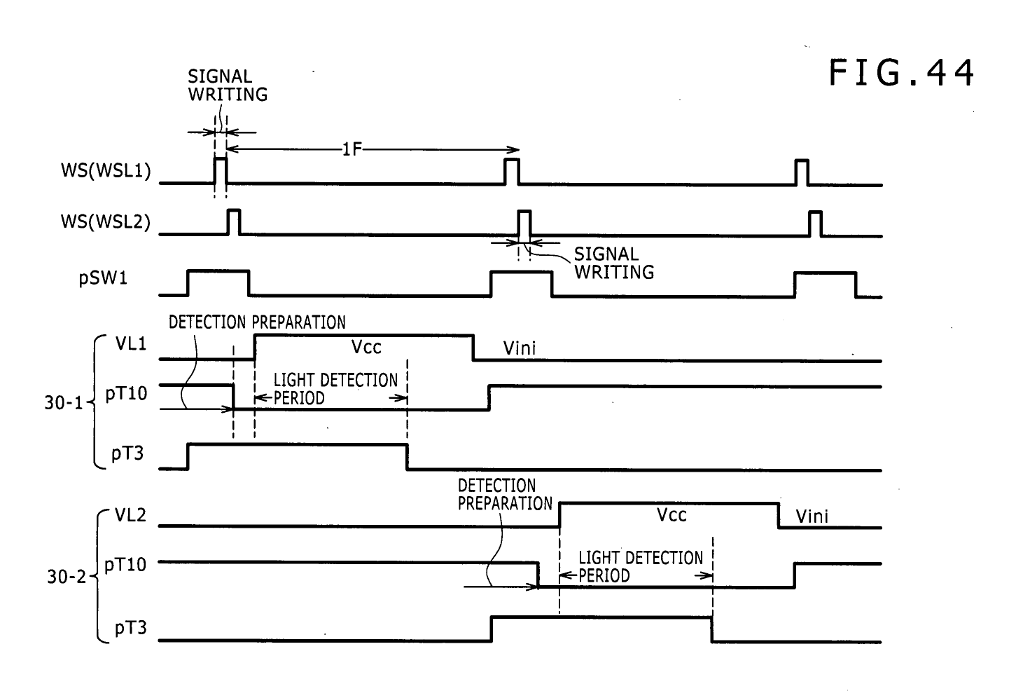

The fifth embodiment is described with reference to FIGS. 43 and 44.

The present fifth embodiment has a configuration which includes a switching transistor T3 in addition to the configuration of the third embodiment described hereinabove with reference to FIG. 34.

In this case, the detection signal outputting transistor T5 is connected at the drain thereof to the power supply line VL. The detection signal outputting transistor T5 is connected at the source thereof to the switching transistor T3.

The switching transistor T3 is connected between the source of the detection signal outputting transistor. T5 and the light detection line DETL. The switching transistor T3 is connected at the gate thereof to a control line TLa (TLa1, TLa2).

For example, the detection operation control section 21 described hereinabove with reference to FIG. 1 applies a control pulse pT3 to the control line TLa to control the switching transistor T3 between on and off. When the switching transistor T3 is turned on, current flowing to the detection signal outputting transistor T5 is outputted to the light detection line DETL.

Operation waveforms within a period of two frames are shown in FIG. 44. FIG. 44 shows a waveform of the control pulse pT3 to the switching transistor T3 of the light detection sections 30-1 and 30-2 in addition to signal waveforms similar to those of FIG. 27.

In this instance, a potential variation corresponding to light leak current of the sensor serving transistor T10 appears on the light detection line DETL, and the light detection period within which the voltage detection section 22a carries out voltage detection depends upon the control pulse pT3 and the potential of the power supply line VL.

In the third embodiment described hereinabove, the light detection period within one frame is a period within which the power supply line VL exhibits the power supply voltage Vcc (refer to FIGS. 35 and 27).

In contrast, in the case of the light detection section 30 of the example of FIG. 43, outputting to the light detection line DETL is carried out in response to turning on of the switching transistor T3. Accordingly, as seen in FIG. 44, the light detection period is a period within which the control pulse pT3 has the H level and the switching transistor T3 is on and besides the power supply line VL exhibits the power supply voltage Vcc.

Therefore, the light detection period can be determined not only by the pulse voltage of the power supply line VL but also by a rising edge of the potential of the power supply line VL and turning off of the switching transistor T3. Further, it is possible to control the switching transistor T3 to set the light detection period shorter within a period within which the power supply line VL has the power supply voltage Vcc.

### 8. Sixth Embodiment

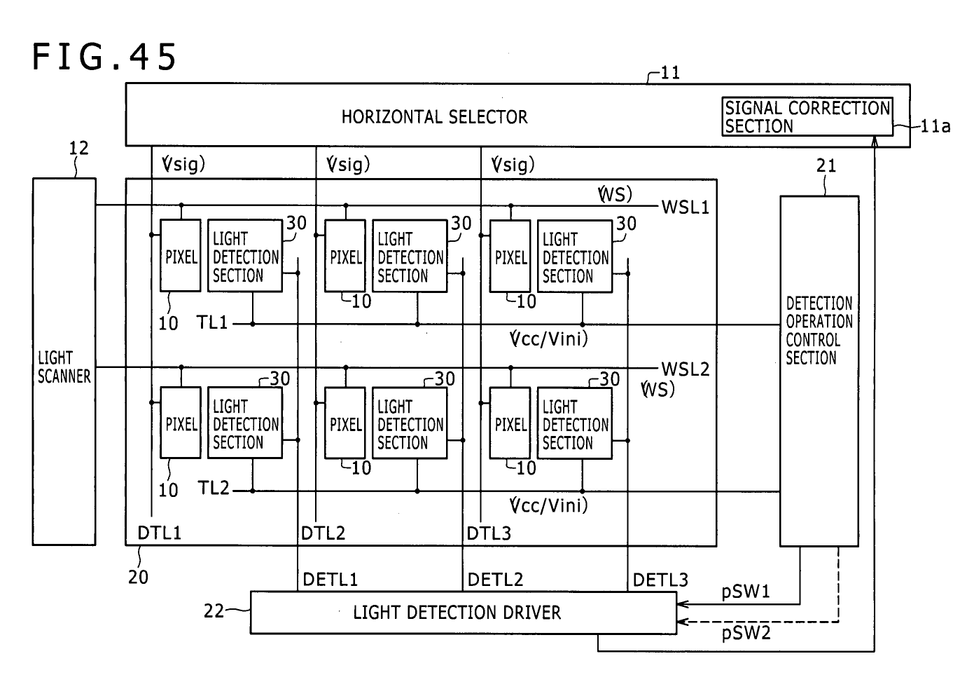

The sixth embodiment is described below with reference to FIGS. 45 to 48.

It is to be noted that, in the sixth embodiment and the seventh embodiment which is hereinafter described, the organic EL display apparatus has such a configuration as shown in FIG. 45. The organic EL display apparatus is described below in regard to differences thereof from that of FIG. 1.

Referring to FIG. 45, the detection operation control section 21 applies a power supply pulse through the power supply lines VL, that is, VL1, VL2, . . . , to the light detection sections 30. In other words, the detection operation control section 21 applies a pulse voltage having the power supply voltage Vcc or the reference voltage Vini to each of the light detection sections 30 through a power supply line VL.

In the first to fourth embodiments described hereinabove, the detection operation control section 21 applies a control pulse pT10 to each light detection section 30 through a control line TLb shown in FIG. 1. However, in the sixth and seventh embodiments, control with the control pulse pT10 is not carried out. In other words, on/off control of the sensor serving transistor T10 is not carried out by the detection operation control section 21.

This signifies that a driver for generating the control pulse pT10 in the detection operation control section 21 is not required.

It is to be noted that, in the sixth embodiment, the detection operation control section 21 provides a control signal pSW1 to the light detection driver 22.

On the other hand, in the seventh embodiment, the detection operation control section 21 supplies control signals pSW1 and pSW2 to the light detection driver 22.

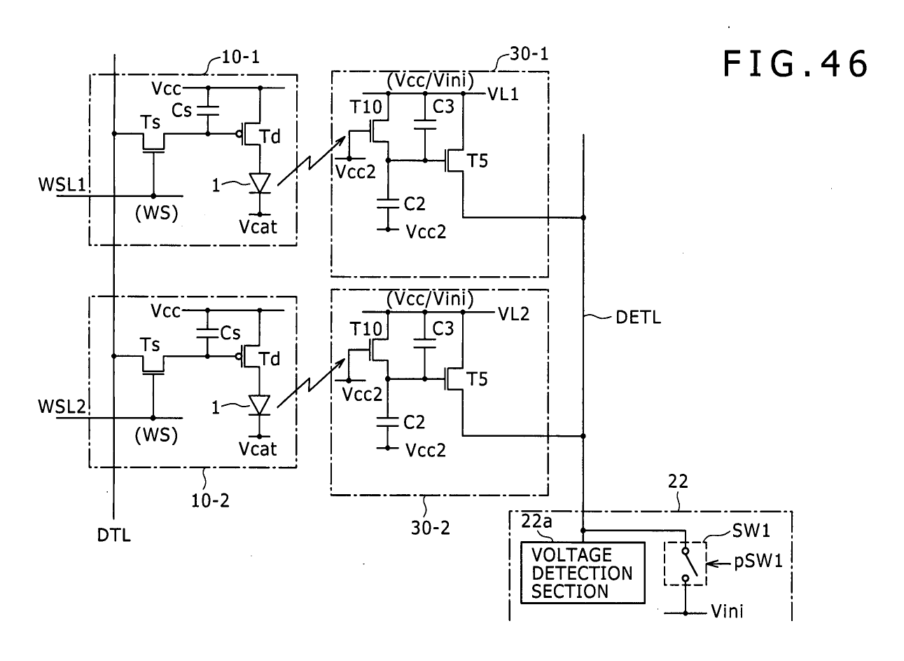

FIG. 46 shows a configuration of a pixel circuit 10 and a light detection section 30 in the sixth embodiment.

The light detection section 30 has a configuration similar to that of the light detection section 30 in the third embodiment described hereinabove in that a sensor serving transistor T10, a detection signal outputting transistor T5, a first capacitor C2 and a second capacitor C3 are provided and that a power supply line VL is used and also similar in the connection scheme among the elements.

However, the sensor serving transistor T10 is connected at the gate thereof to a line of a fixed potential Vcc2. Further, also the first capacitor C2 is contacted at one end thereof to the line of the power supply voltage Vcc.

The pixel circuit 10 and the light detection driver 22 are configured similarly to those in the third embodiment described hereinabove with reference to FIG. 34.

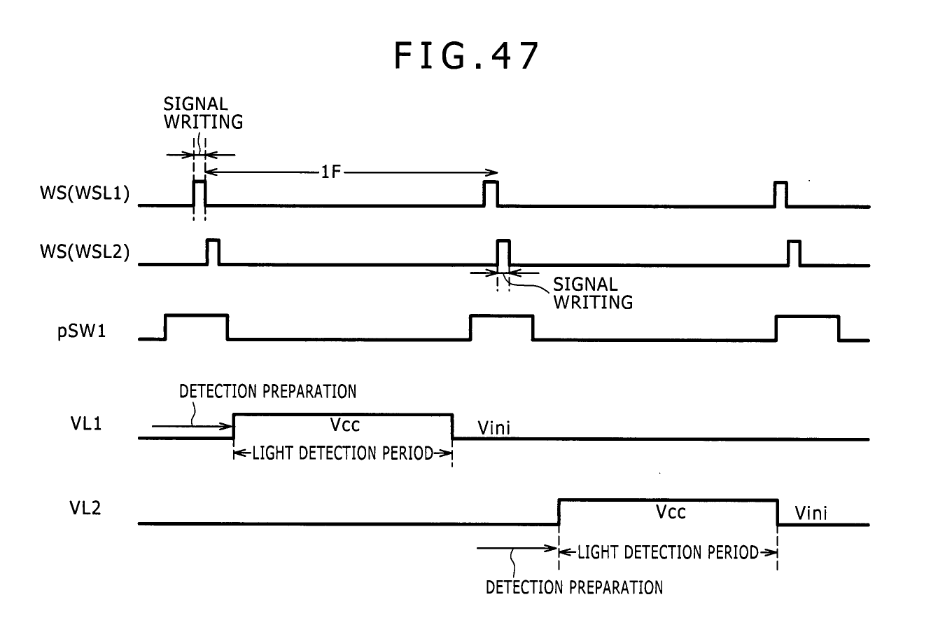

FIG. 47 shows signal waveforms within a period of two frames. The signal waveforms are basically similar to those in the third embodiment, that is, to those described hereinabove with reference to FIG. 27. However, FIG. 47 does not include the waveform of the control pulse pT10.

Further, in each light detection section 30, detection preparations are made when the power supply line VL has the reference potential Vini, and a period within which the power supply line VL has the power supply potential Vcc makes a light detection period.

The present sixth embodiment is characterized in that the sensor serving transistor T10 is connected at the gate thereof to a power supply of the fixed potential Vcc2.

This fixed potential Vcc2 is higher than the sum of the reference voltage Vini and the threshold voltage VthT10 of the sensor serving transistor T10. Further, the fixed potential Vcc2 is set lower than the sum of the gate potential of the detection signal outputting transistor T5 after the potential of the power supply line VL changes from the reference voltage Vini to the power supply voltage Vcc and the threshold voltage VthT10 of the sensor serving transistor T10.

In short, the fixed potential Vcc2 is set to a potential with which, when the potential of the power supply line VL is the reference voltage Vini, the power supply voltage Vcc turns on the sensor serving transistor T10, but when the potential of the power supply line VL changes from the reference voltage Vini to the power supply voltage Vcc, the power supply voltage Vcc turns off the sensor serving transistor T10.

By setting the fixed potential Vcc2 in this manner and inputting the fixed potential Vcc2 to the gate of the sensor serving transistor T10, when the power supply line VL has the reference voltage Vini, the sensor serving transistor T10 can serve as a switch to charge the reference voltage Vini to the gate of the detection signal outputting transistor T5. On the other hand, when the potential of the power supply line VL has the power supply voltage Vcc, the sensor serving transistor T10 acts as a light detection element to supply light leak current to the gate of the detection signal outputting transistor T5 so that the gate potential of the detection signal outputting transistor T5 is varied depending upon the amount of received light.

As a result, upon a light detection operation, through-current from the power supply line VL is eliminated, and consequently, a failure of the picture quality such as a screen burn can be prevented and the number of control lines can be reduced. Accordingly, the number of driving circuits or drivers to be provided in the detection operation control section 21 can be reduced, and this can contribute to reduction of the cost.

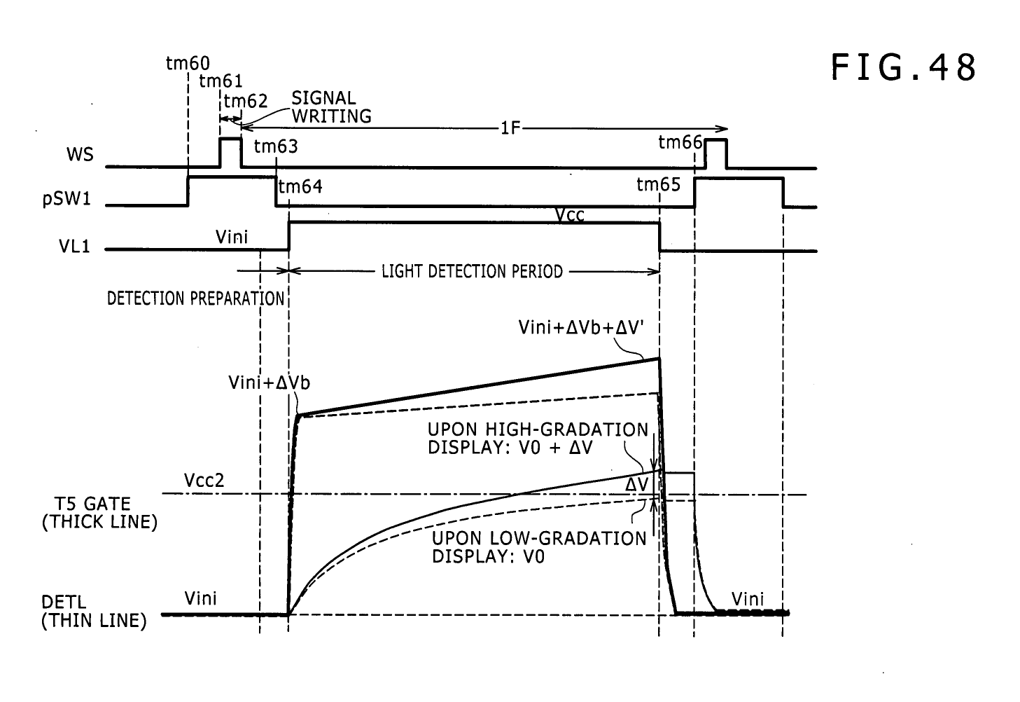

A light detection operation is described with reference to FIG. 48 with attention paid to the light detection section 30-1.

FIG. 48 shows waveforms relating to operation of the light detection section 30-1, particularly those of the scanning pulse WS and the power supply pulse of the power supply line VL1. FIG. 48 further shows waveforms of the gate voltage of the detection signal outputting transistor T5 and the voltage of the light detection line DETL in a thick line and a thin line so as to facilitate identification of them. Further, FIG. 48 shows a waveform of the fixed potential Vcc2 in an alternate long and short dash line.

Except the period within which each light detection section 30 carries out light detection, the detection operation control section 21 controls the power supply line VL to the reference voltage Vini as seen in FIG. 47.

In FIG. 48, for the light detection section 30-1, the detection operation control section 21 controls the power supply line VL1 to the reference voltage Vini till time tm64.

As described hereinabove, when the power supply line VL1 has the reference voltage Vini, the sensor serving transistor T10 is on. This period till time tm64 is a detection preparation period.

Within the detection preparation period, in both of the light detection sections 30-1 and 30-2, the sensor serving transistor T10 is in an on state and the power supply lines VL1 and VL2 have the reference voltage Vini. Consequently, the reference voltage Vini is inputted to the gate of the detection signal outputting transistor T5.

Further, at time tm60, the control signal pSW1 is set to the H level to switch on the switch SW1 connected to the light detection line DETL to initialize the potential of the light detection line DETL to the reference voltage Vini.

In this state, the gate-source voltage of the detection signal outputting transistor T5 is 0 V and the detection signal outputting transistor T5 exhibits an off state.

Within a period from time tm61 to time tm62, the sampling transistor Ts of the pixel circuit 10-1 is turned on with the scanning pulse WS to input a signal value voltage Vsig to the gate of the driving transistor Td. By this operation, the organic EL element 1 begins to emit light.

At this time, since the sensor serving transistor T10 in the light detection section 30-1 is on, the gate voltage of the detection signal outputting transistor T5 remains the reference voltage Vini and also the potential of the light detection line DETL remains the reference voltage Vini similarly.

The detection operation control section 21 switches off the switch SW1 with the control signal pSW1 at time tm63 and then sets the power supply line VL1 to the power supply voltage Vcc at time tm64.

By varying the potential of the power supply line VL1 from the reference voltage Vini to the power supply voltage Vcc, the sensor serving transistor T10 is turned off.

Then, to the gate of the detection signal outputting transistor T5, a coupling amount ΔVb from the power supply line VL1 is inputted through the second capacitor C3. As seen in FIG. 48, the gate voltage of the detection signal outputting transistor T5 rises to Vini+ΔVb.

Since the coupling amount ΔVb has a value which depends upon the capacitor C3, it is possible to make the gate potential of the detection signal outputting transistor T5 higher than Vini+VthT5, which is the threshold voltage of the detection signal outputting transistor T5.

When the gate potential of the detection signal outputting transistor T5 becomes higher than Vini+VthT5, the detection signal outputting transistor T5 is turned on and current begins to flow from the power supply line VL, which has the power supply voltage Vcc, to the light detection line DETL.

By the coupling through the second capacitor C3, also the source-drain voltage of the sensor serving transistor T10 increases, and light leak current depending upon the received light amount flows from the power supply line VL, which has the power supply voltage Vcc, to the gate of the detection signal outputting transistor T5.

By this operation, the gate voltage of the detection signal outputting transistor T5 changes from Vini+ΔVb to Vini+ΔVb+ΔV′ after lapse of a fixed period of time, and together with this, also the potential of the light detection line DETL changes to V0+ΔV. ΔV′ is a rise amount of the gate voltage by the leak current, and ΔV is a potential rise amount of the light detection line DETL corresponding to the rise amount ΔV′ of the gate voltage.

Generally, the light leak amount of a light detection element increases as the amount of light received by the light detection amount increases. Therefore, the detection voltage in a high gradation display state becomes higher than the voltage in a low gradation display state and is outputted to the outside. The potential variation of the light detection line DETL is detected by the voltage detection section 22a. This detection voltage corresponds to the amount of light emitted from the organic EL element 1.

At time tm65 after lapse of a fixed period of time, the detection operation control section 21 sets the power supply line VL to the reference voltage Vini. At this time, a coupling amount ΔVb from the power supply line VL1 which has the reference voltage Vini is inputted to the gate of the detection signal outputting transistor T5 through the second capacitor C3 again.

Since the gate-source voltage Vgs of the detection signal outputting transistor T5 becomes lower than the threshold voltage of the detection signal outputting transistor T5 as a result of this operation, the detection signal outputting transistor T5 is turned off.

Further, since at this time, the sensor serving transistor T10 is turned on, to the gate of the detection signal outputting transistor T5, the reference voltage Vini is inputted.

At time tm66, the detection operation control section 21 switches on the switch SW1 with the control signal pSW1. By this operation, the potential of the light detection line DETL becomes the reference voltage Vini.

Detection by the pixel circuits 10 on the line, for example, for one frame is carried out in such a manner as described above.

As described above, in the present sixth embodiment, the fixed potential Vcc2 is applied as a gate voltage to the sensor serving transistor T10. Then, when the power supply line VL has the reference voltage Vini, the sensor serving transistor T10 exhibits an on state, but when the power supply line VL has the power supply voltage Vcc, the sensor serving transistor T10 exhibits an off state.

Then, when the power supply line VL is set to the power supply voltage Vcc to place the sensor serving transistor T10 into an off state, a potential difference appears in the gate-drain voltage of the sensor serving transistor T10 through the second capacitor C3 and the gate potential of the sensor serving transistor T10 is raised to start outputting of light detection information.

Since the necessity for the on/off controlling system for the sensor serving transistor T10 is eliminated, the gate line for the sensor serving transistor T10 can be made common to the light detection sections 30.

Particularly in the case of the example of FIG. 46, the first capacitor C2 is set also at one end thereof to the fixed potential Vcc2, and consequently, also the connecting point of the first capacitor C2 can be made common to the light detection sections 30.

Consequently, the panel configuration can be simplified significantly by reduction of the number of control lines for the light detection sections 30, reduction of the number of control line drivers in the detection operation control section 21 and so forth, and improvement in yield can be implemented.

Further, through-current can be eliminated from the power supply line VL upon a light detection operation, and reduction of the power consumption can be anticipated.

### 9. Seventh Embodiment

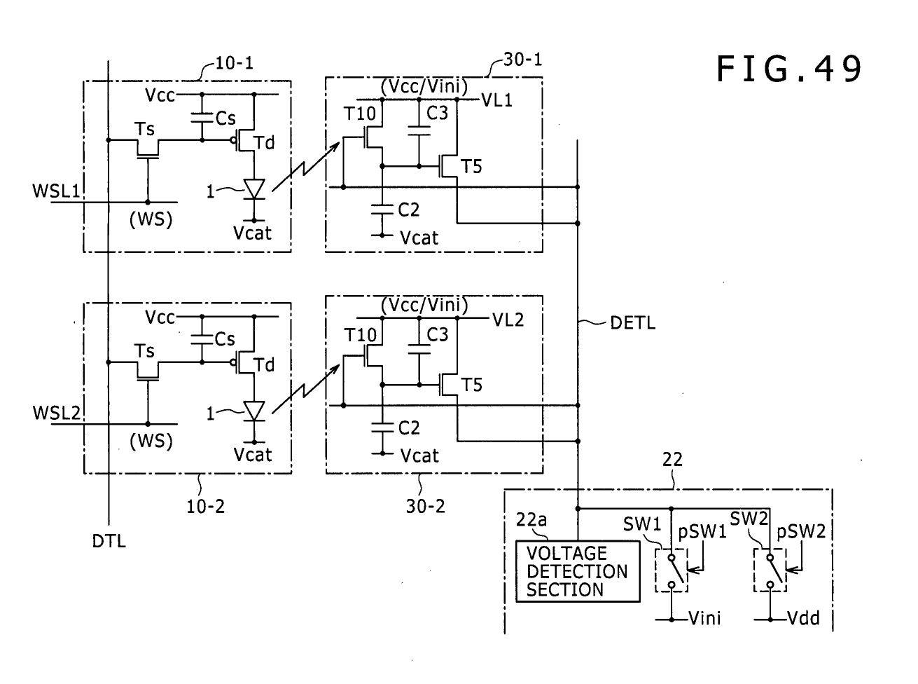

The seventh embodiment is described with reference to FIGS. 49 to 56.

Referring to FIG. 49, each light detection section 30 is similar to that in the sixth embodiment described hereinabove in the provision of a sensor serving transistor T10, a detection signal outputting transistor T5, a first capacitor C2 and a second capacitor C3, the introduction of a power supply line VL and the connection scheme among the elements mentioned.

However, the light detection section 30 is different from that in the sixth embodiment in that the sensor serving transistor T10 is connected at the gate thereof to the light detection line DETL and that the first capacitor C2 is connected at one end thereof to the cathode voltage Vcat.

Further, the light detection driver 22 includes switches SW1 and SW2 connected to the light detection line DETL.

The switch SW1 is connected at the other end thereof to a line of the reference voltage Vini and is controlled between on and off with the control signal pSW1 from the detection operation control section 21.

The switch SW2 is connected at the other end thereof to a line of a fixed potential Vdd and is controlled between on and off with a control signal pSW2 from the detection operation control section 21.

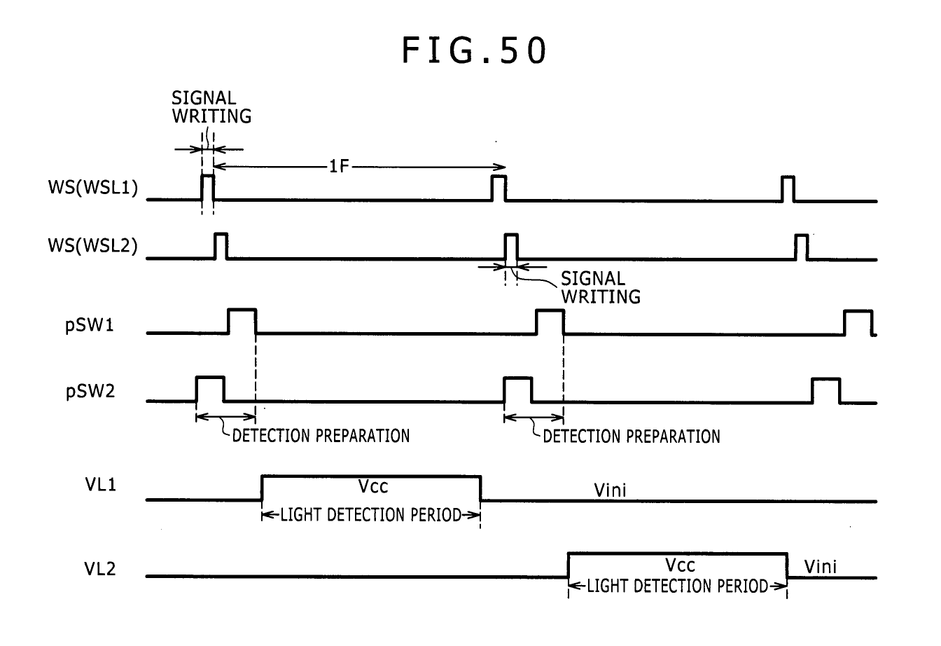

FIG. 50 illustrates signal waveforms within a period of two frames.

Similarly as in the preceding sixth embodiment, each light detection section 30 has a light detection period within which the power supply line VL is set to the power supply voltage Vcc.

Then, a period from a point of time at which the switch SW2 is switched on with the control signal pSW2 to another point of time at which the switch SW1 is switched off with the control signal pSW1 makes a period for detection preparations.

In particular, for the detection preparations, the switch SW2 from between the switches SW1 and SW2 is first controlled to an on state for a fixed period of time. Then, after the switch SW2 is switched off, the switch SW1 is controlled to an on state for a fixed period of time.

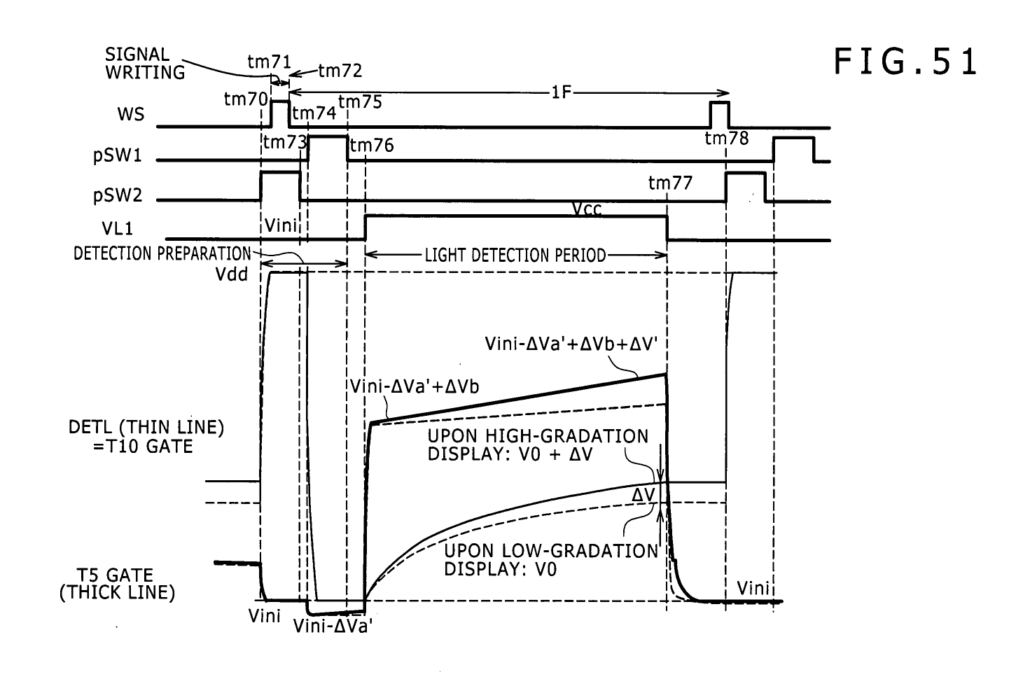

A light detection operation is described with reference to FIGS. 51 to 56 with attention paid to the light detection section 30-1.

FIG. 51 shows waveforms relating to operation of the light detection section 30-1, particularly those of the scanning pulse WS, power supply pulse of the power supply line VL1 and control signals pSW1 and pSW2. FIG. 51 further shows waveforms of the gate voltage of the detection signal outputting transistor T5 and the voltage of the light detection line DETL in a thick line and a thin line, respectively so as to facilitate identification of them.

Except the period within which each light detection section 30 carries out light detection, the detection operation control section 21 controls the power supply line VL to the reference voltage Vini as seen in FIG. 50.

In FIG. 51, for the light detection section 30-1, the detection operation control section 21 controls the power supply line VL1 to the reference voltage Vini till time tm76.

As described hereinabove, the detection preparation period is defined by the switches SW1 and SW2. Within a period from time tm70 to tm73, the switch SW2 is controlled to an on state with the control signal pSW2, and within another period from time tm74 to tm75, the switch SW1 is controlled to an on state with the control signal pSW1.

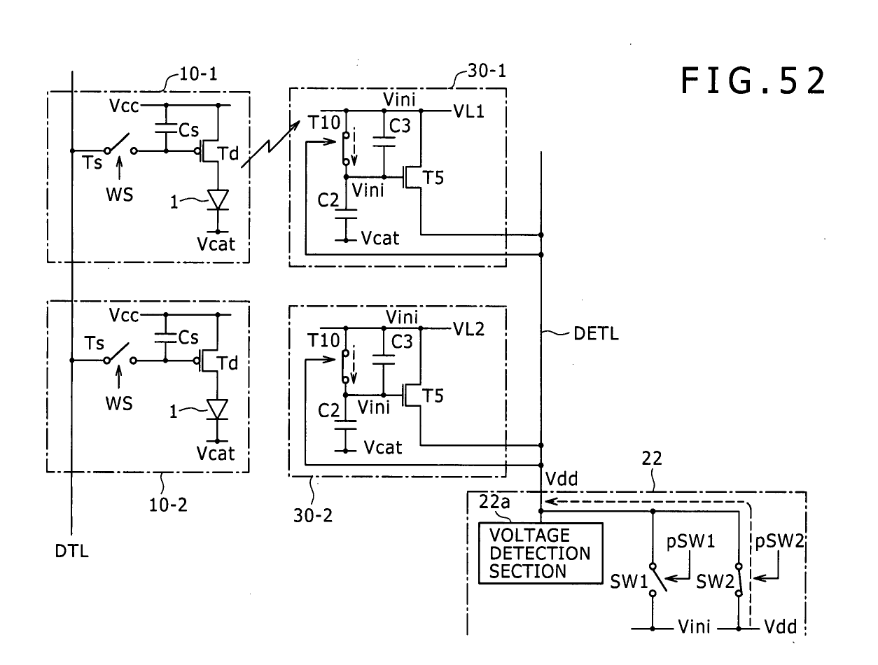

First, for light detection preparations, the detection operation control section 21 switches on the switch SW2 at time tm70. As seen in FIG. 52, when the switch SW2 is switched on, the potential of the light detection line DETL is set to the fixed potential Vdd.

Here, the fixed potential Vdd has a value higher than the sum of the reference voltage Vini and the threshold voltage VthT10 of the sensor serving transistor T10. Further, at this point of time, the power supply line VL has the reference voltage Vini.

Since the sensor serving transistor T10 is connected at the gate thereof to the light detection line DETL, when the light detection line DETL is set to the fixed potential Vdd, the sensor serving transistor T10 is placed into an on state. Consequently, the gate potential of the detection signal outputting transistor T5 is charged to the reference voltage Vini.

At this time, the source of the detection signal outputting transistor T5 becomes the power supply line VL, and the gate-source voltage of the detection signal outputting transistor T5 becomes 0 V. As a result, the detection signal outputting transistor T5 exhibits an off state.

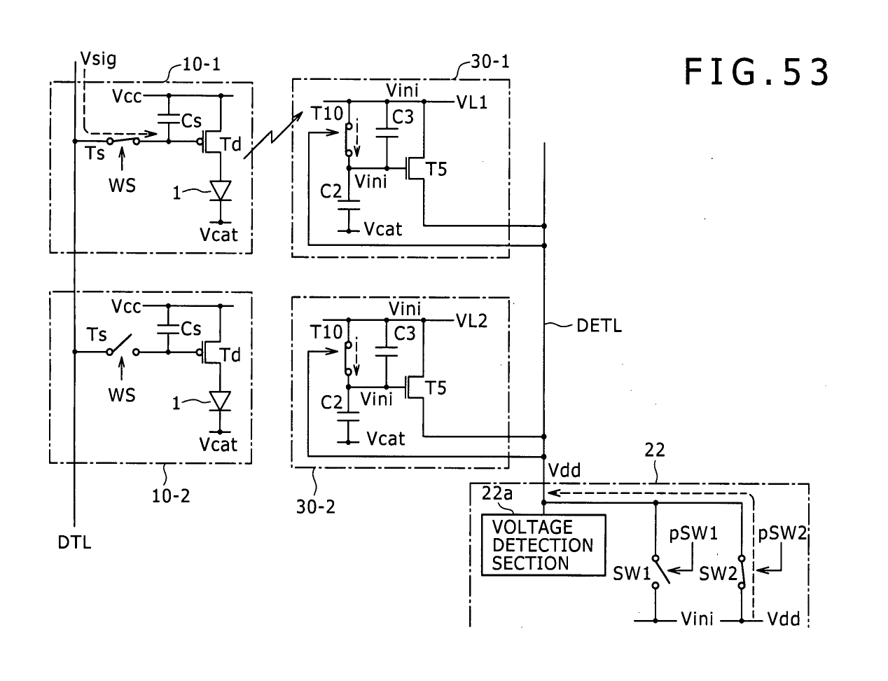

Within a period from time tm71 to time tm72, the sampling transistor Ts of the pixel circuit 10-1 is turned on with the scanning pulse WS to input a signal value voltage Vsig to the gate of the driving transistor Td. By this operation, the organic EL element 1 begins to emit light. A state at this time is illustrated in FIG. 53.

At this time, since the switch SW2 is on and the sensor serving transistor T10 in the light detection section 30-1 is on, the gate voltage of the detection signal outputting transistor T5 remains the reference voltage Vini and also the potential of the light detection line DETL remains the fixed potential Vdd similarly.

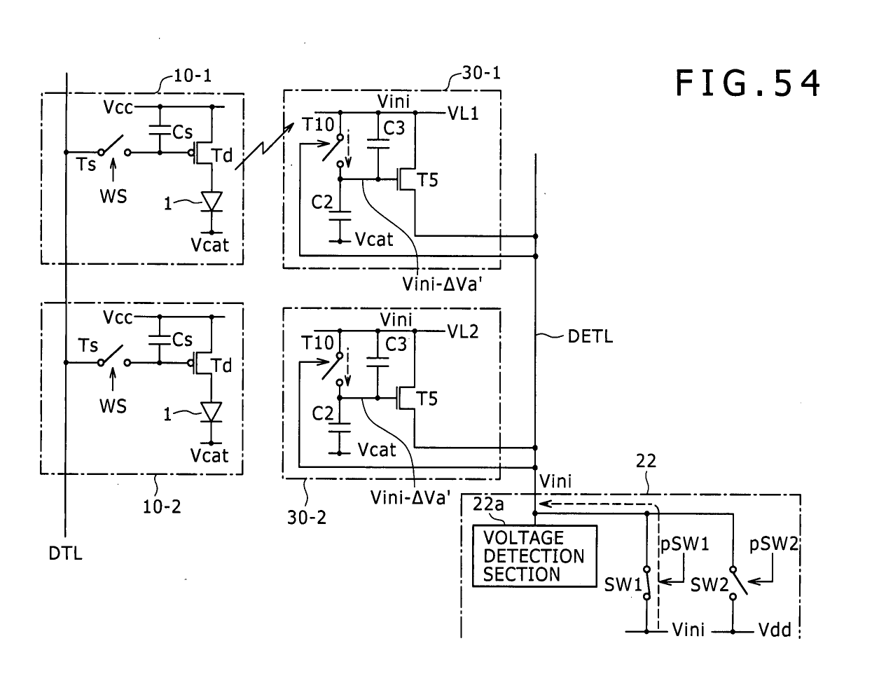

The detection operation control section 21 switches off the switch SW2 at time tm73 and then switches on the switch SW1 with the control signal pSW1 at time tm74. A state at this time is illustrated in FIG. 54.

By switching on the switch SW1, the potential of the light detection line DETL varies from the fixed potential Vdd to the reference voltage Vini.

Therefore, also the gate potential of the sensor serving transistor T10 becomes the reference voltage Vini and the sensor serving transistor T10 is turned off.

At this time, by the variation of the gate voltage of the sensor serving transistor T10, that is, by the potential variation of the light detection line DETL, a coupling amount ΔVa′ is inputted to the gate of the detection signal outputting transistor T5.

A potential difference appears between the source and the drain of the sensor serving transistor T10 as a result of the coupling, and the leak current varies in response to the amount of received light. However, the light leak current of the sensor serving transistor T10 little varies the gate voltage of the detection signal outputting transistor T5. This is because the potential difference between the source and the drain of the sensor serving transistor T10 is small and the period of time before switching off of the switch SW1 which is a next operation is carried out and the potential of the power supply line VL varies to the power supply voltage Vcc is short.

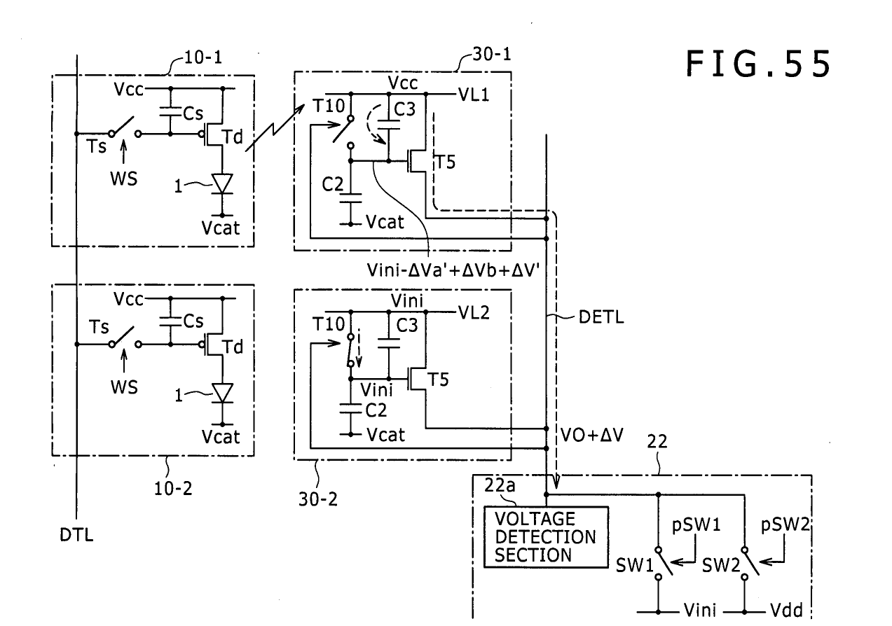

Further, at time tm75 after lapse of a fixed period of time, the detection operation control section 21 switches off the switch SW1, and then at time tm76, the detection operation control section 21 varies the potential of the power supply line VL1 from the reference voltage Vini to the power supply voltage Vcc. A state at this time is illustrated in FIG. 55.

By varying the potential of the power supply line VL from the reference voltage Vini to the power supply voltage Vcc, a coupling amount ΔVb is inputted from the power supply line VL1 to the gate of the detection signal outputting transistor T5 through the second capacitor C3.

Since the coupling amount ΔVb assumes a value which relies upon the second capacitor C3, it is possible to use the value of the second capacitor C3 to raise the gate potential of the detection signal outputting transistor T5 so as to be higher than Vini+VthT5. VthT5 is the threshold voltage of the detection signal outputting transistor T5.

When the gate potential of the detection signal outputting transistor T5 becomes higher than Vini+VthT5, the detection signal outputting transistor T5 is turned on. Accordingly, current begins to flow from the power supply line VL, which has the power supply voltage Vcc, to the light detection line DETL.

At this time, the potential of the light detection line DETL gradually rises from the reference voltage Vini. However, the potential of the light detection line DETL rises basically depending upon the increase of the gate voltage of the detection signal outputting transistor T5 of the light detection section 30-1. Accordingly, the potential of the light detection line DETL is lower than a value obtained by subtracting the threshold voltage of the detection signal outputting transistor T5 from the gate potential of the detection signal outputting transistor T5.

Consequently, within the light detection period, the gate-source voltage of the sensor serving transistor T10 of the light detection section 30-1 is in the negative. Further, also the source-drain voltage increases by the coupling. Therefore, the sensor serving transistor T10 of the light detection section 30-1 supplies light leak current from the power supply line VL1 to the gate of the detection signal outputting transistor T5 in accordance with the received light amount.

By the operation described, the gate voltage of the detection signal outputting transistor T5 (N) changes from Vini−ΔVa′+ΔVb to Vini−ΔVa′+ΔVb+ΔV′ after a fixed period of time, and together with this, also the potential of the light detection line DETL becomes V0+ΔV.

Further, when the potential of the light detection line DETL exceeds the sum of the reference voltage Vini and the threshold voltage of the sensor serving transistor T10 of the light detection section 30-2, the sensor serving transistor T10 in the light detection section 30-2 turns on and the gate potential of the detection signal outputting transistor T5 of the light detection section 30-2 becomes the reference voltage Vini.

Generally, the light leak amount of a light detection element increases as the amount of light received by the light detection amount increases. Therefore, the detection voltage in a high gradation display state becomes higher than the voltage in a low gradation display state and is outputted to the outside. The potential variation of the light detection line DETL illustrated in FIG. 51 is detected by the voltage detection section 22a. This detection voltage corresponds to the amount of light emitted from the organic EL element 1.

At time tm77 after lapse of a fixed period of time, the detection operation control section 21 sets the power supply line VL1 to the reference voltage Vini to end the light detection operation.

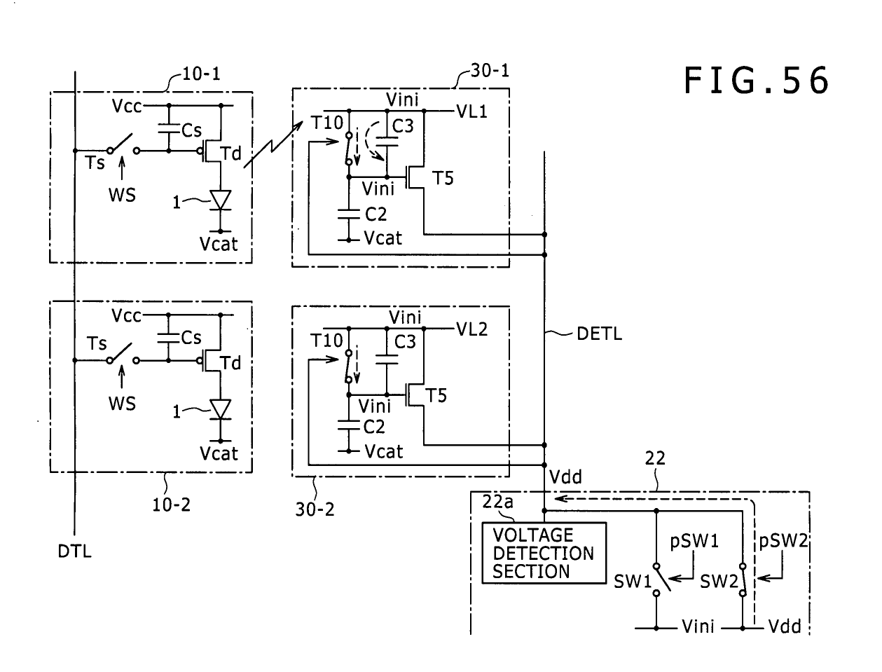

At this time, the coupling amount ΔVb from the power supply line VL1 is inputted to the gate of the detection signal outputting transistor T5 through the second capacitor C3 again. By this operation, the gate-source voltage Vgs of the detection signal outputting transistor T5 becomes lower than the threshold voltage of the detection signal outputting transistor T5, and consequently, the detection signal outputting transistor T5 turns off. A state at this time is illustrated in FIG. 56.

Here, if the potential of the light detection line DETL becomes higher than the sum of the gate voltage of the detection signal outputting transistor T5 and the threshold voltage of the sensor serving transistor T10 as a result of the coupling, then the sensor serving transistor T10 turns on to charge the gate potential of the detection signal outputting transistor T5 up to the reference voltage Vini.

It is to be noted that, if the potential of the light detection line DETL is not higher than the sum described above, then the potential of the detection signal outputting transistor T5 is maintained. However, since the switch SW2 is thereafter switched on at time tm78 to change the potential of the light detection line DETL to the fixed potential Vdd, the sensor serving transistor T10 is turned to charge the gate potential of the detection signal outputting transistor T5 to the reference voltage Vini.

For example, detection of the pixel circuits 10 on the pertaining line in one frame is carried out in such a manner as described above.

As described above, the seventh embodiment is configured such that the sensor serving transistor T10 is connected at the gate thereof to the light detection line DETL and the light detection line DETL can be charged to two fixed voltages, that is, the voltages Vdd and Vini, using the switches SW1 and SW2.

Meanwhile, the light detection section 30 includes a first capacitor C2 connected between the gate of the detection signal outputting transistor T5 and a fixed potential, that is, the potential Vcat, and a second capacitor C3 connected between the gate of the detection signal outputting transistor T5 and the power supply line VL.

Then, from between the two fixed voltage for charging the light detection line DETL, the higher potential, that is, the potential Vdd, turns on the sensor serving transistor T10. Meanwhile, the lower potential is set to turn on the detection signal outputting transistor T5 to which a coupling from the power supply line VL is inputted through the second capacitor C3. The lower potential is, for example, the reference voltage Vini.

With the present seventh embodiment, simplification in configuration and enhancement in yield with respect to the sixth embodiment can be implemented in that the fixed power supplies to be provided to the gate of the sensor serving transistor T10 can be reduced.

Further, similarly to the sixth embodiment, since through-current from the power supply line VL upon a light detection operation can be eliminated as a countermeasure against a failure of the picture quality such as a screen burn and besides the number of control lines can be reduced, the number of driving circuits or drivers to be provided in the detection operation control section 21 can be reduced. Consequently, reduction in cost can be anticipated.

It is to be noted that, in the example described above, the switches SW1 and SW2 are provided to charge the light detection line DETL with two fixed voltages, that is, with the voltages Vdd and Vini. However, in place of this configuration, a pulse voltage having the potentials Vdd and Vini may be generated such that the potentials Vdd and Vini are provided at respective predetermined timings to the light detection line DETL through a single switch.

### 10. Modifications and Applications

While the first to seventh embodiments are described above, modifications which can be applied to the embodiments are described here.

First, it is considerable to vary the sensitivity of the sensor serving transistor T10 in the light detection section 30 in order to fix the voltage level to be outputted to the light detection line DETL from the light detection section 30 which detects light of a different wavelength.

In particular, the sensitivity of the sensor serving transistor T10 for detecting light having high energy is set low while the sensitivity of another sensor serving transistor T10 for detecting light having low energy is set high. As an example, in order to vary the sensitivity of light, the transistor size determined by the channel length or the channel width of a transistor as the sensor serving transistor T10 or the film thickness of the channel material should be changed.

In particular, the channel film thickness of a sensor serving transistor T10 of a light detection section 30 which detects light having higher energy such as B light is set thin while the channel width of the sensor serving transistor T10 is set small. Conversely, the channel film thickness of a sensor serving transistor T10 which detects light having low energy is set thin while the channel width of the sensor serving transistor T10 is set large.

For example, among the light detection sections 30 corresponding to a B light pixel, a G light pixel and a R light pixel, the channel film thickness of the sensor serving transistor T10 for detecting B light is set thinnest while the channel film thickness of the sensor serving transistor T10 for detecting R light is set thickest. Or, the channel width of the sensor serving transistor T10 for detecting B light is set smallest while the channel width of the sensor serving transistor T10 for detecting R light is set greatest. Or both countermeasures are applied.

Generally, a light detection element supplies a greater amount of leak current as the wavelength of light to be received thereby becomes shorter, that is, as the energy of light increases. Therefore, by setting the sensitivity of each sensor serving transistor T10 in response to the wavelength of light to be received, the variation of the gate potential of the detection signal outputting transistor T5 in each of the light detection sections 30 can be made a fixed value independently of the energy of the light to be received. As a result, the voltages to be outputted to the light detection lines DETL can be set to an equal voltage which does not vary depending upon the emitted light wavelength. Consequently, simplification of the light detection driver 22 can be anticipated.

Further, the configuration of the pixel circuit 10 is not at all limited to the examples described hereinabove, and various other configurations may be adopted. In particular, each embodiment described above can be applied widely to display apparatus which adopt a pixel circuit which carries out a light emitting operation irrespective of the configuration of the pixel circuit 10 described above with reference to FIG. 16 and include a light detection section provided outside the pixel circuit for detecting the emitted light amount of the pixel circuit.

Further, while some of the embodiments utilize the cathode voltage Vcat in the light detection section 30 or the light detection driver 22, they may utilize not the cathode voltage Vcat but some other fixed potential.

Also, light detection in regard to a plurality of lines may be carried out at the same timing, or a plurality of light detection periods for different lines may be overlapped with each other. Since the number of light detection elements can be increased by adopting any of such timing relationships, it is possible to increase the light detection accuracy and further reduce the light detection period.

For example, when the emitted light luminance of an EL element on a certain line is to be detected, light detection periods of a plurality of lines are made common to each other or overlapped with each other. In other words, a plurality of light detection sections 30 are provided with a period within which they detect light of the organic EL element 1 of one pixel circuit 10 at the same time.

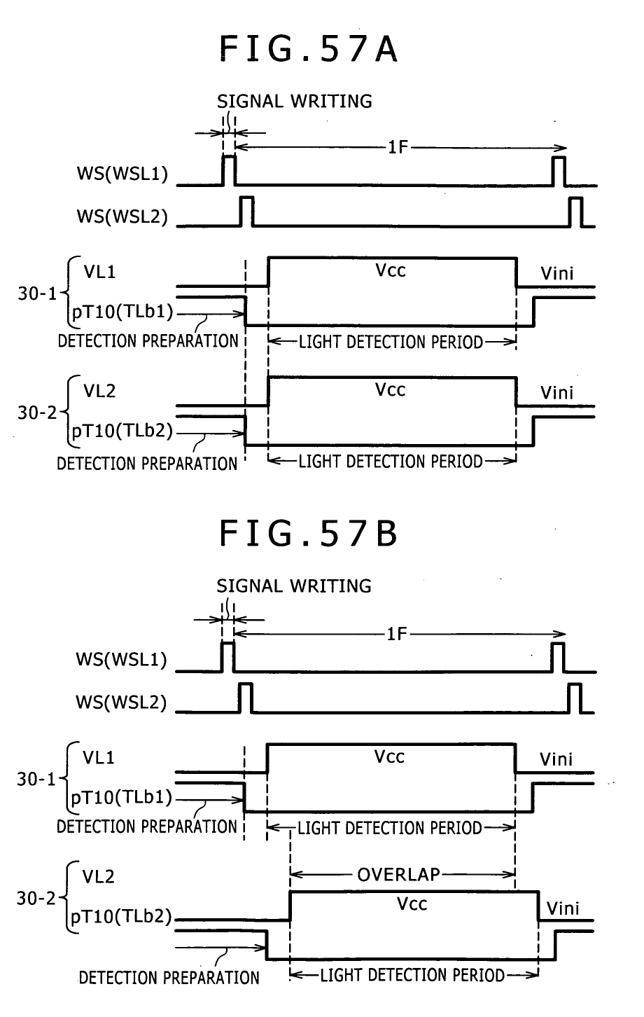

FIGS. 57A and 57B show waveforms shown in FIG. 19 in regard to the first embodiment. In particular, FIG. 57A show waveforms where power supply pulses of the power supply lines VL1 and VL2 and the control pulses pT10 of the control lines TLb1 and TLb2 to the light detection sections 30-1 and 30-2 are applied at the same timing. The light detection periods of the light detection sections 30-1 and 30-2 are the same period.

In other words, when the pixel circuit 10-1 shown in FIG. 16 is driven to emit light, the two light detection sections 30-1 carry out a light detection operation at the same time.

Meanwhile, FIG. 57B shows waveforms where power supply pulses of the power supply lines VL1 and VL2 and the control pulses pT10 of the control lines TLb1 and TLb2 to the light detection sections 30-1 and 30-2 are applied in an overlapping relationship with each other, or in other words, light detection periods of the light detection sections 30-1 and 30-2 overlap with each other. In this instance, within some period, light detection is carried out simultaneously by the light detection sections 30-1 and 30-2. In short, within the overlapping period, when the pixel circuit 10-1 shown in FIG. 16 emits light, a light detection operation is carried out simultaneously by the two light detection sections 30-1.

It is to be noted here that, while FIGS. 57A and 57B show waveforms of pixels of two lines, where a plurality of light detection sections 30 output light detection information simultaneously or in a temporarily overlapping relationship with each other, such light detection sections 30 may naturally belong to three or more lines.

By setting light detection periods of pixels in different lines as the same period or as overlapping light detection periods in this manner, the light detection sensitivity can be increased and the voltage rise in accordance with leak to the light detection line DETL can be accelerated. Consequently, also it becomes possible to shorten the light detection period or decrease the size of the light detection elements. As a result, enhancement in yield can be anticipated and it is possible to take a countermeasure against a failure in picture quality caused by deterioration of the efficiency of a light emitting element such as a screen burn.

While the waveforms based on the first embodiment are shown in FIGS. 57A and 57B, similar effects can be anticipated also with the second to seventh embodiments by setting the light detection periods of the light detection sections 30 in a plurality of lines to the same light detection period or as overlapping light detection periods with each other by setting of the timings of the pulses for setting the light detection periods.

Now, applications of the present invention are described.

The present invention can be applied to an electronic apparatus wherein light is irradiated upon a screen from the outside to carry out information inputting.

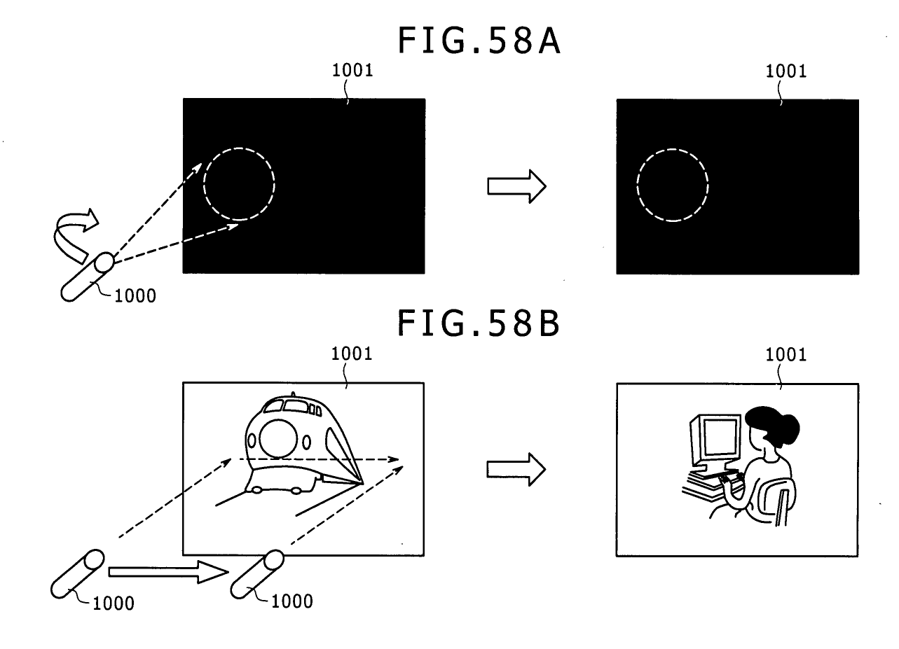

For example, FIG. 58A illustrates a state wherein a user operates a laser pointer 1000 to direct a laser beam to a display panel 1001.

The display panel 1001 may be any of the organic EL display panels described hereinabove with reference to FIGS. 1 and 45.

For example, while the overall screen displays black, a circle is drawn on the display panel 1001 using the light of the laser pointer 1000. Thus, the circle is displayed on the screen of the display panel 1001.

In particular, the light of the laser pointer 1000 is detected by the light detection sections 30 on the pixel array 20. Then, the light detection sections 30 transmit detection information of the laser light to the horizontal selector 11, particularly to the signal value correction section 11a.

The horizontal selector 11 applies the signal value Vsig of a predetermined luminance to the pixel circuits 10 corresponding to the light detection sections 30 by which the laser light is detected.

Consequently, light of a high luminance can be generated from the screen of the display panel 1001 at the irradiated position of the laser light. In short, such a display as to draw a graphic figure, a character, a symbol or the like on the panel can be carried out by laser irradiation.

FIG. 58B illustrates an example wherein an input of a direction by the laser pointer 1000 is detected.

Referring to FIG. 36B, a laser beam is irradiated from the laser pointer 1000 such that it moves, for example, from the right to the left. Since the variation of the laser irradiation position on the screen can be detected as a result of detection by the light detection sections 30 on the display panel 1001, it can be detected in which direction the laser light is directed by the user.

For example, changeover of the display contents or the like is carried out so that this direction may be recognized as an operation input.

Naturally, it is possible to recognize the operation contents by directing the laser beam to an operation icon or the like displayed on the screen.

In this manner, it is possible to recognize light from the outside as a coordinate input on the display panel 1001 so as to be applied to various operations and applications.

Further, in such applications to picture drawing or operation inputting as described above, if a plurality of light detection sections 30 output light detection information simultaneously or in a temporarily overlapping relationship with each other as an example in FIG. 57 described hereinabove, then the detection capacity of external light can be improved advantageously.

For example, when light provided from the outside is detected, the light detection sensitivity can be enhanced by making light detection periods for a plurality of lines overlap with each other, and it is possible to reduce the light detection period or reduce the size of the light detection elements. As a result, enhancement of the yield can be implemented, and besides a countermeasure against a drawback in picture quality by degradation of the efficiency of light emitting elements such as a screen burn can be taken.

The present application contains subject matter related to that disclosed in Japanese Priority Patent Application JP 2010-001877 filed in the Japan Patent Office on Jan. 7, 2010 the entire contents of which are hereby incorporated by reference.

While preferred embodiments of the present invention have been described using specific terms, such description is for illustrative purpose only, and it is to be understood that changes and variations may be made without departing from the spirit or scope of the following claims.

What is claimed is:

1. A display apparatus, comprising:
a plurality of pixel circuits disposed in a matrix at positions at which a plurality of signal lines and a plurality of scanning lines cross each other and individually including a light emitting element;
a light emission driving section adapted to apply a signal value to each of said pixel circuits to cause the pixel circuit to emit light of a luminance corresponding to the signal value; and
a light detection section provided in each of said pixel circuits and including a sensor-switch serving element which functions as a switching element by switching thereof between an on state and an off state and functions, in the off state thereof, as a light sensor for detecting light from the light emitting element of the pixel circuit, and a detection signal outputting transistor connected to a light detection line for outputting light detection information corresponding to a variation amount of current of said sensor-switch serving element in the off state to said light detection line.

2. The display apparatus according to claim 1, wherein said light detection section supplies, when said sensor-switch serving element is placed into the on state, a predetermined reference potential to a gate node of said detection signal outputting transistor, but provides, when said sensor-switch serving element is in the off state, current from the light emitting element in response to reception of light to the gate node of said detection signal outputting transistor to vary a gate potential of said detection signal outputting transistor so that said detection signal outputting transistor outputs the light detection signal in accordance with the variation of the gate potential.

3. The display apparatus according to claim 2, wherein a power supply line switchable between a predetermined operation power supply potential and the reference potential is connected to said light detection section while said sensor-switch serving element and said detection signal outputting transistor are connected to said power supply line such that, when said sensor-switch serving element is placed into an on state while said power supply line is set to the reference potential, the referenced potential is supplied to the gate node of said detection signal outputting transistor whereas, when said sensor-switch serving element is placed into an off state and said power supply line is set to the operation power supply potential, said sensor-switch serving element applies current in response to the light received from the light emitting element to the gate node of said detection signal outputting transistor to vary the gate potential of said detection signal outputting transistor so that said detection signal outputting transistor outputs the light detection information in accordance with the variation of the gate potential.

4. The display apparatus according to claim 3, wherein said light detection section further includes:
a first capacitor connected between the gate of said detection signal outputting transistor and a fixed potential; and
a second capacitor connected between the gate of said detection signal outputting transistor and the power supply line.

5. The display apparatus according to claim 4, wherein, when said sensor-switch serving element is placed into an off state and the power supply line is set to the operation power supply potential, a potential difference is generated between the gate and the drain of a transistor as said sensor-switch serving element through said second capacitor and the gate potential of said detection signal outputting transistor is raised to start outputting of the light detection information.

6. The display apparatus according to claim 5, wherein an operation of charging the light detection line to the reference potential is carried out in a detection preparation operation before said detection signal outputting transistor starts the outputting of the light detection information.

7. The display apparatus according to claim 3, wherein a fixed gate potential with which said sensor-switch serving element exhibits an on state when the power supply line has the reference potential but exhibits an off state when the power supply line has the operation power supply potential is supplied to the gate node of said detection signal outputting transistor as said sensor-switch serving element.

8. The display apparatus according to claim 7, wherein said light detection section further includes:
a first capacitor connected between the gate of said detection signal outputting transistor and the gate potential which is fixed; and
a second capacitor connected between the gate of said detection signal outputting transistor and the power supply line.

9. The display apparatus according to claim 3, wherein the gate node of said detection signal outputting transistor as said sensor-switch serving element is connected to the light detection line, and the light detection line can be charged to at least two different fixed potentials.

10. The display apparatus according to claim 9, wherein said light detection section further includes:
a first capacitor connected between the gate of said sensor-switch serving element and a fixed potential; and
a second capacitor connected between the gate of said detection signal outputting transistor and the power supply line, and
a higher one of the two fixed potentials to be charged to the light detection line being set so as to turn on said sensor-switch serving element while a lower one of the two fixed potentials is set so as to turn on said detection signal outputting transistor to which a coupling from the power supply line is inputted through said second capacitor.

11. The display apparatus according to claim 10, wherein the lower one of the two fixed potentials is the reference potential.

12. The display apparatus according to claim 1, further comprising a correction information production section adapted to supply the light detection information outputted from said light detection section to the light detection line as information for correction of the signal value to said light emission driving section.

13. The display apparatus according to claim 1, wherein said light detection section carries out a light detection operation before normal image display is started or after normal image display is ended by the pixel circuit.

14. The display apparatus according to claim 1, wherein said light detection section carries out a light detection operation within an intermittent period within a normal image displaying period.

15. The display apparatus according to claim 1, wherein a plurality of such light detection sections are provided and are individually driven and controlled so as to output the light detection information at the same time or in an overlapping relationship with each other in time.

16. A light detection method for a display apparatus including a pixel circuit having a light emitting element and a light detection section for detecting light from the light emitting element of the pixel circuit and outputting light detection information, the light detection section including a sensor-switch serving element which functions as a switching element by switching thereof between an on state and an off state and functions, in the off state thereof, as a light sensor for detecting light from the light emitting element of the pixel circuit, and a detection signal outputting transistor connected to a light detection line for outputting light detection information corresponding to a variation amount of current of the sensor-switch serving element in the offset state to the light detection line, said light detection method comprising the step of:
outputting the light detection information in accordance with a variation amount of current flowing to the sensor-switch serving element in the off state of the sensor-switch serving element from the detection signal outputting transistor to the light detection line.

17. An electronic apparatus, comprising:
a plurality of pixel circuits disposed in a matrix at positions at which a plurality of signal lines and a plurality of scanning lines cross each other and individually including a light emitting element;
a light emission driving section adapted to apply a signal value to each of said pixel circuits to cause the pixel circuit to emit light of a luminance corresponding to the signal value; and
a light detection section including a sensor-switch serving element which functions as a switching element by switching thereof between an on state and an off state and functions, in the off state thereof, as a light sensor for detecting light from the light emitting element of the pixel circuit, and a detection signal outputting transistor connected to a light detection line for outputting light detection information corresponding to a variation amount of current of said sensor-switch serving element in the off state to said light detection line.

18. A display apparatus, comprising:
a plurality of pixel circuits disposed in a matrix and each including a light emitting element; and
a light detection section including a sensor-switch serving element capable of functioning as a switch element and also as a light sensor for detecting the light from said light emitting element.

19. The display apparatus according to claim 18, wherein said sensor-switch serving element functions as a light sensor in the off state thereof; and
said light detection section further includes a detection signal outputting transistor for outputting light detection information in accordance with a variation amount of current of said sensor-switch serving element in the off state.
